(19) United States
(12) Patent Application Publication
(10) Pub. No.: US 2008/0049621 A1
(43) Pub. Date: Feb. 28, 2008

(54) Connection-Oriented Communications Scheme For Connection-Less Communications Traffic

(76) Inventors: Alan McGuire, Felixstowe (GB); Andrew B.D. Reid, London (GB)

Correspondence Address: NIXON & VANDERHYE, PC, 901 NORTH GLEBE ROAD, 11TH FLOOR, ARLINGTON, VA, 22203, US

(21) Appl. No.: 11/794,152

(22) PCT Filed: Dec. 30, 2005
(86) PCT No.: PCT/GB05/05100

§ 371 Date: Jun. 26, 2007

(30) Foreign Application Priority Data
Dec. 31, 2004 (GB) 0428541.7
Dec. 31, 2004 (GB) 0428542.5
Feb. 1, 2005 (GB) 0502036.7
Feb. 1, 2005 (GB) 0502039.1
Feb. 1, 2005 (GB) 0502038.3
Apr. 12, 2005 (EP) 05252276.0
Sep. 9, 2005 (GB) 0518450.2
Sep. 15, 2005 (GB) 0518850.3

(51) Int. Cl. H04L 12/56

(52) U.S. Cl. 370/236.2

(57) ABSTRACT

A communications scheme for configuring a network comprising a plurality of connected switching apparatus, each switching apparatus having functionality for implementing connectionless forwarding of received communications traffic to selectively provide a connection-oriented service for said received communications traffic, the scheme comprising: determining in a control plane index header field values to identify connectionless traffic received at switching apparatus for which a connection is to be established between a source node and a destination node; providing each switching apparatus necessary to implement the connection with information from the control plane, the information enabling the data forwarding tables of the switching to be populated with said index header field values in association with egress ports of the switching apparatus; and disabling all other functionality on said switching apparatus capable of populating the data forwarding tables with index information associated with said egress ports of the switching apparatus necessary to establish said connection.

The present invention relates to a connection-oriented communications scheme for switching connectionless traffic across a communications network. In particular, but not exclusively, the invention relates to switching apparatus arranged to implement the connection-oriented communications scheme for said connectionless traffic in said communications network, and related aspects such as methods of providing appropriate signalling information and OAM control information to support the communications scheme.

### INTRODUCTION

Telecommunications networks have developed significantly over the past few decades starting from the connection-oriented, circuit-switched systems using point-to-point connections of the past to connectionless digital communication networks available to virtually all businesses and consumers. Thus today there is a mix of communication systems, each having their own specific properties which appeal to differing kinds of usage.

The oldest form of telecommunications networks can be referred to as Connection-Oriented Circuit-Switched (CO-CS) networks and examples of such networks include the public switched telephone network (PSTN) and optical networks. Optical networks and co-axial cable networks have higher bandwidth than, for example, networks comprising pairs of copper wires and will carry time division multiplex channels (TDM) so that multiple communications can be transmitted on a single cable or a single optical fibre. TDM networks are sometimes also referred to as Plesiochronous Digital Hierarchy (PDH) and Synchronous Digital Hierarchy (SDH) networks depending on the structure and organisation of the networks being used.

Connection-Oriented Packet Switched networks (CO-PS) are used to enable the transfer of high bandwidth or high speed data between terminals and examples include frame relay networks, Asynchronous Transfer Mode (ATM) networks and X.25 networks.

ConnectionLess NetworkS (CNLS) do not usually have a pre-established route between end user terminals communicating thereon but rather rely on each terminal having a dedicated address and routers seeking to transfer information by any available route. The best known example of CNLS is the so-called Internet supporting the World Wide Web (WWW or W3) but other networks such as Ethernet networks use the same principle of transmitting data via “any available route” on a packet by packet basis to its terminal point.

### BACKGROUND

Switching apparatus (for example, hubs, routers, bridges and/or switches), requires appropriate address information to be carried by the relevant protocol data units (PDUS) to determine on which interface the received PDU should be forwarded on towards its destination address. Data which is to be communicated between nodes located in the same local area network can be provided with destination address information which is based solely on an Open Systems Interconnection OSI layer 2 addressing scheme. Data which is to be communicated between nodes located on different local area networks and communicated over an inter-network, containing routers, however must be provided with destination address information which is unique at the network level, i.e., which is based on an OSI layer 3 (the network layer) addressing scheme. Examples of OSI layer 2 addressing schemes include Media Access Control (MAC) addressing schemes, and examples of OSI layer 3 addressing schemes include the Internet Protocol (IP) addressing schemes (e.g., IETF IPv4 or IPv6).

Processing received PDU's to extract appropriate addressing information generates delay. The look-up process to determine which port a received packet should progress to via the switch fabric in order to reach its destination needs to be implemented as rapidly as possible, and this imposes limits on the complexity of the addressing information which can be processed. In addition, if the switching apparatus is implemented so as to require broadcast behaviour if a packet is received with an unknown destination address (also referred to herein as “broadcast-on-unknown” type functionality), then the size of any broadcast domain can affect the performance of the network.

Those skilled in the art will be aware that broadcasts have the potential to overwhelm network resources and that logically restricting the broadcast domains can mitigate this to some extent. One means of imposing such a logical restriction is to implement Virtual Local Area Networks (VLANs). By providing additional information in the header of the PDU, the VLAN to which the PDU has been assigned can be identified by the switching apparatus receiving the PDU, and traffic is switched internally to the VLAN, i.e., only between other nodes on the VLAN.

To implement a VLAN, a switching apparatus which receives a PDU indicated as belonging to a particular VLAN must associate interfaces with that particular VLAN (i.e., assign the VLAN to a “native” port). In this way, when the switching apparatus receives traffic associated with a particular VLAN-ID that traffic will be exclusively forwarded to the appropriate native ports associated with the VLAN to which the received PDU belongs. If a PDU contains an OSI layer 2 destination address which is not already associated with a particular outgoing port of the switching apparatus, the switching apparatus need only broadcast over the interfaces associated with the PDU's VLAN-ID and not over all the ports of the switching apparatus. As those skilled in the art will be aware, Ethernet frames (OSI-layer 2 PDUs) can incorporate additional information comprising a VLAN-ID as part of a VLAN tag in their header fields.

Unfortunately, the solution offered by simple VLAN identification schemes is not readily scalable, and is limited to 4096 separate. VLAN instances in a network, as the VLAN ID is unique in the context of a local area network. To provide further scalability, hierarchical or stacked VLANs can be utilised.

PDUs having the same source and destination address which are forwarded on a connection-less basis by switching apparatus are assigned routes on a per packet basis, such that each PDU is forwarded independently from the path taken by previously received PDUs having the same source and destination addresses. To ensure looping does not occur in Ethernet networks, the spanning tree protocol logically configures the Ethernet network topology, which also prevents multiple paths from being established to the same destination address. Traffic to a MAC address is first broadcast and once the location is determined the forwarding tables are populated such that the traffic is forwarded along the same route (unless spanning tree determines an alternative route as may occur as a result of a failure in topology).

In any communications network where data tends to be bursty, that is, where significant blocks of data are transmitted from a source to a sink in an uneven manner, there is the possibility of a particular selected route becoming seriously overloaded, delaying the transfer of data, while other routes will be significantly under used. This is because a first message having a new source-sink header may arrive at a switch, be broadcast and receive a first ACK through a route while a previous source-sink combination is relatively quiet. Transmission times along a route usually degrade when other sources allocated to the same route begin transmitting higher traffic loads. If the degradation is severe enough, it can make the route unusable for the service required. Multiple routes between a source and a destination to balance the traffic load are not allowed in legacy Ethernet because the spanning tree protocol (STP) determines a loop free topology, if possible, with only one route between a source and a destination.

If a guaranteed quality of service (QOS) is required for services with an aggregate capacity greater than that of the link, an alternative way of assigning the required bandwidth to have more than one link is required. Ethernet switches are inherently vulnerable when in-band control information is provided as control messages and switch functionality can be attacked by hackers. The use of spanning tree processes in an Ethernet network can be detrimental to the network, particularly when there are bridging loops when a port that should be blocking is instead of forwarding traffic. It is important that no interaction occurs between the spanning tree processes used in local area networks and the core network. Simply switching off a spanning tree algorithm is often not possible as it would simply result in broadcast “storms” and looping.

OSI layer 2 and layer 3 switching apparatus may extract information which differentiates how received PDUs are to be forwarded, for example, information relating to the type of service the PDU is to receive, and/or priority information may be extracted. Different types of PDUs may be processed by the switching apparatus differently (for example Operations Administration and Management (OAM) traffic may be processed differently from PDUs carrying end user data).

Although connection-less protocols have historically provided adequate support for elastic applications, which are suitable for communications with varying delay, potential mis-sequencing and no true Quality of Service (QoS), many applications are in-elastic and require connection-oriented service together with guaranteed bandwidth, resilience, and QoS. Thus there is a demand for providing secure connection-oriented services for applications such as interactive video applications for example, such as video conferencing, as well as streamed media applications. Replacing equipment already installed to support connectionless communications protocols with connection-oriented equipment to meet this demand is both costly and problematic.

One solution proposed is the implementation of Multi protocol label switching (MPLS) systems such as those provided by Cisco™. MPLS systems provide a network of routers which use a label to route packets between defined network nodes using the same routing protocols as connectionless routing but with a signalling protocol such as LDP (Label Distribution Protocol). In this way, the routes through the network may appear to be connection-oriented from a signalling point of view in such MPLS systems. MPLS provides a partial solution to the provision of connection-oriented switching arrangements and is a relatively expensive solution compared to the use of Ethernet switching systems due to the complexity of MPLS systems. Ethernet is a more widespread solution to providing local area networks (LANs) and wide area networks (WANs). Ethernet switches are thus more readily available and less expensive than MPLS enabled routers. Internet Protocol (IP) routers are also widely deployed, however, IP is an example of another protocol supporting connectionless communications.

International Patent Application WO2005/008971 entitled “Arrangements for Connection-Oriented Transport in a Packet Switched Communications Network” published on 27 Jan. 2005 relates to a control system and communications system that makes it possible to transport traffic in a connection-oriented mode using the network infrastructure and hardware of a traditionally connectionless network. WO'8971 partitions the address space of an address field in a traditionally connectionless frame into a subset of addresses which are associated with a connection-oriented mode, and a subset of addresses which are associated with a connectionless mode. The contents of WO2005/008971 are hereby incorporated in to the description by reference.

International Patent Application WO2003027807 entitled “Method for Supporting Ethernet MAC Circuits” describes an Ethernet MAC sublayer for supporting Ethernet MAC circuits in an Ethernet network in which the MAC sublayer processes and sets up circuits. The MAC sublayer supports higher level signalling and routing applications to implement MAC circuit functionality and provides interrupts for WAN learning and circuit setup. The MAC sublayer also provides address table entry extension to allow for usage of multiple links between nodes. The routing application is used to manage routing information, maintain a MAC to port mapping database, and manage port resources. The signalling application is used to set up and manage circuits. The contents of WO2003027807 are hereby incorporated in to the description by reference.

In the above prior art, either interrupts must be provided to enable switching apparatus which has been pre-configured to provide a connectionless service and/or the legacy connection-less service retained. For example, in WO2003027807, an address in a connection-oriented subset is used as a path label for a connection established by a connection-oriented control plane. However, the reservation of a sub-set of the address space to identify a connection-oriented label switched path requires, in addition to legacy switching functions, an address manager and multiple control planes (the control plane dedicated to support the connection-oriented mode must be complemented by a connectionless control plane to support the connectionless mode). Moreover, to support the connectionless mode, the spanning tree functionalities cannot be switched off for the appropriate subset, and the connection-oriented control plane must have a complete view of the network before connection-oriented paths can use links disabled by the spanning tree protocol.

Those skilled in the art will be aware of the Institute for Electrical and Electronic Engineering's standard IEEE 802.1Q™ entitled “Local and metropolitan area networks, Virtual Bridged Local Area Networks” which describes an architecture for Virtual Bridged LANs, for services provided in Virtual Bridged LANs, and the protocols and algorithms involved in the provision of those services. This standard describes how Ethernet switching apparatus should be configured to support the standard, for example, how the spanning tree algorithm should be implemented and how the data forwarding and data filtering processes should be implemented by switching apparatus. The contents of IEEE 802.1Q™ are hereby incorporated by reference into the description.

Section 8.10. of IEEE 802.10 describes how the filtering database supports the forwarding process by determining how, on the basis of destination media access control (MAC) address and virtual LAN (VLAN) identifier (VID), received Ethernet frames are to be forwarded through a given interface (i.e., through a potential transmission port).

The IEEE 802.1Q™ standard describes how the filtering database comprises entries that are either static (i.e., the database entry is explicitly configured by a management action) or dynamic (i.e., the filtering entry is automatically entered into the filtering database by the normal operation of the Ethernet switching apparatus and the protocols it supports). The IEEE 802.1Q™ static filtering information for individual and for group MAC Addresses includes both information to enable administrative control over how a frame with a particular destination address is forwarded and information to enable administrative control over how frames with particular VLAN-IDs are forwarded, and how VLAN tag entries are added to/extracted from forwarded frames.

Under IEEE 802.1Q™, static filtering information such as MAC address information, a VID, and the port map (which has a control element for each port to specify filtering for that MAC address and VID) is added to, modified, and removed from the filtering database under explicit management control. For example, using the remote bridge management capability under IEEE 802.1Q™ resources can be identified, initialized, re-set/closed-down, resource relationships determined and operational parameters supplied.

However, whilst IEEE 802.1Q describes the use of remote bridge management to populate the filtering databases with static entries, this is always in the context of supplementing dynamic filtering information which is automatically generated. Moreover, IEEE 802.1Q™ always requires spanning tree and other protocols to operate to ensure looping does not occur, i.e., it is necessary for each bridge to operate a spanning tree protocol to calculate, one or more loop free fully connected active topologies by configuring certain ports to logically remove any physically looped connections with other bridges.

US 2005/0220096 describes a method of traffic engineering in frame-based networks such as Ethernet networks in which connections are established by configuring, in various nodes, mappings for forwarding data frames (such as Ethernet frames). The mappings associate a combination of a) destination address corresponding to a destination node of the connection and an identifier such as a VLAN tag with a selected output port of the switch arrangement. In US 2055/0220096 the mappings use a combination of destination address and identifier to enable data frames belonging to different connections to be forwarded differentially at a node despite having the same destination node.

In US 2005/0220096 one means of addressing the problems generated when configuring forwarding tables in Ethernet switches is to alter the behaviour of the Ethernet switches forming the carrier network so that instead of broadcasting unknown traffic, the Ethernet switches discard packets and possibly issue an alarm, log or count the discarded packets. However, whilst it is possible to set the broadcast volume rate to zero on some Cisco™ switches, no motivation to set the broadcast volume so low has hitherto existed as this would generally result in an unacceptable number of packets being discarded (due to their forwarding address being unknown).

In US 2005/022096 instead of using auto-learning to configure forwarding tables in Ethernet switches, forwarding tables are configured directed using a novel Ethernet control plane. In US 2005/022096 the control plane comprises a number of connection controllers corresponding to each Ethernet switch. Each connection controller controls the switching of its respective switch using connection control interface signalling which is used to directly configure the forwarding tables used by the Ethernet switches of the carrier network. In US2005/022096 flow control is implemented by distinguishing flows to the same destination address based on the virtual local area network identifier of each received frame of traffic (i.e., based on the VLAN-ID).

In US 2005/022096 connection controllers may communicate between themselves using Network to Network Interface (NNI), and typically exchange information regarding their operational state and the state of their communications links using NNI signalling. Other control plane functions such as are described in Y.17ethOAM are also described. The contents of US 2005/022096 and its subsequent PCT patent application are hereby incorporated by reference into the description.

In the IETF Draft Recommendation draft-kawakami-mpls-lsp-vlan-00.txt dated 29 Mar. 2004, by Kawakami et al, a method is proposed a method to setup a Layer 2 tunnel over networks based on Ethernet technology. Kawakami et al describe configuring the ports of an Ethernet switch to forward VLAN tag-labelled packets incoming from a certain port to another unambiguous port by using VLAN tag information. The Ethernet switches themselves are a part of the Label Switching Routers (LSRs), which distribute the VLAN tags using Label Distribution Protocol (LDP). To enable LDP to fulfil this function, an LDP extension is proposed.

Kawakami et al propose setting up LSP over Ethernet using VLAN tag switching in which information is transported in the forwarding plane and the control plane. The forwarding plane uses the forwarding component of a VLAN-LSR whereas the control plane controls the LSP label distribution and provides management for the LSP. Kawakami also describes a network management entity which calculates the paths (the VLAN-LSP information) and controls the network load. The contents of IETF Draft Recommendation draft-kawakami-mpls-lsp-vlan-00.txt dated 29 Mar. 2004, by Kawakami et al are hereby incorporated by reference into the description.

The prior art cited above relates to either partitioning the address-space to provide a connection-less or connection-oriented service or requires the reservation of a range of addresses etc at the traffic source such that certain traffic can be identified by switching apparatus and routed in a connection-oriented manner, even though the traffic format otherwise conforms to the format of traffic which is usually routed in a connection-less manner.

The present invention seeks to mitigate and/or obviate certain problems associated with using switching apparatus pre-configured to support connectionless communication protocols (referred to herein as legacy switching equipment) to provide an end-to-end connection-oriented service.

The aspects of the invention are as set out in the accompanying independent claims, and the preferred embodiments of the invention are set out in the claims dependent thereon, now set out below:

A switching apparatus in a communications network, the switching apparatus comprising:
a plurality of ingress ports arranged to receive traffic in the form of protocol data units which conform to a connection-less communications protocol;
a plurality of egress ports for forwarding received traffic on
interface means arranged to receive information from a control plane processor; and
data storage means, whereby information provided by the control plane is stored and arranged to associate an egress port of the switching apparatus with an index field,
wherein the information received by the switching apparatus from the control plane enables the switching apparatus to operate to provide a connection-oriented mode of transport for the received traffic to establish a connection between a source node and an end node in said communications network via a plurality of other switching apparatus configured by the control plane, wherein said switching apparatus has no other functionality capable of controlling the data forwarding function for the interfaces of said switching apparatus configured by said control plane to provide a connection-oriented mode of transport for said received traffic, wherein the mode of transport for received traffic between said source and said destination is determinable by the control plane for the plurality of switching apparatus in the communications network.

In an embodiment of the first aspect of the invention, the mode of transport is determined by the control plane populating the data storage means with a plurality of index field identifiers, at least one index field identifier comprising a destination address of the connection to be established for said received traffic.

In an embodiment of the first aspect of the invention or the first statement of embodiments of the first aspect, the mode of transport is determined by the control plane populating the data storage means with a plurality of different index field identifiers, at least one index field identifier comprising a destination address of the connection to be established for said received traffic.

In an embodiment of the first or second statements of embodiments of the first aspect of the invention, the plurality of index field identifiers are arranged in a hierarchical order, and index field identifiers at different levels of the hierarchy are associated with different egress ports of the switch arrangement.

In an embodiment of the first aspect of the invention or any of the first to third statements of embodiments of the first aspect, the information received from the control plane processor further controls the data filtering function the switching apparatus performs on received traffic, and wherein said switching apparatus has no other functionality capable of controlling the data filtering function for the interfaces of said switching apparatus for which the control plane has provided information to control the data filtering function.

In an embodiment of the first aspect of the invention or any of the first to fourth statements of embodiments of the first aspect, the forwarding and/or filtering functions performed by the switching apparatus are controlled by the control plane populating the forwarding tables used by the switching apparatus to cause said received traffic to follow one or more predetermined paths through said communications network.

In an embodiment of the fifth statement of embodiments of the first aspect of the invention, the forwarding table has entries causing said received traffic to be forwarded using a connection-oriented mode which take precedence over entries for connectionless traffic.

In an embodiment of the first aspect of the invention or any of the first to sixth statements of embodiments of the first aspect of the invention, the received traffic comprises Ethernet frames or IP packets.

In an embodiment of any of the second to seventh statements of embodiments of the first aspect of the invention, for one or more egress ports of the switching apparatus, the information provided by the control plane populates the data forwarding table with aggregate address information comprising a combination of header field values associated with an egress port of the switching apparatus.

In an embodiment of the previous statement of an embodiment of the first aspect of the invention, the aggregate address information comprises at least one locally unique address and at least one globally unique address, and wherein said control plane provides information to route said received traffic to a globally unique address along a path dependent on one or more locally unique addresses.

In an embodiment of either of the eighth or ninth statements of embodiments of the first aspect of the invention, said aggregate address information comprises information extracted from one or more fields in a header of a packet received by said switching apparatus which is associated with an egress port of the switching apparatus by said control plane, whereby the switching apparatus is arranged to forward said received frame to an egress port of the switching apparatus based on one or more of the following fields of the received packet conforming to a connectionless communications protocol:
one or more destination address fields;
one or more source address fields;
one or more source route address fields;
one or more Ethertype field;
one or more priority fields;
one or more type of service fields;
one or more flow identifier fields; and
one or more fields capable of identifying a virtual private network;
one or more protocol fields;
one or more TCP/UDP destination port identifier fields;
one or more TCP/UDP source port identifier fields.

In an embodiment of the eighth statement of embodiments of the first aspect of the invention, said traffic comprises IP packets and said aggregate address comprises a set of IP addresses and appropriate address mask information associated with an egress port of the switching apparatus, and wherein for each aggregate address, an IP subnet provides a destination address and the address within each subnet uniquely identifies a path through said communications network.

In an embodiment of the eighth statement of embodiments of the first aspect of the invention, said globally significant address is provided by a combination of data stored in the header fields of said received traffic, and wherein said locally significant aggregate address information comprises a hardware address.

In another embodiment of the eighth statement of embodiments of the first aspect of the invention, said control plane provides in addition to said address aggregate a unique path identifier comprising a TCP/UDP port identifier associated with an IP address, said TCP/UDP port identifier being associated by the control plane with an egress port of said switching apparatus.

In another embodiment of the eighth statement of embodiments of the first aspect of the invention, said control plane provides said forwarding table with an IPv6 route associated with an egress port of said switching apparatus, and said unique path identifier comprises said flow identifier of an IPv6 address.

In an embodiment of the first aspect of the invention or of any one of the first to tenth statements of embodiments of the first aspect of the invention, the connectionless protocol comprises Ethernet.

In an embodiment of the previous (fifteenth) statement of embodiments of the invention, said locally unique address information comprises one or more MAC header fields.

In an embodiment of the first aspect of the invention or any one of the previous statements of embodiments of the first aspect of the invention, the switching apparatus is arranged to be capable of re-activating the connection-less mode of operation of egress ports by activating functionality which is capable of configuring the data forwarding tables of the switching apparatus to operate in a connectionless mode upon receipt of appropriate signalling from the control plane.

In an embodiment of the first aspect of the invention or any one of the previous statements of embodiments of the first aspect of the invention, the switching apparatus further comprises:
means to extract header information from the header of each received packet;
means to perform a lookup operation to determine if said extracted header information matches stored forwarding information, said forwarding information being arranged to provide a data forwarding function for each said received packet dependent said extracted header information;
wherein said information received from said control plane source is processed by said switching apparatus to populate said data storage means to store forwarding information to enable the control plane source to control the connection-oriented data forwarding functionality which the switching apparatus performs on each said received packet.

In an embodiment of the first aspect of the invention or any one of the previous statements of embodiments of the first aspect of the invention, said switching apparatus is deployed in a communications network, and previously provided only a connectionless service over said communications network.

In an embodiment of the first aspect of the invention or any one of the first to eighteenth statements of embodiments of the first aspect of the invention, said switching apparatus provides a transparent point-to-point service over said communications network.

In an embodiment of the first aspect of the invention or any one of the first to eighteenth statements of embodiments of the first aspect of the invention, the switching apparatus provides a transparent point-to-multipoint service over said communications network.

In an embodiment according to any one of the nineteenth to twenty-first statements of embodiments of the first aspect of the invention, a field in a header of a packet received by said switching apparatus is associated with an egress port of the switching apparatus, and the switching apparatus forwards said received frame to an egress port of the switching apparatus based on one or more of the following fields of the received packet conforming to a connectionless communications protocol:
one or more destination address fields;
one or more source address fields;
one or more source route address fields;
one or more Ethertype field;
one or more priority fields;
one or more type of service fields;
one or more flow identifier fields; and
one or more fields capable of identifying a virtual private network;
one or more protocol fields;
one or more TCP/UDP destination port identifier fields;
one or more TCP/UDP source port identifier fields.

In an embodiment of the twenty-second statement of embodiments of the first aspect of the invention, said switching apparatus encapsulates received the header of a received packet within one or more other headers.

In an embodiment of the twenty-third statement of embodiments of the first aspect of the invention, said received packet comprises an IP packet having an IP packet header including first IP address information encapsulated in a second IP packet header comprising second IP address information.

In an embodiment of the first aspect of the invention or of any one of the first to twenty-fourth statements of embodiments of the first aspect of the invention, information relating to a connection provided by said switching apparatus in said communications network is provided only within the control plane of said communications network.

According to a second aspect of the invention, a method of modifying switching apparatus deployed in a communications network to provides a connectionless service over said communications network, wherein said method comprises the step of disabling the data forwarding functionality of the switching apparatus from using information calculated from connectionless routing protocols to implement connectionless routing, and wherein said information populating said forwarding table is provided by the control plane of the switching apparatus, wherein said provided information enables the switching apparatus to implement its data forwarding functionality for received packets.

In an embodiment according to the second aspect of the invention, in said step of disabling the data forwarding functionality, the IP addresses of the switching apparatus themselves are retained in each forwarding table in a normal connectionless mode, and wherein the control plane transport and routing protocol including auto-discovery is implemented in a connectionless mode.

A third aspect of the invention comprises a method of modifying switching apparatus deployed in a communications network to provide a connectionless service over said communications network, wherein said method comprises the step of preventing data forwarding in connectionless mode by populating the forwarding table with connection-oriented entries which take precedence over connectionless forwarding entries, and wherein said information populating said forwarding table is provided by the control plane of the switching apparatus, wherein said provided information enables the switching apparatus to implement its data forwarding functionality for received packets.

A fourth aspect of the invention comprises a method of switching packets over a communications network comprising a plurality of interconnected switching apparatus, the method comprising:
receiving packets at a switching apparatus connected to said communications network,
forwarding said packets at a switching apparatus by populating a data store arranged to associate information provided in at least one field of the header of a received packet with an egress port of the switching apparatus using information provided by one or more control plane processors associated with the switching apparatus, said one or more control plane processors comprising the control plane of said communications network, whereby the data forwarding and/or route filtering functionality of the switching apparatus are controlled by the control plane of the communications network.

A fifth aspect of the invention comprises a communications network comprising a plurality of switching apparatus interconnected to provide switchable data transport between data sources and data sinks, wherein the data forwarding and data filtering functions each switch apparatus performs on received packets is controlled by a control plane comprising one or more control plane processors, said control plane providing each switch apparatus with control data enabling the switching apparatus to implement its data forwarding and data filtering functionality on received packets, said received packets including header information having address information conforming to a connectionless protocol, said control data enabling said switching apparatus to provide a connection-oriented service for said received packets.

A sixth aspect of the invention comprises a control plane processor arranged to provide switching apparatus according to the first aspect or according to any one of the first to 25^{th} statements of embodiments of the first aspect of the invention with control data, the control data enabling the switching apparatus to implement its data forwarding and data filtering functionality on received packets.

A seventh aspect of the invention comprises a communications network comprising a plurality of interconnected switching apparatus according to the first aspect or any of the embodiments thereof.

In an embodiment according to the seventh aspect of the invention, the control data generated by said control plane is transmitted out of band to each switching apparatus.

In an embodiment according to the seventh aspect of the invention or the first statement of an embodiment of the seventh aspect of the invention, the control plane of said communications network establishes a plurality of paths for a traffic flow from at least one data source to at least one data sink through said network.

An eighth aspect of the invention comprises a method of providing service differentiation over a communications network by re-configuring a switching apparatus capable of providing a connectionless service to provide a connection-oriented service, the method comprising the steps of:
disabling all preconfigured data forwarding and pre-configured data filtering functionality of the switching apparatus;
providing all required routing information for forwarding a received packet from a data source located off-switch via a control interface for the switching apparatus, wherein the routing information replaces information previously provided by the connectionless protocols supported by the switching apparatus,
wherein the route determined for each flow of traffic is dependent on a characteristic of the traffic flow.

In an embodiment of the eighth aspect of the invention, each said route is dependent on a characteristic comprising a quality of service requested for the traffic flow.

In an embodiment of the eighth aspect of the invention, said characteristic is the priority of said traffic flow.

In an embodiment of the eighth aspect of the invention or the first statement of an embodiment of the eighth aspect of the invention, said characteristic is the bandwidth required for said traffic flow.

In an embodiment of the eighth aspect of the invention or the first statement of an embodiment of the eighth aspect of the invention, said characteristic is the Ethertype of the traffic flow.

In an embodiment of the eighth aspect of the invention or the first statement of an embodiment of the eighth aspect of the invention, said characteristic is the logical link control (LLC) header for said traffic flow.

The ninth aspect of the invention comprises a method of selecting a path in a communications network to balance the load of traffic in the network, the method comprising the steps of:
identifying a traffic flow arriving at switching apparatus, wherein the switching apparatus has been reconfigured to provide a connection-oriented service across a communications network instead of a connection-less service,
associating the traffic flow with an individual connection identifier;
associating said individual connection identifier with additional header field information to provide a global identifier for said traffic flow;
determining using the control plane a path for said globally identified flow, and
providing information to a plurality of re-configured switching apparatus within said communications network to enable a plurality of paths to be determined for each said traffic flow, wherein one or more of said plurality of paths is selected by said control plane processor.

In an embodiment of the ninth aspect of the invention, said traffic is Ethernet traffic and said individual connection identifier comprises a virtual local area network identifier.

In an embodiment of the ninth aspect of the invention, said traffic is IP traffic.

The tenth aspect of the invention comprises a method of generating an end-to-end connection over a communications network comprising a plurality of switching apparatus preconfigured to support a connectionless communications protocols the method comprising the steps of:
reconfiguring the switching apparatus by:
disabling any functionality supporting forwarding a received communications traffic flow using said connectionless communications protocol;
enabling functionality supporting forwarding a received communications traffic flow using a connection-oriented communications protocol;
determining a path for said end-to-end connection from a source to a sink for said traffic flow;
communicating said path via a control interface to provide routing information for said received traffic flow, whereby said enabling functionality forwards said received traffic flow towards said sink across said communications network.

In an embodiment of according to the tenth aspect of the invention, said step of enabling said functionality supporting a connection-oriented communications protocol is provided via a control interface to the switching apparatus.

The eleventh aspect of the invention comprises in a communications network comprising a plurality of local area networks interconnected by a wide area network, a method of providing differentiated forwarding modes for packetised data received from a first one of said plurality of LANs to a second one of said plurality of LANs, the method comprising:
at a first apparatus arranged to provide data from said first LAN with access to said WAN, performing a look-up operation on a plurality of header fields for said data;
determining if each of said plurality of header fields are associated with routing information stored in a data store populated by the control plane of said first apparatus;
routing said data across said wide area network to a second apparatus arranged to provide access to data from said WAN to said second LAN in accordance with the routing information provided by said control plane.

In an embodiment according to the eleventh aspect of the invention, the packetised data comprises a plurality of Ethernet frames, and said plurality of header fields comprise at least a VLAN-ID/DA MAC tuple, and wherein said first and second switching apparatus comprise first and second independent VLAN learning Ethernet switches respectively.

In an embodiment of the first statement of an embodiment of the eleventh aspect, the first and second independent VLAN learning Ethernet switching apparatus are interconnected by a contiguous sequence of independent VLAN learning Ethernet switching apparatus arranged to forward received Ethernet frames on locally significant VLAN-IDs to form a unidirectional connection.

In an embodiment of the second statement of an embodiment of the eleventh aspect, said routing information provided by said control plane further provides a reverse path between said second Ethernet switch and said first Ethernet switch to provide bi-directional connectivity between said first and second Ethernet switching apparatus.

The twelfth aspect of the invention comprises an Ethernet switching apparatus arranged to receive data from a control plane processor to control the data forwarding and data filtering functions the switching apparatus performs on received Ethernet traffic.

In an embodiment of the twelfth aspect, said control plane sets up connections and populates one or more bridging tables on the switching apparatus so that the Ethernet switching apparatus has its Media Access Control address learning functionality disabled and so that the spanning tree protocol is deactivated and so no bridge protocol data units are provided.

In an embodiment of the twelfth aspect or of the first statement of an embodiment of the twelfth aspect, said control plane comprises a connection-oriented control plane arranged to control Ethernet switching apparatus technology which is assumed to be connectionless and in doing so convert the behaviour of said Ethernet switching apparatus technology.

The thirteenth aspect of the invention comprises a control plane processor arranged to provide an Ethernet switching apparatus with control data, the control data enabling the Ethernet switching apparatus to implement its data forwarding and data filtering functionality on received Ethernet traffic.

The fourteenth aspect of the invention comprises a communications network comprising a multiplicity of Ethernet switching apparatus interconnected to provide switchable data transport between data sources and data sinks, wherein the data forwarding and data filtering functions each Ethernet switching apparatus performs on received Ethernet traffic is controlled by a control plane processor providing each Ethernet switching apparatus with control data enabling the Ethernet switching apparatus to implement its data forwarding and data filtering functionality on received Ethernet traffic.

The fifteenth aspect of the invention comprises a communications network comprising a multiplicity of Ethernet switching apparatus interconnected to provide switchable data transport between data sources and data sinks, wherein the data forwarding and data filtering functions all of the Ethernet switching apparatus performs on received Ethernet traffic in the network are collectively controlled by a control plane processor arranged to provide control data to all the Ethernet switching apparatus to enable each switching apparatus to implement its data forwarding and data filtering functionality on received Ethernet traffic.

In an embodiment of the fourteenth or fifteenth aspects, the control data generated by each said control plane processor is transmitted out of band to each Ethernet switching apparatus.

In an embodiment of the first statement of an embodiment of the fourteenth or fifteenth aspects of the invention, a VLAN is established between said Ethernet switching apparatus to transmit said control data.

In an embodiment of either the fourteenth or fifteenth aspects or any one of the first or second statements of embodiments of the fourteenth or fifteenth aspects, the control plane establishes a plurality of paths for a traffic flow from at least one data source to at least one data sink.

In an embodiment of any one of the twelfth to fifteenth aspects or any of the statements of embodiments of said twelfth to fifteenth aspects, the information provided by the control plane comprises at least one index identifier type to associate said identifier with an egress port of the switching apparatus, said identifier type being a header field identifier of traffic which the switching apparatus is configured to receive.

In an embodiment of said previous statement of an embodiment of any one of the twelfth to fifteenth aspects or any of the statements of embodiments of said twelfth to fifteenth aspects, the forwarding information provided by the control plane for a plurality of egress ports comprises differing types of index identifiers.

In an embodiment of any of said previous statements of embodiments of any one of the twelfth to fifteenth aspects or any of the statements of embodiments of said twelfth to fifteenth aspects, wherein said control plane assigns a said index identifier type to implement a load-balancing scheme.

A sixteenth aspect of the invention comprises a method of implementing an OAM flow along a communications connection between a source and a destination in a communications network, the method comprising the steps of:
injecting a packetised traffic flow from an adjunct processor to a first switching apparatus, the packetised traffic flow comprising OAM traffic, wherein the OAM traffic has label field value types which are the same label field value types as user plane traffic flowing along said communications connection;
switching the OAM packets at to enable intermediate switching apparatus between said source and said destination to forward the OAM packets as if they were user plane packets;
receiving said OAM and user plane packetised traffic flow at a second switching apparatus;
   separating out the OAM packets from the user plane packets;
   switching out the OAM packets in an adjunct processor to said far end switching apparatus for processing by said switching apparatus according to its standard functionality.

In an embodiment of the sixteenth aspect, said OAM flow is provided for user plane traffic conforming to a connectionless communications protocol and wherein said first switching apparatus is configured by said adjunct processor to establish a connection to said second switching apparatus at the far end of the connection for said user plane traffic.

In an embodiment of the sixteenth aspect or the first statement of an embodiment of said sixteenth aspect, said step of separating out the OAM packets from the user plane packets is performed by processing said header field information at said second switching apparatus at the far end of the connection to determine one or more identifiers in said header information indicating that the received packets are OAM packets.

In an embodiment of the sixteenth aspect or the first or second statements of embodiments of said sixteenth aspect, said OAM packets contain header information indicating their destination address is the adjunct processor associated with said second switching apparatus at the far end of the connection whereby at said far end switching apparatus, said step of separating out the OAM packets from the user plane packets comprises further forwarding said OAM packets to said adjunct control plane processor.

In an embodiment of the sixteenth aspect or any one of the first to third statements of embodiments of said sixteenth aspect, said packetised traffic flow comprises a flow of OSI layer 2 packets.

In an embodiment of the previous statement of an embodiment of the sixteenth aspect of the invention, said OSI layer 2 packets comprise Ethernet frames.

In an embodiment of the sixteenth aspect or any one of the first to fifth statements of embodiments of said sixteenth aspect, said packetised traffic flow comprises a flow of OSI layer 3 packets.

In an embodiment of the previous statement of an embodiment of the sixteenth aspect of the invention, said OSI layer 3 packets comprise Internet Protocol packets.

In an embodiment of the sixteenth aspect or any one of the first to seventh statements of embodiments of said sixteenth aspect, the control plane processor injects said packetised OAM to said switching apparatus.

In an embodiment of the sixteenth aspect or any one of the first to eighth statements of embodiments of said sixteenth aspect, the OAM flow is implemented on demand.

In an embodiment of the previous statement of an embodiment of the sixteenth aspect of the invention, the OAM flow is implemented on demand when a connection is established by the control plane for traffic received at said first switching apparatus.

A seventeenth aspect of the invention comprises a method of implementing an OAM flow in a communications network comprising:
injecting a Ethernet frames from an adjunct processor to an Ethernet switch, the Ethernet frames comprising an OAM flow and user plane traffic, wherein the OAM flow has label field values which are the same label field values as the user plane connection to enable intermediate Ethernet switching apparatus to switch the OAM frames as if they were user frames;
at the far end of the connection,
separating out the OAM frames from the user plane frames; and
switching out the OAM frames in an adjunct processor for processing by an Ethernet switch according to its standard functionality.

An eighteenth aspect of the invention comprises an Ethernet switching apparatus capable of providing a connection-less service in a communications network, wherein the functionality of the Ethernet switching apparatus is modified by its control plane to provide a connection-oriented service for at least some of its ports, wherein an operational, administrational, and management (OAM) protocol supporting the connection-oriented functionality of the Ethernet switching apparatus is implemented using a processor which is different from the processor arranged to implement the connection-oriented service provided by at least some of the ports of the Ethernet switch for non-OAM traffic.

In an embodiment of the eighteenth aspect of the invention, the separate processing hardware is supported by a different platform from the platform supporting the switching functionality of the Ethernet switch for non-OAM traffic.

In an embodiment of the eighteenth aspect of the invention or of the first statement of an embodiment of the eighteenth aspect of the invention, the connection-oriented service provided by the Ethernet switch comprises a transparent point-to-point service.

In an embodiment of the eighteenth aspect of the invention or of the first statement of an embodiment of the eighteenth aspect of the invention, the connection-oriented service provided by the Ethernet switching apparatus comprises a transparent point-to-multipoint service.

In an embodiment of the eighteenth aspect of the invention or of the first statement of an embodiment of the eighteenth aspect of the invention, the OAM protocol applies to the aggregate flow associated with an aggregate flow associated with the transparent service offered by the Ethernet switch.

The nineteenth aspect of the invention comprises a system for implementing operational, administrational, and management (OAM) protocols for Ethernet switching apparatus, the system comprising:
a platform arranged to support software arranged to provide an OAM-type operation for the Ethernet switching apparatus, wherein said Ethernet switching apparatus is arrange to provide a transparent point-to-point service.

The 20^{th} aspect of the invention comprises a system for implementing operational, administrational, and management (OAM) protocols for Ethernet switching apparatus, the system comprising:
a platform arranged to support software arranged to provide an OAM-type operation for the Ethernet switching apparatus, wherein said Ethernet switching apparatus is arrange to provide a transparent point-to-multipoint service.

In an embodiment of the 19^{th} or 20^{th} aspects of the invention, the system according to the 19^{th} or 20^{th} aspects is arranged to provide a OAM protocol for an aggregate flow associated with said transparent service provided by said Ethernet switching apparatus.

The 21^{st} aspect of the invention comprises a processor arranged to provide an operational, administrational, and management (OAM) protocol to switching apparatus in a communications network, wherein a data forwarding functionality of the switching apparatus is controlled by a control plane to enable the switching apparatus to forward received Ethernet traffic over a plurality of paths to a destination in said communications network, wherein the OAM processor does not provide said data-forwarding functionality for non-OAM traffic received by said switching apparatus.

The 22^{nd} aspect of the invention comprises an out-of-band switch control system for a switching apparatus in a communications network comprising a plurality of switching apparatus interconnected to provide switchable data transport between data sources and data sinks, wherein the data forwarding functionality each switching apparatus performs on received traffic is controlled out-of-band by a control plane processor providing each switching apparatus with control data logically separated from the data sent between the data sources and data sinks.

In an embodiment of the 22^{nd} aspect of the invention, said switching apparatus comprises Ethernet switching apparatus, and said traffic comprises Ethernet frames.

In another embodiment of the 22^{nd} aspect of the invention, said switching apparatus comprises an IP router, and said traffic comprises IP packets.

In an embodiment of the 22^{nd} aspect or the first statement of an embodiment according to the 22^{nd} aspect of the invention, the control data is communicated to each switching apparatus using a virtual local area network.

In an embodiment of the 22^{nd} aspect of the invention or any one of the previous statements of embodiments of the 22^{nd} aspect of the invention, one or more virtual networks provided in the communications network are used to convey control information to the switching apparatus forming the communications network.

In an embodiment of the 22^{nd} aspect of the invention or any one of the first to fourth statements of embodiments of the 22^{nd} aspect of the invention, a control plane processor in the communications network provides control data to a plurality of switching apparatus.

A 23^{rd} embodiment of the invention comprises a switching apparatus arranged to received out-of-band switch control data from a control plane processor according to the 22^{nd} aspect of the invention or any one of statements of an embodiment of the 22^{nd} aspect of the invention, wherein said received control data enables the switch to implement its data forwarding functionality on received traffic.

A 24^{th} aspect of the invention comprises a switching apparatus arranged to received out-of-band switch control data from a control plane processor according to the 22^{nd} aspect of the invention or any one of statements of an embodiment of the 22^{nd} aspect of the invention, wherein said switching apparatus comprises Ethernet switching apparatus received control data enables the switch to implement its data forwarding and data filtering functionality on received Ethernet traffic.

In an embodiment of the 24^{th} aspect of the invention, said Ethernet switching apparatus comprises:
a data store arranged to forward received Ethernet traffic over said communications network to egress ports of the switching apparatus, said data store comprising a plurality of data records, each data record associating a received Ethernet frame with an egress port of the switching apparatus based on information extracted from the header of the received Ethernet frame; and
means to populate said data store records with information provided by a control plane processor of the switching apparatus, whereby the data forwarding functionality of the Ethernet switching apparatus is controlled by the control plane of the communications network.

In an embodiment of the previous statement of an embodiment of the 24^{th} aspect of the invention, said information provided by said control plane comprises at least one index identifier associated with an egress port, said index identifier type being the type of identifier said switching apparatus is capable of extracting from the header of a received Ethernet frame.

In an embodiment of the 24^{th} aspect or either of the first or second statements of an embodiment of the 24^{th} aspect of the invention, said switching apparatus comprises Ethernet switching apparatus deployed in a communications network, wherein said Ethernet switching apparatus previously provided only a connectionless Ethernet service over said communications network.

The 25^{th} aspect of the invention comprises a switching apparatus arranged to received out-of-band switch control data from a control plane processor according to an out-of-band switch control scheme of the 24^{th} aspect of the invention or of any one of the statements of invention dependent thereon, wherein said switching apparatus comprises Internet Protocol (IP) switching apparatus received control data enables the switch to implement its data forwarding and data filtering functionality on received Internet Protocol (IP) traffic.

In an embodiment of the 25^{th} aspect, said Internet Protocol (IP) switching apparatus comprises:
a data store arranged to forward received Internet Protocol (IP) traffic over said communications network to egress ports of the switching apparatus, said data store comprising a plurality of data records, each data record associating a received Internet Protocol (IP) packet with an egress port of the switching apparatus based on information extracted from the header of the received Internet Protocol (IP) packet; and
means to populate said data store records with information provided by a control plane processor of the switching apparatus, whereby the data forwarding functionality of the Internet Protocol (IP) switching apparatus is controlled by the control plane of the communications network.

In an embodiment of the 25^{th} aspect or the first statement of an embodiment of the 25^{th} aspect, said switching apparatus comprises Internet Protocol (IP) switching apparatus deployed in a communications network, wherein said Internet Protocol (IP) switching apparatus previously provided only a connectionless Internet Protocol (IP) service over said communications network.

In an embodiment of either the 24^{th} or 25^{th} aspects of the invention or any of the first to third statements of embodiments of the 24^{th} aspect or any of the first or second statements of embodiments of the 25^{th} aspect of the invention, said switching apparatus provides a transparent point-to-point service over said communications network.

In an embodiment of either the 24^{th} or 25^{th} aspects of the invention or any of the first to third statements of embodiments of the 24^{th} aspect or any of the first or second statements of embodiments of the 25^{th} aspect of the invention, said switching apparatus provides a transparent point-to-multipoint service over said communications network.

In an embodiment of either the 24^{th} or 25^{th} aspects of the invention or any of the first to third statements of embodiments of the 24^{th} aspect or any of the first or second statements of embodiments of the 25^{th} aspect of the invention, a field in a header of a traffic frame or packet received by said switching apparatus is associated with an egress port of the switching apparatus, and the switching apparatus forwards said received frame or packet to an egress port of the switching apparatus based on one or more of the following fields:
one or more globally unique destination address fields;
one or more globally unique source address fields;
one or more locally unique destination address fields;
one or more locally unique source address fields;
one or more Ethertype fields;
one or more IPV6 flow identifier fields;
one or more priority fields; and
one or more VLAN-ID fields.

In an embodiment of the previous statement of an embodiment of either the 24^{th} or 25^{th} aspects of the invention or any of the first to third statements of embodiments of the 24^{th} aspect or any of the first or second statements of embodiments of the 25^{th} aspect of the invention, said receive frame or packet encapsulates frame or packet locally unique to the source local area network for said received frame or packet.

In an embodiment of either of the 24^{th} or 25^{th} aspects of the invention or any of the first to third statements of embodiments of the 24^{th} aspect or any of the first or second statements of embodiments of the 25^{th} aspect of the invention, or any embodiments thereof, said switching apparatus is arranged to forward a received frame or packet either via an egress port of said switching apparatus arranged to provide a connection-less service or via an egress port arranged to provide a connection-oriented service, in dependence on information contained within the header of the received frame or packet.

The 26^{th} aspect of the invention comprises a control plane processor arranged to provide switching apparatus according to the 24^{th} or 25^{th} aspects of the invention or any statements of embodiments thereof, with out-of-band switch control data according to an out-of-band switch control scheme as claimed in any one of claims 1 to 6, the received control data enabling the switch to implement its data forwarding and filtering functionality on received traffic frames or packets.

The 27^{th} aspect of the invention comprises a communications network comprising a plurality of switching apparatus according to the 24^{th} or 25^{th} aspects of the invention or any statements of embodiments thereof, said switching apparatus being interconnected to provide switchable data transport between data sources and data sinks, the communications network providing an out-of band control system for each of said plurality multiplicity of Ethernet switches.

The 28^{th} aspect of the invention comprises a method of generating a virtual local area network to carry control plane traffic between a plurality of switching apparatus in a communications network, the method comprising:
configuring on each of said plurality of switching apparatus at least one port to be associated with said VLAN carrying said control plane traffic;
receiving on said switch control plane signalling from a control plane processor associated with said switching apparatus;
forwarding on said port associated with said VLAN said control plane signalling traffic to each one of said plurality of switching apparatus having a port configured for said VLAN traffic, whereby when said control plane signalling is a destination one of said plurality of switching apparatus, said switching apparatus is arranged to be capable of communicating said control plane signalling with a control plane processor within which said switching apparatus is associated.

The 29^{th} aspect of the invention comprises a method of enabling a control plane to automatically discover the interconnectivity of a plurality of switching apparatus in a communications network, said switching apparatus being re-configured to provide support for connection-oriented modes of communication by having all functionality for supporting connection-less modes of communication disabled, the method comprising the steps of:
re-enabling a connection-less mode in a partition of at least one of said switching apparatus exclusive to management and control information;
issuing messages from the control plane by broadcasting through the management partition;
receiving at least one of said messages at an existing switching apparatus at the end of a new link and/or at a new switching apparatus of said communications network;
responding to said at least one received message at said existing or new switching apparatus by communicating with said control plane, said communication enabling said discovery of said interconnectivity of said new switching apparatus and/or said new link.

The 30^{th} aspect of the invention comprises a method of establishing a management connection in a communications network, comprising the steps of:
firstly generating a virtual local area network to carry management traffic as in the 28^{th} aspect; and
secondly, discovering the connectivity between said switching apparatus using the method as in the 29^{th} aspect.

The 31^{st} aspect of the invention comprises a method of configuring switching apparatus to receive management and/or signalling information comprising the steps of:
retaining a broadcast functionality on one or more specific ports of said switching apparatus,
disabling all pre-existing functionality supporting pre-configured connectionless protocols from other ports of said switching apparatus, said other ports being re-configured by information derived from said management and signalling information received on said one or more specific ports to provide one or more connection-oriented modes of transport for traffic received at said other ports, said traffic received at said other ports conforming to a connectionless communications protocol,
whereby, said one or more specific ports of said switching apparatus are configured to logically isolate said received management and/or signalling information from other traffic received by the switching apparatus.

In an embodiment of the 31^{st} aspect, said retained broadcast functionality enables said switching apparatus to forward said received management and signalling traffic in a connection-less manner;

In an embodiment of the 31^{st} aspect of the invention or of the first statement of an embodiment of the 31^{st} aspect, said switching apparatus logically isolates received management and/or signalling information by associating an identifier extracted from the header of a packet or frame carrying said information with said one or more specific ports of said switching apparatus.

The 32^{nd} aspect of the invention comprises a communications scheme for configuring a network comprising a plurality of connected switching apparatus, each switching apparatus having functionality for implementing connectionless forwarding of received communications traffic to selectively provide a connection-oriented service for said received communications traffic, the scheme comprising:
determining index header field values to identify traffic received at switching apparatus for which a connection is to be established between a source node and a destination node;
providing each switching apparatus necessary to implement the connection with information which enables their data forwarding tables to be populated with said index header field values in association with egress ports of the switching apparatus; and
disabling all other functionality on said switching apparatus capable of populating the data forwarding tables with index information associated with said egress ports of the switching apparatus necessary to establish said connection.

In an embodiment of the 32^{nd} aspect of the invention, a plurality of differing types of index header field values are provided by the control plane.

In an embodiment of the previous statement of an embodiment of the 32^{nd} aspect of the invention, the differing types of index header field values are arranged hierarchically, and different levels of the hierarchy are associated with different egress ports of the switching apparatus.

Thus one aspect of the invention seeks to provide a method of using legacy switching apparatus to provide a connection-oriented service, in which the required information to establish an end-to-end connection has been provided by a control plane processor. This removes any need to provide interrupts and/or to use any address learning and/or loop avoidance functions. Instead each switching apparatus is provided with data from the control plane. The route information provided from the control plane relates to routes that are preconfigured to ensure the switching apparatus provides a connection-oriented service. In some embodiments of the invention, conventional switching apparatus arranged to support connection-less modes of transport may require modification to enable its command line interface to provide information for populating the forwarding tables of the switching apparatus to provide an end-to-end connection-oriented mode of transport. In some embodiments of the invention, however, such a modification is limited to using software to reconfigure the interface. In this way, the command line interface enables information which originates from the control plane to populate the forwarding tables of the switching apparatus (whereas conventionally, the data forwarding tables are populated using information from the data plane in a manner well known to those skilled in the art).

Thus in one aspect, the invention seeks to use the control plane to configure legacy switching apparatus to provide an end-to-end connection-oriented service across a communications network and/or internetwork. Implementing the invention to provide a connection-oriented service over a communications internetwork connecting a plurality of local area networks (LANs), requires the provision of consistent routing information to populate the forwarding tables of each switching apparatus within the internetwork. This may be provided by a centralised control plane associated with all switching apparatus within the internetwork or by a distributed control plane, which requires information to be communicated between the distributed processors control plane

One aspect of the invention provides a scheme by which management information and signalling information is securely communicated to the switching apparatus by retaining some functionality on specifics port of the switching apparatus such that a broadcast function can be retained. The scheme removes all pre-existing functionality supporting pre-configured protocols on other ports which are to provide connection-oriented modes of transport. Certain embodiments of the invention provide a control plane arranged to dynamically control the functionality of one or more ports of a plurality of switching apparatus deployed in a communications network to establish a connection for traffic which otherwise conforms to a connectionless protocol from a source edge node of the communications network to a destination edge node of the communications network. The edge nodes may provide access to and from one or more local area networks. In this way, the switching apparatus is capable of changing the mode of operation of the ports for routing traffic from connection-oriented to connection-less by selectively restoring functionality associated with a connection-less mode of transport (e.g. retaining the spanning tree and MAC address learning protocols) and ceasing to provide routing information from the control plane. In this way, in some embodiments, the connection-oriented mode can be remotely and/or dynamically controlled by using the control plane to deactivate/remove/uninstall connection-less functionality on specific ports of the switching apparatus and instead provide routing information from the control plane.

The data provided by the control plane processor is arranged to control at least the data forwarding function the switching apparatus performs on received packets. The received packets conform to a connectionless protocol. The data received by the switching apparatus from the control plane enables the switching apparatus to operate to provide a connection-oriented mode of transport for the received packets across a communications network. The header information of the packets retains the format of the connectionless protocol whilst being transported in a connection-oriented manner across the network.

By co-ordinating how the forwarding tables of switching apparatus across the communications network are populated from the control plane, the switching apparatus (which may comprise a bridge, router, switch or hub or any apparatus capable of performing a suitable data forwarding and/or filtering and/or switching function) is arranged to provide a connection-oriented environment, i.e., it is possible to change the mode in which data forwarding is provided by the switching apparatus (connection-less or connection-oriented) using the control plane.

Thus for Ethernet, connectionless processes such as the spanning tree and bridge learning processes are no longer required on those ports of the switching apparatus used to establish a connection across the communications network as signalling from the control plane is provided and the control plane signalling can be used to determine if a path has already been transited, which enables looping to be avoided. In some embodiments of the invention, if a packet is received for which no path has been pre-configured, the packet is dropped, and all required information to establish the connection-oriented service must populate the address tables in advance of the receipt of any packets to avoid packet loss. Thus in these embodiments the switching apparatus is configured to have a default discard function for packets which are received and for which no information has been provided in the address and forwarding tables.

The control plane can be in-band but is preferably out-of-band as in-band it is more vulnerable to attack. Advantageously, there is no need to reserve a subset of the available address space to function as a label for implementing the connection-oriented service. As the control plane is now populating at least part of the switching apparatus forwarding tables in the communications network, the control plane can selectively format the index fields upon which the switching apparatus performs the look up operation to provide greater versatility and flexibility. This may be done by including additional index fields, replacing index fields, or having a number of differing index fields, which may be arranged such that forwarding is performed on a hierarchical basis. In some embodiments, the provision of a plurality of differing types of index fields enables flow control to be performed in the event of congestion of an outgoing port of the switch automatically.

Those skilled in the art will appreciate that the aspects as set out in the independent claims or aspects can be combined with any of the dependent features as set out in the dependent claims in any appropriate manner apparent to those skilled in the art.

The invention provides similar benefits to that provided by Multi-Protocol Label Switching (MPLS) without the associated cost implications the MPLS approach involves for the hybridisation of connectionless and connection-oriented packet switching.

Embodiments of the invention will now be described with reference to the accompanying drawings which are by way of example only and in which:

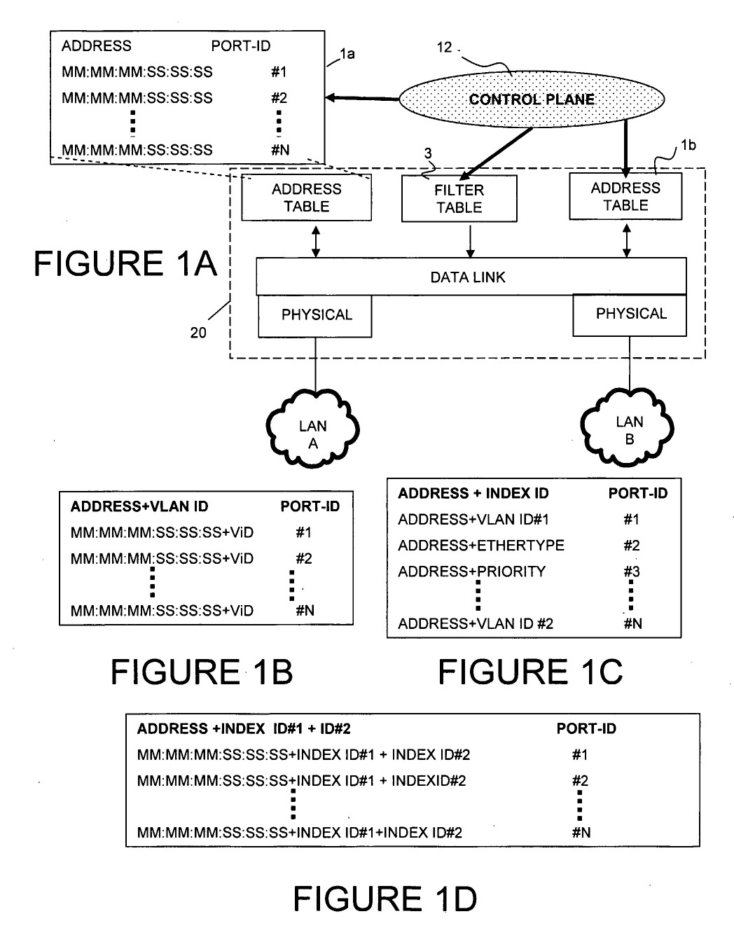

FIG. 1A shows a control plane according to the invention populates the MAC address tables of Ethernet switching apparatus;

FIG. 1B shows schematically an alternative embodiment of a forwarding table populated by a control plane according to an embodiment of the invention;

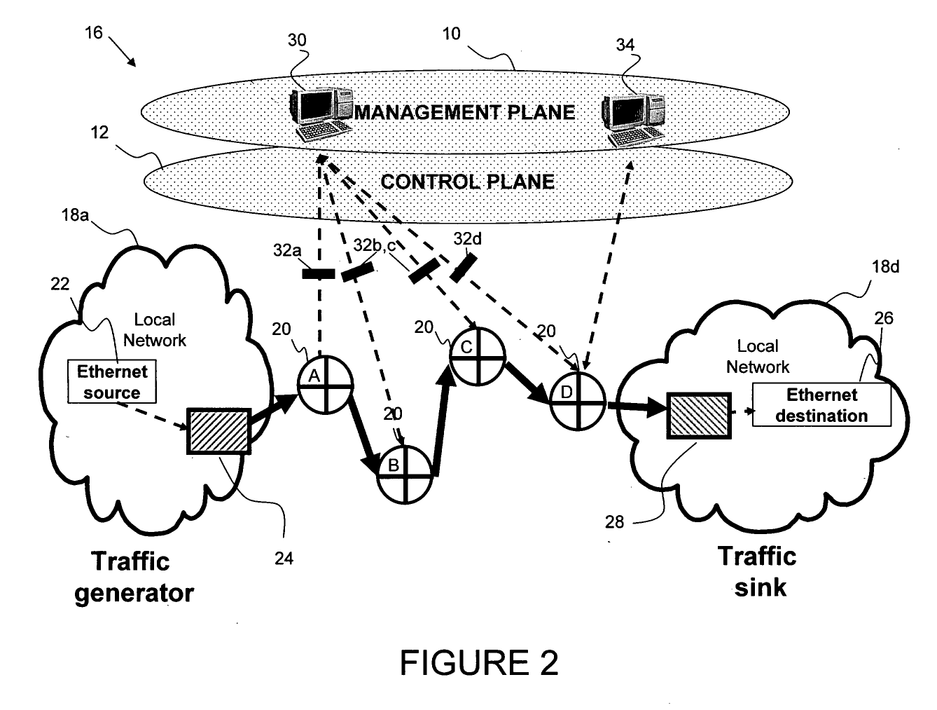

FIG. 2 shows an Ethernet communications network according to one embodiment of the invention.

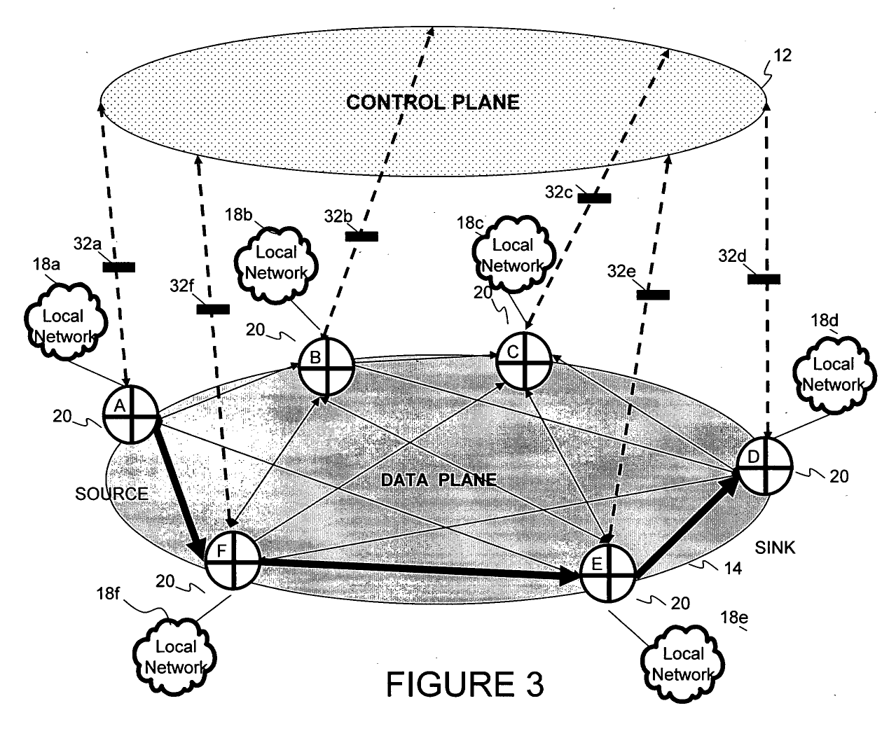

FIG. 3 shows how the control plane interfaces with the data plane of a communications network according to one embodiment of the invention;

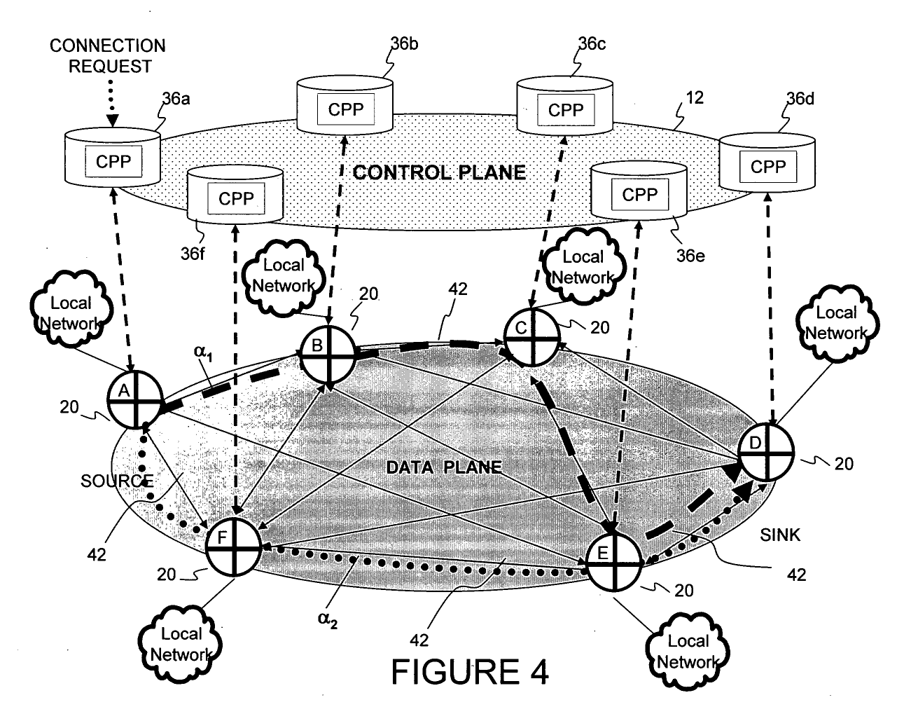

FIG. 4 shows an embodiment of the control plane interface of FIG. 3;

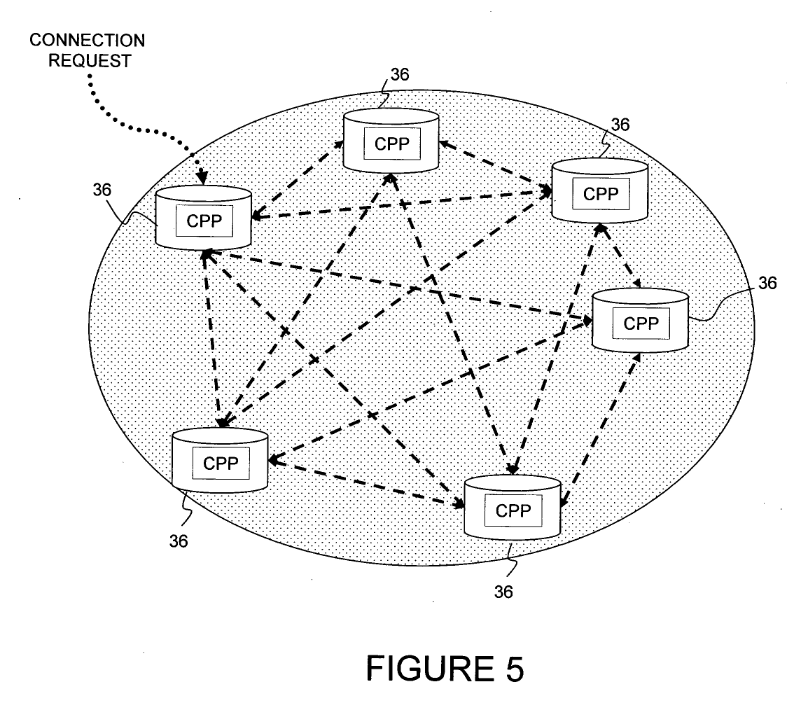

FIG. 5 shows in more detail the distributed control plane of FIG. 4;

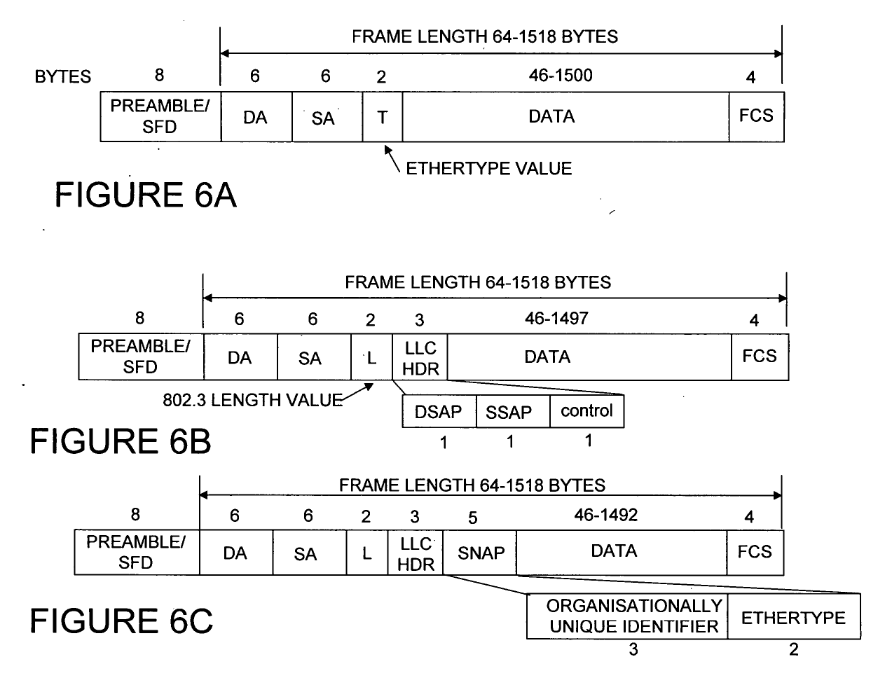

FIGS. 6A, 6B and 6C show examples of a standard Ethernet frame as known to those skilled in the art;

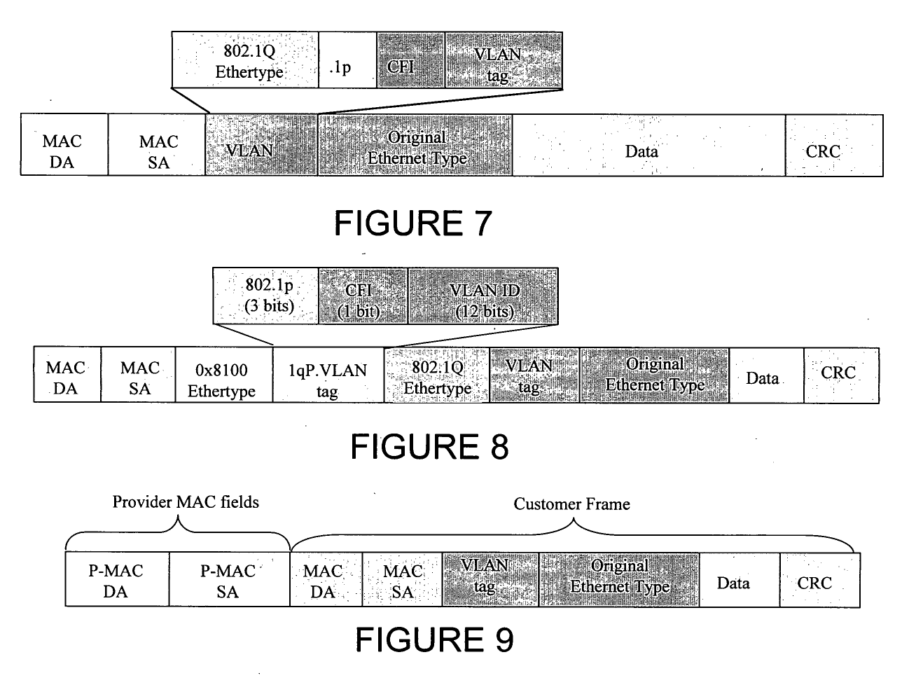

FIG. 7 shows in more detail how a VLAN tag is conveyed in an standard Ethernet frame;

FIG. 8 shows how Q-in-Q is conveyed in an Ethernet frame;

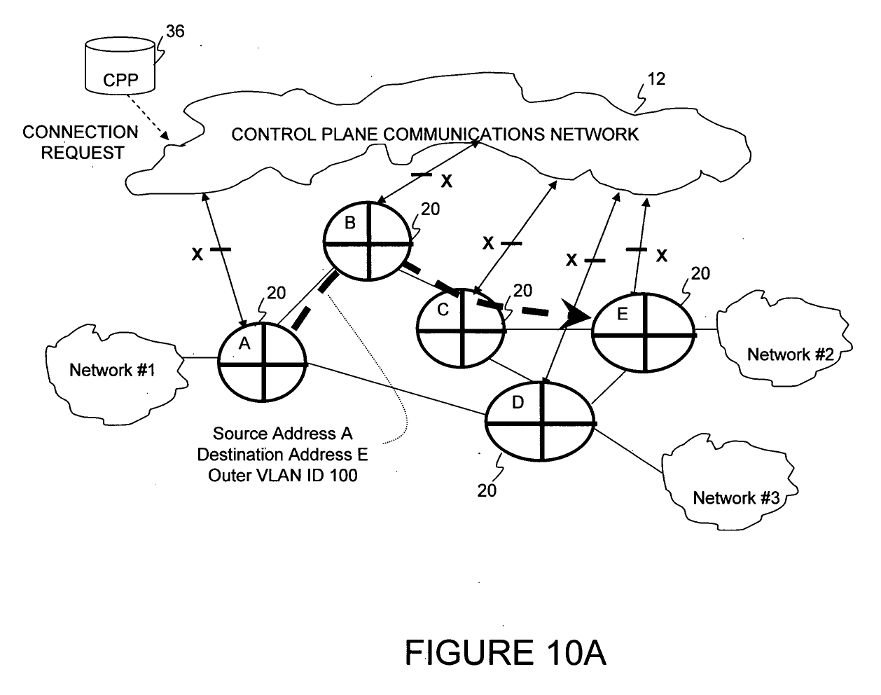

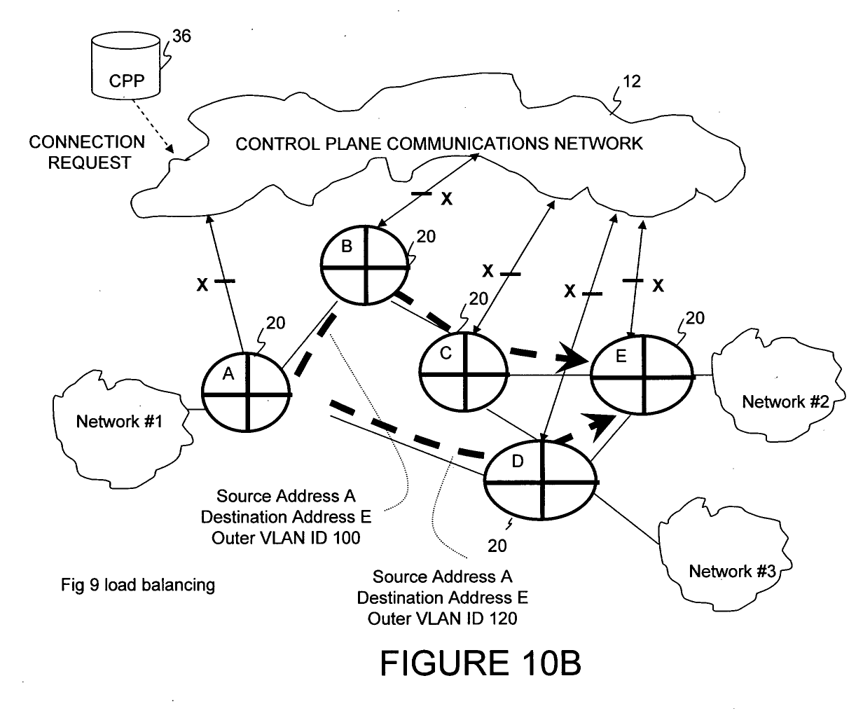

FIG. 9 shows how MAC-in-MAC is conveyed in an Ethernet frame;

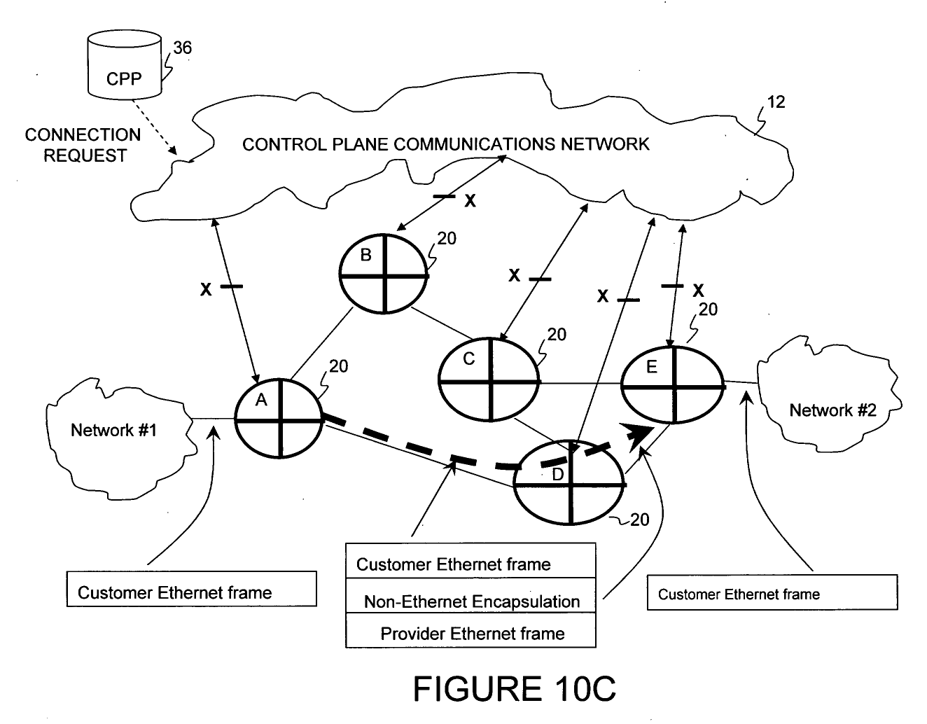

FIG. 10A shows an embodiment of the invention in which a connection-oriented Ethernet is provided;

FIG. 10B shows how multiple connections between Ethernet switches may be provided in the connection-oriented Ethernet of FIG. 10A;

FIG. 10C shows how the carrier frame may encapsulate the customer frame information in an embodiment of the invention.

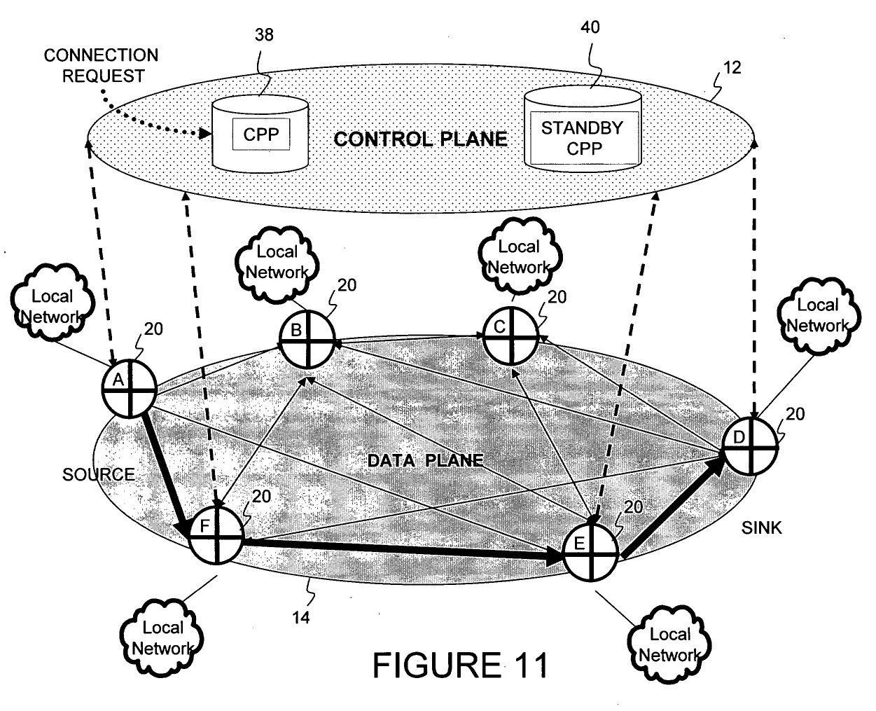

FIG. 11 shows a centralised control plane according to an embodiment of the invention;

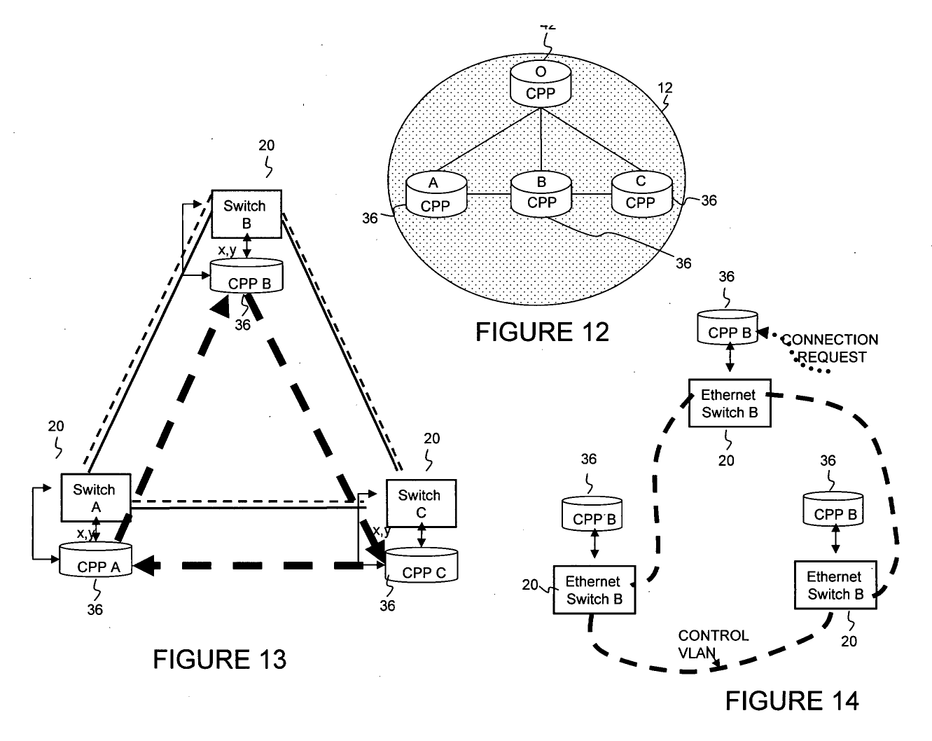

FIG. 12 shows a hierarchy of control plane processors according to another embodiment of the invention;

FIG. 13 shows signalling between control plane processors according to one embodiment of the invention;

FIG. 14 shows signalling between control plane processors according to another embodiment of the invention;

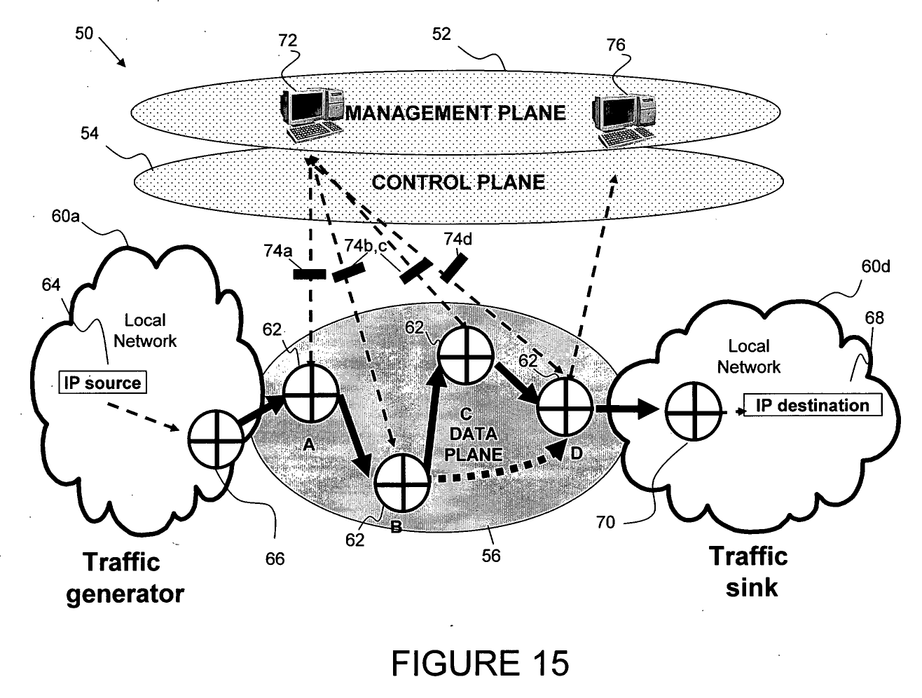

FIG. 15 shows how the control plane interfaces with the data plane of a IP communications network according to one embodiment of the invention;

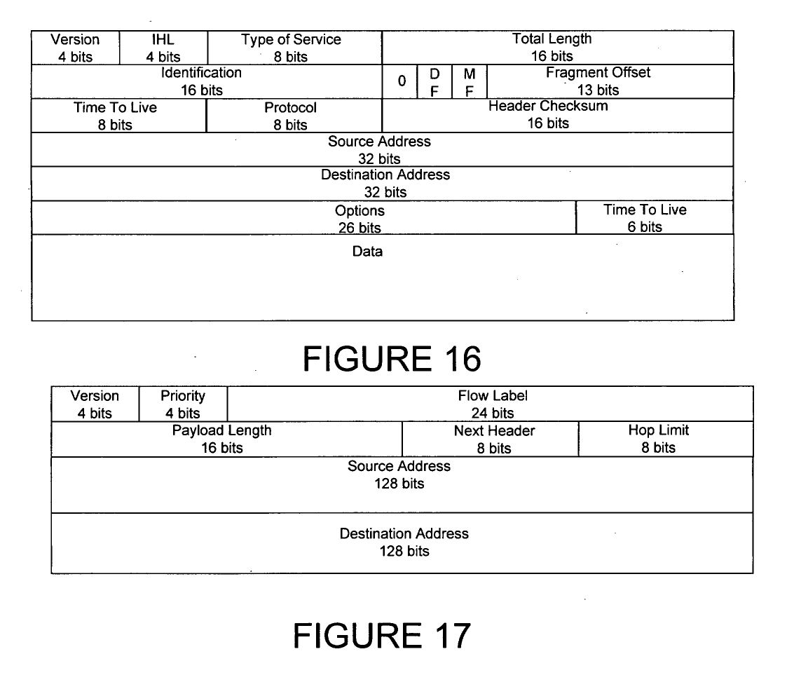

FIG. 16 shows the format of an IPv4 frame header;

FIG. 17 shows the format of an IPv4 frame header;

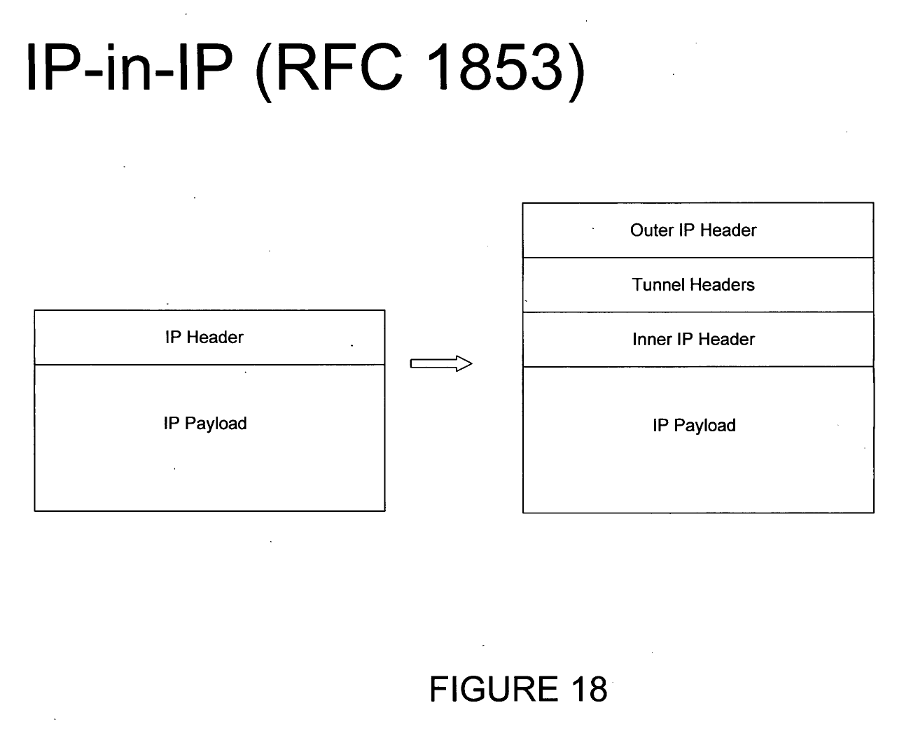

FIG. 18 shows the format of IP-in-IP frame headers conforming to RFC 1853;

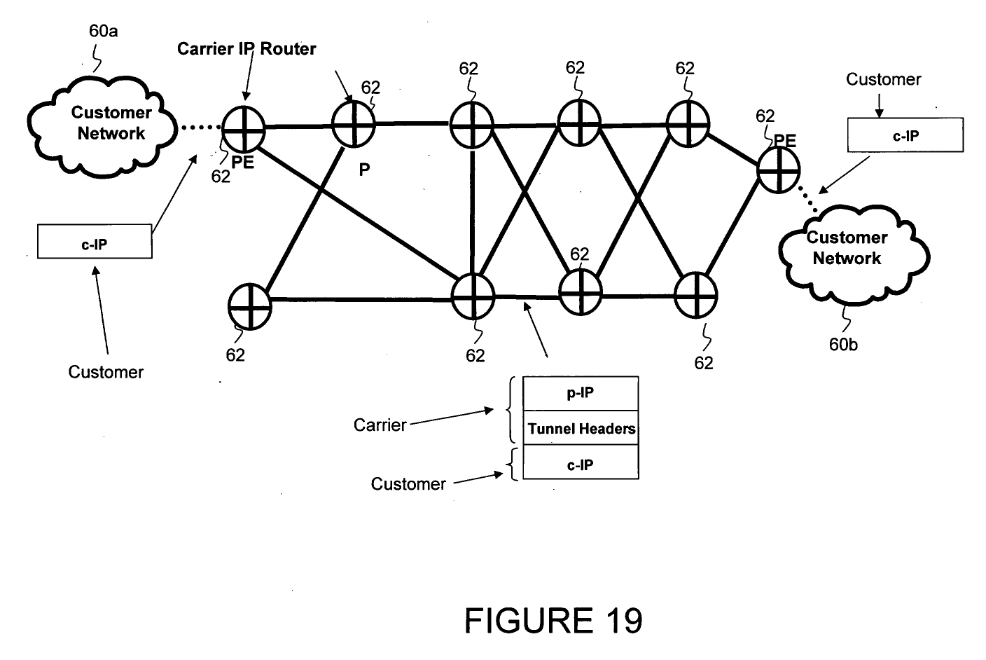

FIG. 19 shows how an IP carrier frame may encapsulate customer IP frame information in an embodiment of the invention;

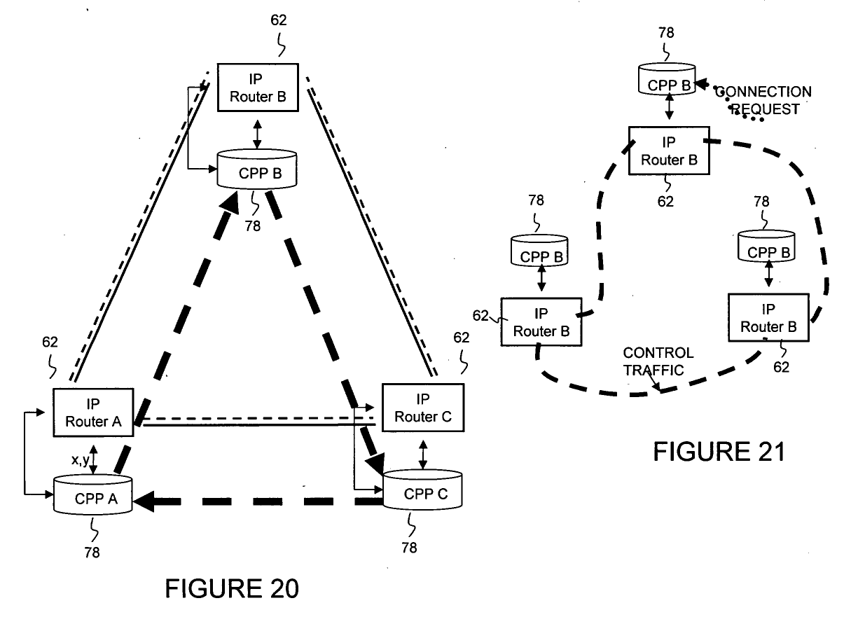

FIGS. 20 and 21 show how signalling may be provided between control plane processors in two embodiments of the invention;

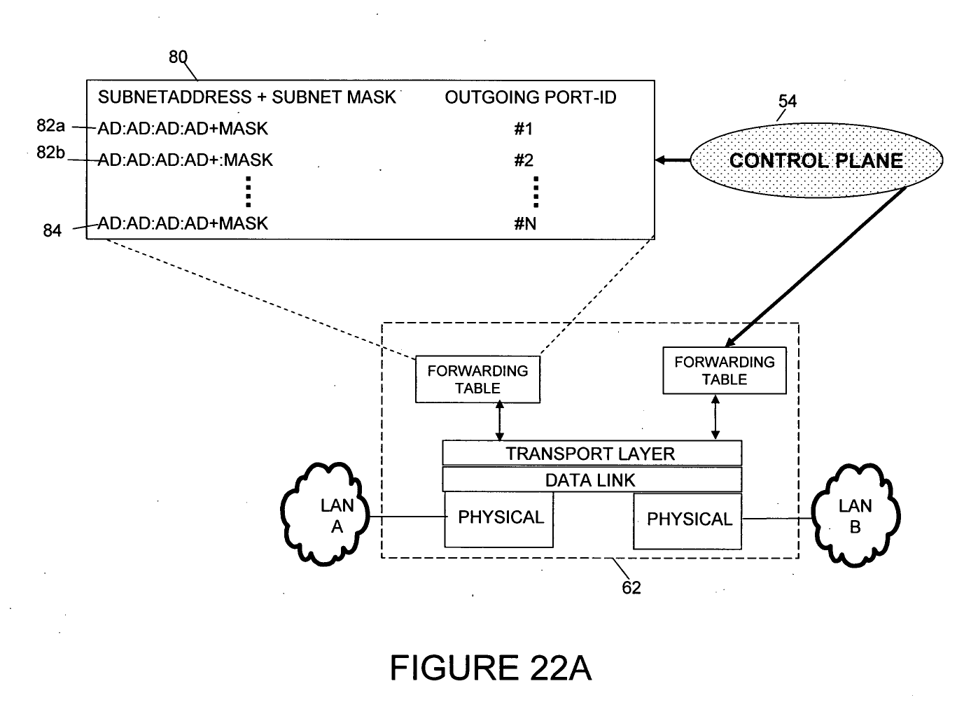

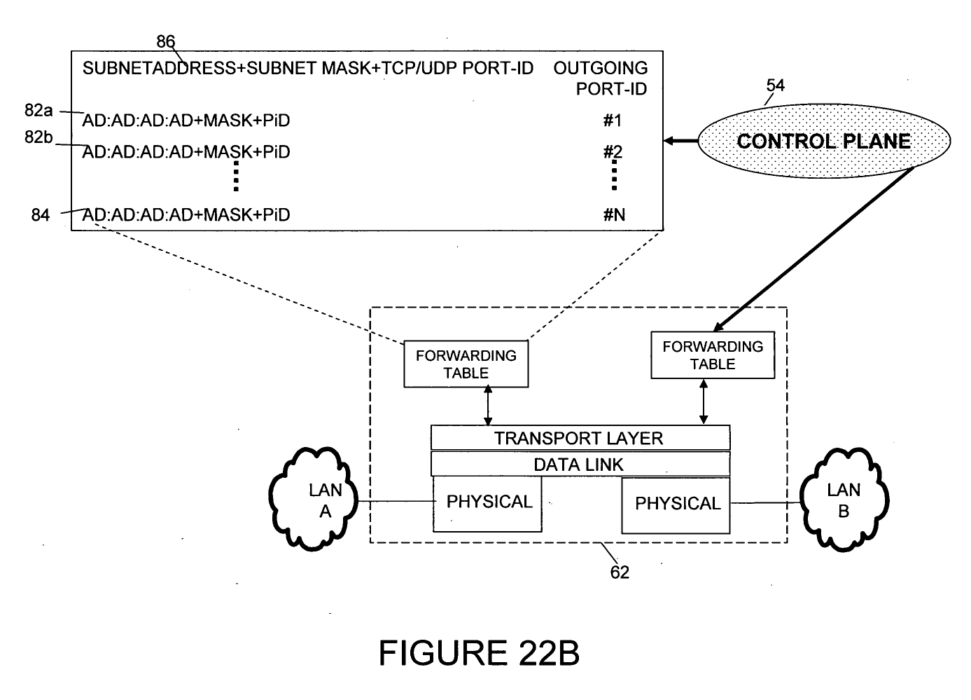

FIG. 22A shows how the control plane populates a forwarding table according to one embodiment of the invention;

FIG. 22B shows how the control plane populates a forwarding table according to another embodiment of the invention; and

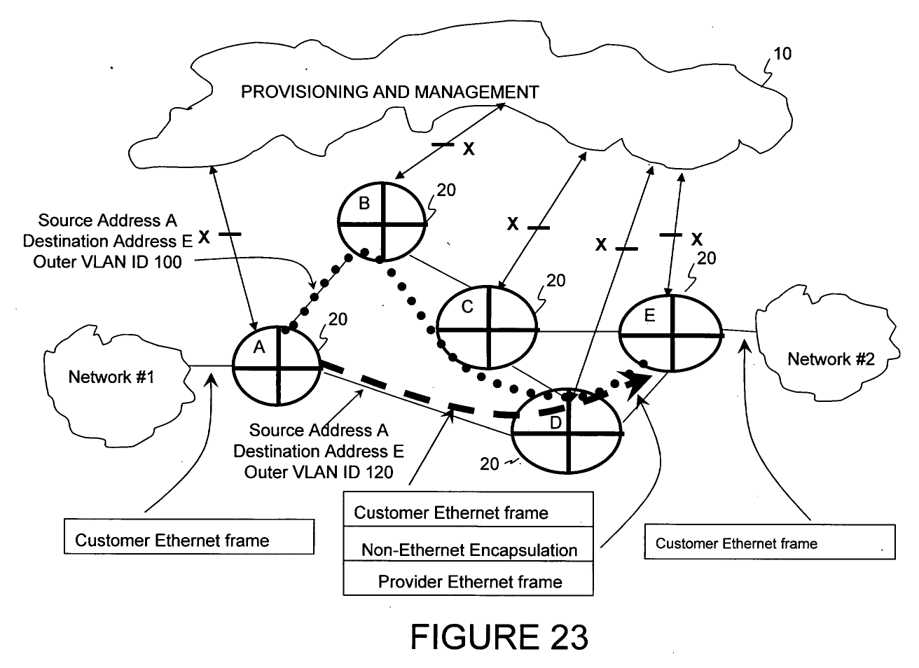

FIG. 23 shows how customer traffic frames can be encapsulated within a provider frames according to an embodiment of the invention.

Embodiments of the invention, including the best mode of the invention currently contemplated by the inventors will now be described with reference to the accompanying drawings. In the following description, for purposes of explanation, numerous specific details are set forth in order to provide a thorough understanding of the present invention. It will be evident, however, to one of ordinary skill in the art, that the present invention may be practiced without these specific details. In other instances, well-known structures and devices are shown in simplified diagrammatic form to facilitate explanation and additional detail known to one of ordinary skill in the art has been omitted for clarity. Where a possible alternative component having equivalent functionality is apparent to those skilled in the art, the description is intended to implicitly include such functional equivalents unless explicitly excluded. A consistent numbering scheme is used for all components in the drawings having equivalent functionality unless stated otherwise. For simplicity, unless there is a need to distinguish between the differing components, features will be referred to as switching apparatus 20 and network 18, instead of switching apparatus 20a,b,c,d,e,f and network 18a,b,c,d,e,f etc.

Referring now to the accompanying drawings, FIGS. 1A and 1B show schematically how a control plane according to the invention populates the MAC address tables of Ethernet switching apparatus.

FIG. 1A shows schematically how a control plane 12 can be used to populate the address forwarding tables 1a, 1b and address filtering tables 3 of Ethernet switching apparatus 20. Instead of the Ethernet switching apparatus 20 populating the forwarding tables in the conventional manner, for example, by learning which ports are associated with which MAC addresses, the control plane is used to directly configure the MAC address tables to associate specific port identifiers with received Ethernet MAC frames). The term “port” is equivalent to “interface” in the context apparent to those of ordinary skill in the art. Similarly, where reference has been made to a particular form of PDU, e.g., a packet, the term “packet” should be read as a synecdoche for any equivalent PDU, e.g., frame for which the invention can be implemented.

As the forwarding tables of the switching apparatus are directly provided with address information associated with outgoing ports of the switching apparatus, there is no need to implement an “address learning” process to enable the switching apparatus to associate received traffic whose destination address is unknown with an outgoing port of the switching apparatus. Instead, if no association of address and outgoing port is known, then the switching apparatus discards the received packet.

Although in IEEE 802q, an interface to the control plane is used to provided static address information, in IEEE 802.1q, existing protocols such as spanning tree and the MAC address learning protocols remain active. In contrast, the invention reconfigures the switching apparatus so that the information provided by the control plane to the forwarding address tables of the switching apparatus is not capable of being autonomously over-written by pre-existing protocols associated with the now unused connectionless control plane. A MAC address is generally assumed to be a unique value associated with a node's network adapter and uniquely identifies the adapter on a Local Area Network (LAN). An example of MAC address is a 12-digit hexadecimal number (48 bits in length) (for example, such as is shown in table 1a by MM:MM:MM:SS:SS:SS in FIG. 1A). The first half of the address field is the ID number of the adapter manufacturer. The second half of the address field is the serial number assigned to the adapter by the manufacturer.

The Ethernet switching apparatus 20 is able to operate in either half-duplex or full duplex mode, and is capable of supporting a full duplex, point-to-point OSI-layer-2 protocol service in a fully collision-less mode. Ethernet switching apparatus 20 receives Ethernet frames from LAN A and routes the frames to LAN B using address tables 1a, 1b associated with each of its ports and filter table 3. The filter table 3 limits traffic to certain logical port associations, such as are used, for example, to configure Virtual Local Area Networks.

FIG. 1B shows an alternative version of a forwarding table, in which the control plane 12 populates the entries in the forwarding table with at least one other Ethernet header field in addition to the destination address field. In FIG. 1B, the control plane further associates a VLAN with an outgoing, or egress port of the switch. This VLAN-Id is used to distinguish between multiple paths across a communications network comprising a plurality of connected Ethernet switching apparatus. However, as mentioned later in more detail herein below, a number of other alternative Ethernet header fields can be provided to populate the forwarding table of the switching apparatus.

According to the invention, there is no need to allocate subsets of the address space or any other header fields to flag a particular packet for receiving connection-oriented forwarding. Instead, a connection across the communications network is established by the control plane by providing appropriate forwarding information in the switching apparatus for the address space allocated to the traffic for which the connection is to be provided. The traffic may be identified by the control plane using any appropriate header field or combination of header fields, and differing traffic may be provided with different field combinations. The network operator or service provider for the core network can selectively provide a connection-oriented service for connection-less protocol traffic across the core network. This may be according to the conditions in the core network generally, or if traffic to a particular destination address is unbalancing the network, etc. The decision to provide a connection-oriented service for traffic may also be performed automatedly. Alternatively, a connection request may be placed in the manner well known to those skilled in the art.

Once it has been determined that a connection should be established across the core network to a particular destination address, the control plane is used to configure switching apparatus across the communications network to establish the connection for traffic based on associating an index entry with an outgoing port or interface of the switching apparatus. Examples of index entries include: destination address, or a combination of destination address and one or more other header field information, such as VLAN-ID, or Ethertype, or if a priority tag is present in the header, or the IP flow label or type of service.

FIGS. 1C and 1D show alternative embodiments of forwarding tables for which the control plane can be configured to provide forwarding information according to embodiments of the invention. In FIG. 1C, the control plane has populated the index field(s) with a combination of different index types. The switching apparatus can be configured in this case to look for different fields to be matched, or to continue to look up its entries in the event the particular egress port first matched is congested. This would also enable different paths may be established for traffic. Thus in FIG. 1C, by way of example, if a packet was received with VLAN-ID type #1 for a particular destination address associated with port-ID #1 of the switching apparatus, the switching apparatus may check the Ethertype of the received packet, and if it matches the next index-field entry, route the port out via port-ID#2, or if this port were congested etc or if no match for Ethertype were found, check the priority of the packet etc. Alternatively (or additionally), packets which have no VLAN-ID field may be forwarded on the basis of Ethertype or some other header field etc. The type of information on which a look up can be performed is limited only by the type of information the switching apparatus can extract from the header field, and the ability of the control plane (and any required software stub) to populate the forwarding table with an index entry in a suitable form.

FIG. 1D shows an alternative form of forwarding table in which the control plane provides a tuple type of index identifier for each port, in this case the destination address, and a first and second index identifier. For example, each port may be associated with a DA, a VLAN-ID, and another index identifier, e.g., the Ethertype.

Referring now to FIGS. 2 and 3 of the accompanying drawings, the Ethernet communications network functionality is provided by a management plane 10, a control plane 12 and a data/forwarding plane 14 (see FIG. 3). The management plane 10 provides the appropriate interfaces to configure, control and manage the Ethernet network. The control plane 12 provides the logical and physical interfaces to set up and control the activities of the data/forwarding plane 14 (see FIG. 3) via the command line interface or by any other way specified in any one of the IEEE standards, for example, IEEE 802.1. The management and/or the control plane 12 can perform the call control and connection control functions, and uses signalling to set up and release connections and to restore connections in the event of failure, for example by setting up soft permanent connections. The data forwarding plane 14 provides the filtering and forwarding functionality used to transport network data.

The invention enables packets conforming to connectionless protocols to be transported across a communications network in a connection-oriented mode by providing routing information to legacy switching apparatus and disabling the functions of the switching apparatus which might overwrite or otherwise provide other routing information. The routing information provided enables switching apparatus to provide a connection-oriented service as all functionality of the switching apparatus which would result in a connectionless service is disabled. Such switching apparatus is readily available and relatively cheap, whereas switching apparatus constructed to support a connection-oriented protocol such as MPLS is relatively expensive. A potential benefit of the invention is that it enables legacy equipment arranged to support connectionless communication protocols to be upgraded to support connection-oriented modes of communication. Advantageously, the invention also enables services to be differentiated in terms of quality of service, priority, bandwidth etc.

According to the invention, the control plane provides routing information, e.g., equipment which generates control information for the switching apparatus is used to provide the switching apparatus with routing and signalling information. This control information includes information which can be used to populate the look-up routing tables of the switching apparatus. Switching apparatus originally designed and/or installed in a communications network to support connectionless communication protocols is thus able to provide a connection-oriented service to received packets.

The term “packet” is used synonymously to imply a packet or a cell (e.g. a fixed length packet), or in some embodiments of the invention a frame as those skilled in the art will find apparent. Data for transmission through a network is assembled into packets each of which carry a header and a payload, the header indicating the source and sink addresses and the payload carrying the data to be delivered. Packets will also carry other data fields which relate to the validity of the overall packet being transmitted. The packets do not need to modify their header information to be able to benefit from the connection oriented service provided by the switching apparatus. Examples of connectionless protocols for which a connection-oriented service can be provided by switching apparatus conforming to the invention include the standard Ethernet protocols and the standard Internet Protocols (e.g. IPv4 and IPv6).

According to the invention, switching apparatus is provided with means for control information to be received, and the control plane (a term used herein to refer to any suitable arrangement of apparatus capable of providing such control information to the switching apparatus) directs channel data signals through the switching section to effect transmission of data from a “source” to a “sink”. The source may be a PC or server as may be the sink, the source referring to the transmitting unit and the sink the receiver. It will be appreciated that in most communications sources and sinks are present at both ends of the link, that is they are co-located, and may simply be a sender/receiver of a computer or a transceiver circuit of a telephone instrument.

All terms used herein retain the definitions given in the International Telecommunication Union (ITU)'s ITU-T Recommendation G.805 “Generic functional architecture of transport networks”, the contents of which are incorporated herein by reference, unless explicitly indicated as having a different meaning which is inconsistent with the meaning given in G.805.

When a frame arrives at the Ethernet switching apparatus the header is processed, and information is extracted to enable the source-sink combination for the packet to be determined. In one embodiment of the invention, this determined by communicating information extracted from a plurality of header fields to the control plane. The control plane then determines whether this is a message for a known source-sink combination. In alternative embodiments, the control plane has already communicated sufficient information to enable the source-sink combination to be determined at the switching apparatus. If the source-sink combination is known, by which it is meant if the information extracted from the header matches information already held in a data store accessible by the switching apparatus, a previously established single route is used to transfer the message through the data switching section.

Referring now to FIG. 2, an embodiment of the invention is shown in which a communications network 16 (e.g. a wide area network (WAN)) comprising a first network 18a of local hosts, for example a customer LAN, is connected to a second network 18b of local hosts, for example another customer LAN, via a plurality of interconnected Ethernet switching apparatus 20. For clarity, four Ethernet switching apparatus 20 are shown in FIG. 2, which are labelled A, B, C, and D.

In FIG. 2, network 18a provides a source 22 of traffic which is transmitted via a suitable edge device 24 (for example, a traffic concentration means providing some multiplexing functionality) to Ethernet switch A. Network 18d as shown in FIG. 2 functions as the Ethernet traffic sink 26, and receives Ethernet traffic from Ethernet switch D via an appropriate edge device 28 (for example, a traffic de-concentration means providing a de-multiplexing function). A local network may, however, in practice function as both a source and a sink of Ethernet traffic, as is well known to those skilled in the art.

In FIG. 2, routing information for the routing tables of Ethernet switching apparatus A is input by a network manager 30 using an appropriate command line interface (CLI) 32a. Routing information is similarly provided via CLIs 32b, c, d to populate the forwarding tables of each of the Ethernet switching apparatus 20 B, C, and D. Other functionality may be implemented on a Ethernet switching apparatus, for example, such as a packet sniffer 34 on Ethernet switching apparatus D.

As mentioned before hereinabove, in order to function correctly as a connection-oriented Ethernet switching apparatus, as the switching apparatus was pre-configured to support connectionless communications protocols, the pre-configured protocols (for example the bridge learning and spanning tree protocols, and any VLAN specific-control protocols not required by the invention) must be turned off for all ports on the Ethernet switching apparatus which provide the connection-oriented service.

In the best mode of the invention, all functionality supporting the pre-configured protocols on all ports of the switching apparatus is disabled. In other embodiments of the invention, specific functionality is retained on specified ports of the switching apparatus. This allows the use of virtual local area networks (VLANs) for management purposes. For example, it allows a broadcast facility to achieve autodiscovery of new links and new nodes, but confined only to the management VLAN.

The routing table entries associated with all ports providing a connection-oriented service are populated using information provided by the control plane via a command line interface (CLI) or by any other way specified in an IEEE standard, for example, IEEE 802.1. By providing routing information to populate the routing table using the interface which is used to convey standard control information to the switching apparatus, any switching apparatus which conforms with the prevailing standard requirements for supporting connectionless communications protocols can be reconfigured to support connection-oriented modes of communication. Thus, for Ethernet switching apparatus, in order to provide an end-to-end connection, each switch A, B, C, D is populated with forwarding table entries appropriate to the end-to-end connection, as the Ethernet routing header information is the same in each switch.

An end-to-end connection can be specified from the control plane by exploiting the global uniqueness already inherent in the Ethernet MAC-addressing scheme. If the MAC addresses are not unique for some reason, some other means to confer a unique identity on the traffic source is provided, for example using a VLAN header, described in more detail later herein below.

FIG. 3 shows schematically an embodiment of the invention in which a control plane network 12 is arranged to provide routing information to the data plane 14. In FIG. 3, a plurality of interconnected Ethernet switching apparatus 20, labelled A, B, C, D, E, and F are shown. The Ethernet networks are shown fully interconnected in FIGS. 3, 4, & 11, but to benefit from the invention, it is sufficient for a plurality of paths to exist between the Ethernet switching apparatus.

In FIG. 3, each Ethernet switching apparatus 20 is connected to a local area network 18 (LAN), and is further connected to one or more Ethernet switching apparatus 20 to provide a larger communications network 16, for example, a wide area network (WAN). Where a particular LAN is associated with a particular virtual LAN (VLAN), traffic will be tagged to identify it as belonging to the VLAN (see FIGS. 6, 7) and the VLAN traffic will access the Ethernet network 16 only via the native port on the Ethernet switching apparatus 20 associated with that VLAN.

In FIG. 3, the Ethernet data forwarding and filtering functionality of all the ports on each of the Ethernet switching apparatus 20 provided in the data plane 14 is controlled from the control plane network 12 via the command line interface 32a, b, c, d, e, f associated with each Ethernet switching apparatus 20. The control plane network 12 comprises an end-to-end control plane communications network which de-activates and configures the learning and spanning tree data forwarding/filtering functionalities of all of the ports of each Ethernet switching apparatus 20 in the communications network which are to offer a connection-oriented service and terminates all associated bridge protocol data units (BDPUs) on those ports.

The control plane network 12 can be implemented either in a centralised manner or in a distributed form, depending on the number of the control plane processors (CPPs) 36 (not shown in FIG. 3), how they are deployed in the network and their relationship to each Ethernet switching apparatus 20.

Once the MAC address learning and spanning tree functionalities have been disabled (for example by the control plane 12 or by manually disabling them at the switch), the control plane 12 creates and provides routing information necessary to populate the MAC address and VLAN-ID tables and any other header field tables entries. The Ethernet switching apparatus then uses this information to establish appropriate Ethernet link connections 42 between the Ethernet switching apparatus themselves. It is possible for the Ethernet switching apparatus to support both uni-directional and/or bi-directional link connections (and thus provide a full duplex service, as is well known to those skilled in the art).

Each Ethernet switching apparatus 20 implements data forwarding based on the lowest VLAN header in each frame of Ethernet traffic received by performing a looking up operation on the identifier for the VLAN (the VLAN-ID) in its forwarding table. As the VLAN-ID table is now populated by information derived from the control plane of the switching apparatus, the data will be forwarded in such a way as to provide a connection-oriented service. If there is no VLAN header, then the switching apparatus forwards the received Ethernet frame using at least the destination MAC address. The forwarding process is provided after the VLAN headers associated with network layers terminating on a particular Ethernet switching apparatus 20 have been removed from the VLAN protocol stack at that switching apparatus.

In addition, one or more new VLAN headers may be added to the VLAN protocol stack at the egress ports of the Ethernet switching apparatus 20. In practice, the lookup operation to provide a connection-oriented service may be performed for a number of fields of the Ethernet header, and as such, enable differentiated services to be provided for different VLANs/traffic flows, for example, services which differ in quality of service, priority, bandwidth etc.

The switching apparatus control provided by the control plane 12 implements the control functions (or an appropriate subset) identified and described in the International Telecommunication Union ITU-T Recommendation G.8080, entitled Architecture of the automatically switched optical network (ASON), the contents of which are hereby incorporated by reference. Preferred embodiments of the invention implements a control plane in a manner consistent with G.8080 which allows for the concept of a connection and a call, separation of control and user plane, and the separation of call control and connection control. Alternatively, GMPLS, MPLS, or a legacy PSTN control plane, or a network management system could be used.

The control plane has 12 visibility over the Ethernet network and is thus aware what resources are free. Once a path from A to D has been signalled, the control plane 12 needs to know at D what resources are available to establish the connection, i.e., to determine what resources are free. For example, if VLAN-ID 50 is free, the control plane 12 informs all switching apparatus 20 via the control plane processors (CPPs) 36 (not shown explicitly in FIG. 3) to use VLAN 50. When a connection request is received by a CPP 36, the CPP 36 processes the request to determine how to talk to the CPP 36 at the far end of the control plane 12 (i.e., the CPP 36 for the Ethernet switching apparatus 20 at which traffic leaves the Ethernet core network) and all intermediate CPPs 36. The request may provide a specific route or identify end-points, and can ask the CPP 36 to find a route.

In embodiments where a request for connection is received by a control plane processor (CPP) 36 via an Ethernet switching apparatus 20 for which the CPP 20 controls the data forwarding and filtering functionality, the Ethernet switching apparatus 20 functions dumbly when forwarding the request for connection to the CPP 36 (i.e., the CPP 36 does not control how the Ethernet switching apparatus 20 forwards received connection requests to the control plane 12).

Referring now to FIG. 4 of the accompanying drawings, the control plane 12 is shown schematically as comprising a plurality of interconnected adjunct control plane processors (CPP) 36a,b,c,d,e,f. The term “adjunct” is used herein to indicate that the processor is not “on-switch”, i.e., that it is not part of the original preconfigured switch. Each Ethernet switching apparatus 20 is connected to a local network 18 comprising interconnected local hosts (for example, a customer LAN). Each network 18 associated with a VLAN ID is provided with a default (or native) port on the Ethernet switching apparatus 20, and the VLAN tables are now populated with information provided by the control plane 12. The control plane 12 retains routing information, which is used to populate the data forwarding tables (i.e., the MAC address tables 1a,b and/or filtering tables 3 shown in FIG. 1C) provided in the data forwarding plane with data forwarding information. In FIG. 4, the routing information is provided for each Ethernet switching apparatus 20 via its respective a command line interface (CLI) 32 (shown as a bar on the dashed line connecting each control plane processor 36 and its associated Ethernet switching apparatus 20 in FIG. 4).

In FIG. 4, each CPP 36 is arranged in one-to-one correspondence with the Ethernet switching apparatus it controls. Information is exchanged between the CPPs 36 by means of an appropriate signalling network (see FIG. 5 for example). FIG. 5 shows how a signalling network between a plurality of CPPs 36 may be configured in the control plane 12 to facilitate connection-set up. One of the plurality of CPPs 36 receives the connection request and communicates this to the management plane or other routing facility which determines an appropriate route (or routes if a plurality of paths are to be followed) for traffic to follow from source node to destination node across data plane 14. The signalling network may be implemented in the form of a VLAN which interconnects a plurality or all switching apparatus within the data plane such that signalling information is separately routed from non-signalling traffic. In this way, it is possible to configure switching apparatus to retain some ports configured to function in a connection-less mode of operation and/or retain routing protocols such as spanning tree etc for the signalling information, even though the spanning tree and any other connection-less routing protocols would be disabled on the other ports of the switching apparatus, i.e., so that normal traffic is switching in a connection-oriented manner.

Returning now to FIG. 4 again, each CPP 36 comprises an adjunct processor which generates information controlling how the data forwarding table of the Ethernet switching apparatus 20 are updated. Each CPP 36 also prevents rogue frames with MAC addresses or VLAN headers which are not recognised by the signalling information provided from passing through the switching apparatus via the ports offering the connection-oriented service. For example, frames which unrecognised MAC addresses or VLAN-IDs may be discarded.

Apart from now being capable of offering a connection-oriented service, the remaining functionality of the Ethernet switching apparatus 20 is unchanged, as the change in switching apparatus behaviour necessary to provide the connection-oriented service is simply a result of changing the forwarding table entries to provide such a service.

As the control plane 12 is populating the forwarding tables and now the spanning tree algorithm is disabled, the spanning tree algorithm no longer prevents multiple routes from being established and multiple paths between Ethernet source and sink using Ethernet trunks 42 across the network are possible. This enables functionality such as load-balancing to be implemented across the network.

FIG. 4 shows two paths α₁, α₂ between Ethernet switching apparatus A and D. Path α₁ is via Ethernet switching apparatus B and C, and α₂ is via Ethernet switching apparatus F and E. Multiple connections can now be provided using the Ethernet switching apparatus 20 offering a connection-oriented service.

As an example, traffic can be switched to a new path dynamically if its current path suffers an unacceptable level of degradation as the control plane can be used to dynamically reconfigure the traffic flow from A to D. For example, a network operator 30 may reconfigure the traffic flow in the event that packet sniffer 34 detects the congestion at Ethernet switching apparatus 20d as FIG. 2 shows.

This enables a high bandwidth source of Ethernet traffic to maintain its quality of service to its sink even when other traffic is subsequently generated which impacts the original path α₁ over the network.

Traffic can also be sent simultaneously along two paths (e.g. α₁, α₂) or more paths simultaneously if the bandwidth is required, and appropriate sequencing etc operations can be performed at the destination Ethernet switching apparatus 20 D. In one further embodiment of the invention, the data forwarding table entries of all Ethernet switching apparatus associated with both routes α₁, α₂ are pre-populated, so that if α₁ fails one only needs to repopulate the forwarding table of the source Ethernet switching apparatus 20 A to effect the change over from the α₁ route to the α₂ route.

The control plane processors CPP 36 provide call connection control functionality in addition to providing routing information. In FIG. 4, CPP 36a controlling switching apparatus A is shown receiving a connection request. CPP 36a then determines an appropriate route for the traffic originating from the source customer network 18a to the sink customer network 18d. CPP 36a also ensures appropriate signalling is sent to the other Ethernet switching apparatus 20 on the route CPP 36a has determined (e.g., for path α₁, Ethernet switching apparatus B, C and D) so that their forwarding tables are appropriately updated.

If VLAN tags are present in the Ethernet packet headers, in one embodiment of the invention, the traffic flows are separated using VLAN tags. This enables appropriate traffic management to be implemented (for example, to enable network load balancing). The VLAN tags do not need to be swapped, and if they are not swapped they can be used as part of a global identifier if they are combined with a VLAN address. In this way a fully scalable solution for managing a scalable network can be provided by, for example, forwarding traffic based on a combination of destination address and VLAN tag, or by stacking VLAN tags (such as occurs when implementing Q-in-Q in the manner known to those skilled in the art). If VLAN tags are swapped by the Ethernet switching apparatus, a VLAN-ID will remain only of local significance.

An end-to-end connection between the source Ethernet switching apparatus A and the sink Ethernet switching apparatus D is thus provided by populating each of the forwarding table entries for the MAC address learning table and the VLAN-ID table for each Ethernet switching apparatus 20 along a path (e.g. α₁ , and/or α₂) with appropriate forwarding table entries. Forwarding is implemented by the forwarding table matching the relevant header information of the Ethernet packet to an out-going port of the Ethernet switching apparatus.

FIGS. 6A, 6B, and 6C, collectively show schematically the standard versions of Ethernet frame currently known to those skilled in the art, and FIG. 7 shows schematically how a standard format Ethernet frame is tagged with a virtual local area network identifier (VLAN ID) and also the VLAN ID tag structure.

FIG. 6A shows the Ethernet V2.0 frame format, FIG. 6B shows the Institute of Electrical & Electronic Engineers standard recommendation IEEE 802.3 frame format with an Institute of Electrical & Electronic Engineers standard recommendation IEEE 802.2 LLC header, and the Ethernet frame shown in FIG. 6C conform with the Institute of Electrical & Electronic Engineers standard recommendation 802.3 with LLC/SNAP variants. However, the term Ethernet frame referred to herein is not limited to these given embodiments but refers to any type of Ethernet frame format capable of implementing the invention.

In a conventional Ethernet network, a basic untagged Ethernet frame such as one of those shown in FIGS. 6 A,B,C consists essentially of a source media access control (MAC) address (SA) and a destination MAC address (DA), a type field and data forming the payload of the Ethernet packet. A standard VLAN tag header, for example, an IEEE 802.1Q compliant VLAN tag header, is inserted between the source MAC address and the type field as FIG. 7 shows. The format of standard Ethernet Frames is well known to those skilled in the art, and a full explanation of all fields and associated functionality is omitted here for clarity.

Where traffic is tagged with a VLAN-ID, the Ethernet switching apparatus 20 are configured to switching apparatus each packets so that it is communicated only to ports associated with the same VLAN on each Ethernet switching apparatus 20 in the communications network 16. In order to switching apparatus traffic between different VLANs, additional functionality (for example, Internet Protocol address forwarding functionality or some other form of OSI layer-3 forwarding functionality) is provided either on or off the Ethernet switching apparatus 20. Any of the relevant fields in the Ethernet frame header, either individually or in combination, for example, the DA, SA, Ethertype, priority, VLAN-ID of the VLAN header may be used. In one embodiment of the invention, the control plane only looks at the MAC address and sets up multiple virtual networks based on the Ethertype to offer multiple QoS. This results in two instances of a control plane existing logically, i.e., two virtual networks are provided, and the domain of control is able to differ for each virtual network according to some embodiments of the invention. In this way, a customer of a carrier network providing the Ethernet service over the core-network 16 can be provided with access to one of the virtual networks to enable them to have a degree of control within the core network.

The 12-bit VLAN-ID field imposes a limitation in that only 4096 VLAN customers are possible at any time. Multiple VLAN tagging to the same Ethernet packet to create a stack of VLAN Ids enables different entities to implement layer two switching on the different levels of the VLAN-ID stack—this is often referred to as Q-in-Q—and enables hierarchical VLAN tagging within an Ethernet packet.

FIG. 8 shows schematically how Q-in-Q is implemented in a standard Ethernet frame and FIG. 9 shows schematically how MAC-in-MAC is implemented in a standard Ethernet frame as are well known to those skilled in the art. The frame format implementing these schemes are already known to those skilled in the art, and thus a full description of all the fields shown in FIGS. 8 and 9 and their associated functionality is omitted here for brevity.

By encapsulating the customer's information, and providing hierarchical addressing schemes such as Q-in-Q and Mac-in-Mac (see FIGS. 8 and 9, which are described above), the control plane is isolated from the customer in some embodiments of the invention. As the control plane operates its own addressing scheme by providing an outer header to the conventional header information at the source Ethernet switching apparatus 20a, security across the network is enhanced.

One embodiment of the invention implements Q-in-Q in which an additional tag is inserted into the customer's Ethernet frames in the manner well known to those skilled in the art. In this an embodiment, the Ethernet switching apparatus 20 processes each received Ethernet frame to forward data across the Ethernet network 16 based on just the outer VLAN header so that the inner VLAN header (shown in the top half of FIG. 8) is ignored. Alternatively, the Ethernet switching apparatus 20 may examine both the outer and inner VLAN headers and make forwarding decisions which are based on the entries the control plane has provided for both VLAN-IDs in the VLAN-ID forwarding table of each Ethernet switching apparatus 20.

In one embodiment of the invention, a MAC-in-MAC encapsulation scheme is controlled by the control plane 12. In this embodiment, the customer source and destination MAC addresses are encapsulated within MAC address fields at the network edge Ethernet switching apparatus 20. When MAC-in-MAC encapsulation is implemented, the customer frame is encapsulated and does not interact with the control plane, instead the control plane acts on the encapsulating MAC headers provided by the Ethernet switching apparatus, enabling the customer MAC addresses to remain effectively invisible over the Ethernet core network 16.

In FIG. 9 the provider (P) frame is shown adjacent to the customer frame. The provider frame includes fields such as a VLAN or MAC field which are completely independent of the customer frame (which could contain, for example, no VLAN tag, or a VLAN-tag or Q-in-Q). In this manner, enhanced security can be provided as within the network core the MAC addresses used are those provided by the carrier whose MAC addressing scheme is being used, with the customer MAC addresses only being de-encapsulated at the network edge switching apparatus if required.

FIG. 10A of the accompanying drawings shows an embodiment of the invention in which a connection-oriented Ethernet is provided. FIG. 10A shows an end-to-end control plane 12, such as may be provided, for example, using—the automatic switched optical network (ASON) for controlling a plurality of interconnected switching apparatus 20.

The control plane sets up the connections, populating the bridging tables on the switching apparatus in the manner described herein above, so that the Ethernet switching apparatus have their MAC learning disabled, and so the spanning tree protocol is deactivated, and so no BPDUs are provided. Flows are separated using one or more fields in the Ethernet frame according to the capability of the switching apparatus, for example, VLAN tags, which enables appropriate traffic management to be implemented (for example, to enable network load balancing). The VLAN tags are not swapped, and have only local significance, which ensures that they are not in practice limiting to the scalability of the network.

This enables multiple connections to be provided between the Ethernet switching apparatus, such as FIG. 10B shows. In FIG. 10B, a first path is shown between switching apparatus A, B, C, and E, and a second path is shown between switching apparatus A, D, and E. At node A, the control plane has configured the outgoing ports to forward traffic which is associated with VLAN ID 100 along the first path, and traffic having VLAN ID 120 is forwarded along the second path.

The embodiment of the invention shown in FIG. 10C provides a multi-service multiplexing technology. This embodiment enables a carrier network to implement a multi-service multiplexing of Ethernet and other services at the network edge using mapping technologies such as GFP and ATM-Layer-Adaptation. Switching apparatus A receives a customer Ethernet frame, which is encapsulated at switching apparatus A (or at some other edge device not shown in FIG. 10A) into a service provider frame. In some embodiments of the invention, the address associated with the service provider is added to the encapsulating header. In other embodiments, the encapsulated header address information continues to be used to forward the encapsulated frame through switching apparatus 20.

FIG. 10C shows a particular embodiment of the invention in which a packet-in-ethernet service for the core network is shown, however, those skilled in the art will appreciate that the principles of wrapping a customer frame inside a carrier's Ethernet frame can be applied for other technologies. s the customer's frame is untouched, transparency is provided. The carrier is free to use their own addressing scheme (providing scaling, security, isolation and fault detection). In this embodiment of the invention carrier OAM (especially management) traffic is distinguished from customer traffic as the OAM frames have only a single header (e.g. Y.17ethoam).

In one embodiment, only the edge Ethernet switching apparatus understands the customer address space. This is not necessary however, if a point-to-point service is provided, in which case the core Ethernet switching apparatus 20 need only understand the provider address space.

As shown in FIGS. 10A to 10C, the Ethernet network 16 provided by the invention uses the Media Access Control (MAC) source address (SA) and destination address (DA) to provide an end-user connection-oriented packet-ed (CO-PS) service (in the highest Ethernet layer network), with VLAN header fields being used to define the server layers below which transport the higher CO-PS layer. This enables a service provider/network operator to offer a “leased line” type of service where the customer MAC layer and any higher VLAN layers are transported transparently (see, for example, FIG. 10C of the accompanying drawings). In one embodiment of the invention, the service provider/network operator is able to add another proprietary server layer to implement proprietary services such as traffic engineering etc.

Those skilled in the art will be aware that G.8080 describes an architecture for the control plane of a connection-oriented network, and it is by implementing the connection-oriented functionality of the G.8080 control plane that a connection-oriented service can be provided in the connectionless Ethernet network environment. The G.8080 connection-oriented control plane is used to control the connectionless Ethernet technology and in doing so converts the behaviour of the Ethernet switching apparatus.

In one embodiment of the invention, an appropriate interface is provided conforming to G.8080 to separate the call/connection control plane processors (CPP) 36 and the Ethernet switching apparatus 20, for example, each Ethernet switching apparatus 20 may be controlled via its existing proprietary command line interface (CLI) 32. Not shown in this drawings is the stub or mediator that this embodiment requires which translates commands across the CLI (i.e., which handles changes to the command line interface or the control plane and translates between the “language” used on either side of the interface). The G.8080 architecture also allows for the control plane to be integrated into the switching apparatus platform. Whilst this may require modifications to the switching apparatus platform to add control plane functionality there is no need to change the hardware providing the data forwarding functionality.

In another embodiment of the invention, a standardised interface between the switching apparatus and the control plane such as the Generalised Switching apparatus Management Protocol (GSMP) is used to implement the control plane functionality. For example, GMPLS and network management protocols or similar control or management plane protocols can be used to implement the necessary functionality, for example, the eXtensible Mark-up Language (XML) or International Telecommunication Union (ITU) Telecommunications (ITU-T) Recommendation M.3100.

Operations, Administration and Maintenance

Operations, Administration and Maintenance or OAM is a fundamental part of any Service Provider's network. This is because it reduces the cost of services through allowing for remote monitoring and troubleshooting of equipment and configurations through alarm detection and notification. Thus faults are located quicker and resolved faster, leading to increased customer satisfaction.

One embodiment of the invention implements OAM functionality on a software platform which is off-switch (i.e., on a different platform providing separate hardware for the OAM traffic to the Ethernet switching apparatus processing hardware for non-OAM traffic). This enables the OAM functionality required by the invention to be provided without any direct modification of the embodiments of Ethernet switching apparatus according to the invention. Moreover, as the standards providing in this field evolve, by implementing the OAM service off-switch, e.g., on a software platform, it is easy to adapt the OAM functions provided to conform to the appropriate standard protocols.

Currently, no standard Ethernet OAM exists and only vendor proprietary solutions exist. Three standards bodies—IEEE, ITU-T and the Metro Ethernet Forum are currently developing standards to introduce OAM into Ethernet segments in the sense of Ethernet providing a connectionless service. These standards are expected to be aligned with those available for Frame-Relay and ATM and include functionality such as discovery, continuity check, loopback, path trace, performance management and alarm suppression. However, whilst Ethernet OAM in a connectionless Ethernet environment will improve the fault isolation ability of Ethernet, it does not provide the same level of information provided in a connection-oriented network like SDH and ATM.

One embodiment of the invention implements OAM functions consistent with the requirements specified in International Telecommunications Union (ITU-T) Recommendation Y.1710, entitled “Requirements for Operation & Maintenance functionality for MPLS networks” by implementing a slightly modified version of the operation and maintenance mechanism proposed solution in ITU-T Recommendation Y.1711 entitled “Operation & Maintenance mechanism for MPLS networks”.

Embodiments of the invention which implement Y.1710-like OAM, implement a OAM system in which the most generic entity in the user plane functional architecture is a source (and/or partitioned source subsequent to the source in the flow domain) which broadcasts/multicasts, and a sink, (and/or partitioned source prior to the sink in the flow domain) which filters. Labelling in its most generic sense is essential to this entity as source and destination labelling allow the sink to filter a unique source/destination communication. A subnetwork and a flow domain are examples of this entity. However, a link is also a special case of this entity. In a link, explicit destination labelling is not needed as there is only one destination. Source labelling is required in order for the sink to demultiplex. In addition, a link does not merge traffic, by definition. As such the source is in full control of the multiplexing of a link. Based on this entity, the distinction between layering and partitioning is more subtle. To implement a subnetwork or flow domain it is necessary to create a “server” set of labels using adaptation functions in a way exactly parallel to that of a server layer supporting a link. The labelled broadcast domain with filtering sinks is the true bottom of the stack.

In ITU-T Recommendation G.805 there are two possible types of OAM flow, the end-to-end trail OAM flow and the intermediate tandem-connection monitoring OAM flow.

In an Ethernet protocol data unit (PDU), there are two levels of labels (or layers)—the Ethernet MAC Source Address (SA)/Destination Address (DA) and the VLAN header layers (which may be further subdivided if there are more sublayers) and so four types of OAM flow are needed:
Trail MAC SA/DA layer OAM flow (lets call this OAM flow type A);
Tandem Connection Monitoring MAC SA/DA layer OASM flow (OAM flow type B);
Trail VLAN layer OAM flow (OAM flow type C);
TCM VLAN layer OAM flow (OAM flow D).

In OAM flow type A the SA and DA in each packet are globally unique and so no further access point identification is needed. In addition each frame has a FCS which can be used for performance monitoring. Explicit OAM packets can be designed, possibly using an Ethertype ID, however, alternatively, the IP and a User Datagram Protocol (UDP) port number can be used.

The other three flows all have essentially the same basic implementation. Ethernet frames are injected by the adjunct processor (CPP 36,38) for the relevant Ethernet edge (or core) switching apparatus 20 and this can be tied to the signalling control which sets up the connection. At the far end, the OAM frames are separated out from the user plane traffic and are switched out in the adjunct processor (CPP 36,38) for processing.

Thus to implement the above OAM flows, firstly, the OAM flow should have the same values in the label fields as the user plane connection so that any intermediate Ethernet switching apparatus switch the OAM frames as if they were user frames. Alternatively, more than one label value per connection can be provided but this does not necessarily test the accuracy and integrity of the signalling and forwarding tables in the same way. Secondly, the OAM frames need to be extracted from the user plane and switched in the Ethernet switching apparatus according to the standard functionality of an Ethernet switching apparatus.

There are several ways of achieving these two requirements, however, the MAC address of the adjunct processor (CPP 36, 38) interface sourcing the OAM flow in the SA field of the OAM frame is used in a preferred embodiment of the invention.

FDI and AIS

As in any CO-PS network, tributary labelling is not hardwired and so the insertion of Alarm indication signals (AIS) and/or Fault detection & identification (FDI) requires that the OAM process look up the label table to find which labels are current and valid. In this embodiment of the invention, the OAM processing is performed by an adjunct processor (CPP 36, 38) located in the control plane and not in the same hardware as the user plane. AIS and/or FDI are now additional indicators to the end-to-end flows.

Generally, AIS and FDI are triggered from a failure detected in the adaptation from a server layer. They do not replace the end-to-end OAM flow in the client layer as that flow and only that flow can monitor the integrity of that client connection. The loss of the client connection is inferred when there is a corresponding loss of the associated OAM flow. If AIS and/or FDI signals are received in addition to the loss of the main OAM flow, then the sink can infer that the fault is not local to the sink. Since AIS and/or FDI are now additional information not essential information, loss or corruption of its insertion is not fatal and not open to misinterpretation.

Connection orientation means that “addressing and labelling” can be decoupled from each other, with the signalling system used to associate them. The invention treats the MAC address as a “Label” which is only visible in the control plane. In principle, any addressing scheme could be used as addressing is only visible to the adjunct processor of the Ethernet switching apparatus, i.e., only visible in the control plane. However, in order to give compatibility with connectionless networks, Internet Protocol version 4 (IPv4) addressing could be used or alternatively, Internet Protocol version 6(IPv6). Given the widespread use of private addressing, a globally unique address has been implicitly created in one of two forms. The first form is the implicit global address VPNid/IPv4 address used in Internet protocol (IP) virtual private networks (VPNs). The second form of a globally unique address is a Network Address Transport (NAT) address. This globally unique address is implicitly formed as the concatenation of the gateway's public IPv4 address followed by the private IPv4 address. Alternatives such as the Network Service Access Point NSAP address, the E.164 address or any applicable globally unique address format could also be used in alternative embodiments of the invention.

It is possible to use human forms of addressing such as those based on the geographic and/or physical location of the switching apparatus interface, as is well known to those skilled in the art of implementing network operations.

Signalling

The signalling sent by the control plane 12 to the data plane 14 conforms to one of the current standard signalling protocols according to one embodiment of the invention. For example, protocols such as the private network node interface (PNNI) as defined by the ATM forum, a Resource ReSerVation Protocol (RSVP) or other protocol providing a signalling mechanism for applications to request and receive preferential service through the network, for example, (RSVP-TE), the Generalised Multi-Protocol Label Switching (GMPLS) protocol such as is defined by RFC 3473, the Multi-Protocol Label Switching (MPLS) protocol as defined by RFC 3209, constraint-based routing label distribution protocol (CR-LDP) such as is defined in ITU-T G.7713.3, or an ITU-Q-series SS7 protocol or any protocol having the necessary functionality could be used with simple extensions that allow parameters specific to Ethernet transport.

In other embodiments of the invention, another type of control plane architecture is implemented which provide similar functionality to that of G.8080 (either fully or as a subset or specialised variants). For example, the GMPLS protocol as defined standard recommendation RFC 3945 by the Internet Engineering Task Force (IETF) can be used in overlay mode. In yet another embodiment of the invention, network management protocols are used to provide routing information for the control plane and backwards defined indications for OAM between the control plane 12 and the Ethernet switching apparatus 20. In this embodiment, signalling messages are sent in a separate network to the Ethernet communications network 16. For example, in embodiments where the control plane components 36 are separate from the Ethernet switching apparatus 20, a separate management data communications network may be used to provide signalling.

Alternatively, the control plane signalling may be provided with the Ethernet traffic in the sense of sharing the same physical link but provided in an out-of-band network. The objective of an out-of-band (OOB) network is to effectively provide a secure network for control information such that the control information is isolated logically from the path of the traffic to which the control information relates. Thus the control information for switching the local area network traffic over the core Ethernet network is carried using an OOB network (i.e., a logically different network) over the core network such that only a carrier (i.e., a network operator for the core network) is able to access the control plane and, if required, interrupt the operation of the control plane. The local area network client (i.e., the customer network) has no control over the control plane. In this embodiment, it is possible to associate the signalling information with a VLAN, so within the VLAN a signalling channel is associated with all Ethernet switching apparatus. This can also be used (or another VLAN for backward direction OAM traffic, particularly for unidirectional traffic).

Routing protocols are often associated with either or both the signalling protocol or the addressing scheme. There is no a priori need for a routing protocol with a connection-oriented service—static routing is possible. The routing may be based on step-by-step, domain hierarchical or source based schemes.

The routing information provided by the control plane may distributed using IP-based protocols such as the Open Shortest Path First Traffic Engineering (OSPF-TE) protocol, or in a manner consistent with the ASON architecture. In one embodiment of the invention, static routing information is provided. In alternative embodiments of the invention, however, dynamic routing is implemented using an appropriate dynamic routing protocol such as is known to those skilled in the art. In one embodiment of the invention a network administrator manually configures network routes.

If dynamic routing is employed, routing algorithms are used to automatically populate the routing tables in the control plane and the signalling protocol reads out the routing table entries and populates the forwarding table entries of the Ethernet switching apparatus. It is still possible for some paths to be explicitly configured via the control plane in a dynamic routing environment). Both static and dynamic routing can be implemented using either the distributed control plane (see FIG. 4) or the centralised control plane (see FIG. 11) embodiments of the invention.

In one embodiment of the invention, a network administrator (or operator) manually enters the connection-oriented routing information in the control plane which is exported by the signalling system via the command line interface to populate the data-forwarding table provided on the Ethernet switching apparatus. The information is mediated by an appropriate stub (not shown) which translates the information provided into the appropriate form to update the forwarding table entries of the Ethernet switching apparatus.

As an example, consider briefly now the embodiment of the invention shown in FIGS. 3 and 4. In this embodiment, routing information is provided by a control plane implemented as a plurality of processors, each control plane processor 34 providing input to a single Ethernet switching apparatus, which may be via a command line interface 32 (shown in FIG. 3). This information can be provided using either an appropriate switching apparatus control protocol or explicitly via the command line interface provided for each Ethernet switching apparatus 20 in the communications network 16.

In one embodiment of the invention, OAM can be combined with routing in order that the control plane can automatically discover the interconnectivity of the Ethernet switching apparatus and use this information to build and maintain the routing information within the control plane. These ‘hello’ messages, as called by those skilled in the art effectively bring together the OAM with routing in order that the control plane has the most up to date picture of the network.

End-to-End Control Plane Communications

FIG. 11 shows a control plane architecture which is arranged so that a centralised control plane functionality (schematically shown by CPP 38 and standby CPP 40 (which is redundant but provides resilience in case CPP 38 fails) provides an end-to-end control plane communications network. In this embodiment of the invention, each component 38, 40 of the control plane provides control plane functionality for more than one Ethernet switching apparatus 20.

FIG. 11 shows a control plane comprising a signal control plane processor 38 which is arranged to function as a call and connection controller for all of the Ethernet switching apparatus 20 of the data plane 14. In practice, the ratio of call and connection controllers 38 to Ethernet switching apparatus 20 can be selected to be any appropriate ratio (as is well known to those skilled in the art). Thus the CPP processor (M) to Ethernet switching apparatus (N) ratio is M:N where M<N varies according to how centralised or distributed the control plane functionality is required to be.

The implementation of a centralised control plane to provide an end-to-end communications network in this embodiment functions in a manner equivalent to the embodiments of the invention shown in FIGS. 3 and 4, apart from the functionality of the control plane processors being now centralised to a greater or lesser extent.

Features described herein above with reference to the distributed control plane embodiments are also deemed to be disclosed in the context of a more centralised control plane whose functionality is implemented by one or more control plane components, each of which is associated with more than one Ethernet switching apparatus of the data plane—in other words, the ratio of the control plane processing components to the Ethernet switching apparatus may vary, as might the level of redundancy built into the control plane. For example, in the embodiment of the invention shown in FIG. 11, only one control plane processor CPP 40 is arranged to provide a standby control plane service to increases the resilience of the control plane in case of a signalling failure occurring (for example, between any one of the Ethernet switching apparatus 20 and the central control plane processor 38 shown in FIG. 11), but in alternative embodiments more than one standby control plane processor 40 may be provided in the control plane.

Describing FIG. 11 now in more detail, in the core Ethernet network 16′, centralised CPP 38 functions as an adjunct processor for every one of the Ethernet switching apparatus 20 A,B,C,D,E, and F shown in the data plane network 14. A single stand-by CPP 40 is also provided for all of the switching apparatus 20 in the data plane communications network 14.

In the embodiment shown in FIG. 11, CCP 38 determines the route of each connection request and sends appropriate signalling messages to populate the data forwarding table entries of each of the Ethernet switching apparatus 20 (for example, using a CLI). CPP 38 contains an appropriate network model, e.g. a database of the network resources such as switching apparatus, links, topology and connections, which CPP 38 uses to activate service requests.

The control plane may be implemented using CPPs having any appropriate relationship such as a global hierarchy or a plurality of local hierarchies, interconnected at specific levels so as to form clusters of control plane processors. FIG. 12 shows an embodiment of the invention in which CPPs “0”, “A”, “B”, and “C” are arranged to interact hierarchically with CPP “0” providing a peer-control over each of the localised CPPs “A, B, C” domain of responsibility. Any suitable communications network can be used by the CPPs forming the control plane to convey appropriate control messages to each Ethernet switching apparatus in the network of Ethernet switching apparatus to populate their data forwarding tables appropriately, although at some point the routing control information (which is retained in the control plane) is converted into a suitable form for populating the data forwarding table entries of the Ethernet switching apparatus.

As has been discussed above in the context of the distributed control plane embodiments, any suitable protocol capable of conveying the control information to the Ethernet switching apparatus may be used, for example, a management or control plane protocol networks could be used. The control plane protocol can be proprietary, based on management protocols or alternatively be based on standard control protocols such as GMPLS, ASON-RSUP-TE, CR-LDP, PNNI, SS7, etc, etc as described herein above, providing these are adapted as would be apparent to anyone skilled in the art for the Ethernet specific parameters required by the invention.

Those skilled in the art will be aware that if the a change is made to the command line interface (CLI) of an Ethernet switching apparatus, the switching apparatus software stubs between the control plane and the CLI will need to be updated. This requires the software to be updated and a separate communications network is required for the control plane to talk to the switching apparatus.

In one embodiment of the invention, to cope with the CLI changes and provide an appropriate communications network for the control plane 12 to talk to the Ethernet switching apparatus 20, the CLI 32 is replaced with a standards based interface to the control plane 12 (for example, GSMP—the general switching apparatus management protocol can be used).

GSMP provides a master-slave protocol in which the switching apparatus 20 functions as a slave to a master comprising any appropriate platform, for example, a computer such as a personal computer. GSMP permits the master to set-up and teardown Ethernet connections across the switching apparatus 20, to perform management talks, request information or allow the switching apparatus to inform the master of any problems. In one embodiment of the invention, the master is arranged to control both the control plane 12 itself and how the GSMP operates to allows both connection management and adjacency. Regardless of whether CLI or GSMP (or their functional equivalent) is used, in one embodiment of the invention, some or all of the control plane traffic follows transport traffic commonly on the same infrastructure.

In some embodiments of the invention are shown in which a VLAN for the control plane is created between the switching apparatus 20. The control plane VLAN, is logically isolated from transport traffic and carries control plane traffic between the Ethernet switching apparatus 20. Each CPP 36 in a distributed control plane network 16 is able to talk to the other CPPs 36 in the network by using Ethernet as the communications network for the control plane signalling information. This information is passed to the relevant VLAN by an appropriately configured port of the relevant Ethernet switching apparatus 20.

In FIG. 13, three Ethernet switching apparatus A, B, and C are shown, each having an associated CPP. FIG. 13 shows how in one embodiment of the invention, each CPP is connected to the Ethernet switching apparatus via an appropriate command line interface (CLI) (shown by “x” in FIG. 13). In this example, there is no change to the Ethernet switching apparatus. Also shown in FIG. 13 is another interface “y”, which comprises a GSMP interface in one embodiment of the invention (in alternative embodiments a similar protocol could be used for remotely controlling the switching apparatus).

However, if a switching apparatus management protocol interface is used to remotely control the switching apparatus, then the switching apparatus software will need to be modified in order to communicate with the CPP, for example, a stub or other mediator may be required.

FIG. 14 shows an alternative embodiment of the invention, in which the CPPs are connected in a different topology. In this embodiment, it is possible for different CPPs to communicate using different communication networks. In this case, the VLAN(s) used to convey the control messages between the CPPs and the Ethernet switching apparatus are set up by the network operator so that it is possible to distinguish each of the control VLANs. Some embodiments of the invention have different control plane functions implemented in different VLANS for example. In this manner it is possible to provide logically out-of-band Ethernet control. Those skilled in the art will also appreciate that a VLAN can also be used for other purposes, e.g., to convey operations and maintenance (OAM) packets. FIG. 14 shows the case where the CPP and Ethernet switching apparatus have a common topology, in which case the control plane functionality can be integrated into each Ethernet switching apparatus.

Dual-Mode Ethernet Switching Apparatus

In another embodiment of the invention, a hybrid Ethernet switching apparatus is arranged to provide both a connectionless service and a connection-oriented service. The hybrid Ethernet switching apparatus provides some connectionless functionality and connection-oriented functionality is provided by the control plane 12 providing routing information which populates the data forwarding table only for the ports on the hybrid Ethernet switching apparatus which are to provide a connection-oriented service. In this embodiment, the data forwarding/filtering plane will retain its connectionless functionality for the ports designated as providing a connectionless service.

The data forwarding tables entries are updated with information derived from the control plane only for the ports associated with a connection-oriented service and the remaining ports continue to provide a connectionless Ethernet service. An appropriate spanning tree algorithm ensures no redundant paths exist by removing redundant paths in the routing table entries associated with the ports of each Ethernet switching apparatus arranged to provide a connectionless Ethernet service.

Whilst it is possible to implement a hybrid switching apparatus offering both connection-less and connection-oriented Ethernet, use of the spanning tree protocol is susceptible to inadvertent mis-operation or deliberate attack. This means that use of a STP represents an operational point of vulnerability in a communications network. By encapsulating the customer's spanning tree functionality using MAC in MAC, and removing all STP functionality from the Ethernet core network, the vulnerability of the core network to STP mis-operation or attack is significantly reduced. The use of MAC-in-MAC over the core Ethernet network does not prevent a local area network from implementing an STP within that domain. Thus embodiments of the invention which use encapsulation over the core network increase the security of traffic in that domain.

Reconfiguration of Layer 3 Switching Apparatus

Referring now to FIGS. 15 to 21 of the accompanying drawings, the switching apparatus of the invention comprises switching apparatus originally intended to be capable of supporting connectionless Open Systems Interconnection (OSI) Layer 3 routing.

Open Systems Interconnection (OSI) Layer 3 (also known as the Network Layer), is the first layer that handles end-to-end traffic and has addressing with end-to-end significance. Examples of layer-3 protocols include the Internet Protocol (IP), and Internet Packet Exchange (IPX). In general, however, layer 3 describes the addressing, routing, and filtering functions required to ensure connectivity between end systems (computers), as well as defining the format of the packets that make use of the frames provided by layer 2. The term “IP” is used herein to refer to both IP version 4 and IP version 6. In the following examples, therefore the switching apparatus according to the invention includes IP routers arranged originally to support connectionless routing of Internet Protocol version 4 or version 6 traffic. The invention enables such routers to be able to provide a connection-oriented service instead of, or in addition to, a connectionless service and the connection-oriented service is able in some embodiments to provide multi-path routing.

In general, therefore, the term switching apparatus is defined to comprise all routing apparatus capable of functioning as forwarding apparatus and capable of resolving OSI-layer 3 (network layer) addresses, for example, an IP Router capable of resolving OSI-layer 3 (network layer) IP addresses. All terms used herein retain the definitions given in the International Telecommunication Union (ITU)'s ITU-T Recommendation G.805 “Generic functional architecture of transport networks”, the contents of which are incorporated herein by reference, unless explicitly indicated as having a different meaning which is inconsistent with the meaning given in G.805.

Internet Protocol Switching Apparatus

One embodiment of the invention delivers a connection-oriented packet switched service which uses a standard IP router as its nodal hardware. All signalling and OAM needed for connection-oriented packet switching is implemented on a separate processing platform (e.g., a UNIX server platform). Ideally, the IP router itself is unmodified, and as such will be available “off-the-shelf” from any standard supplier.

The service type provided by the invention is connection-oriented packet switched (CO-PS) in the sense that it provides a transparent transport across the core IP network, and is capable of providing a point-to-point or point-to-multipoint service. This does not preclude the use of multipoint-to-point and multipoint-to-multipoint constraints as part of the delivery of an end-to-end transparent service. As such a point-to-point service may be instantiated as either a point-to-point or point-to-multipoint unidirectional service or a bi-directional service. In order to be switchable in the IP router, the protocol data unit (PDU) must be consistent with the IP packet format, i.e., be a standard IP PDU.

FIG. 15 shows an layer-3 communications network 50 comprising a plurality of layer-3 switching apparatus 62 established to support connectionless modes of communication. In the communications network 50, network functionality is provided by a management plane 52, a control plane 54 and a data/forwarding plane 56 in an equivalent manner for OSI layer-3 traffic to that described hereinabove for OSI layer-2 type communications traffic.

The concepts associated with the control plane populating the routing tables of switching apparatus and associate VLAN and OAM considerations of the embodiments described herein above in the context of connectionless Ethernet communications equipment are adaptable to instead support the provision of a connection-oriented service using IP communications equipment (including IP communications equipment pre-established in the network for the purposes of providing a connectionless service).

In FIG. 15, the management plane 52 provides the appropriate interfaces to configure, control and manage an IP network 50. The control plane 54 provides the logical and physical interfaces to set up and control the activities of the IP data/forwarding plane 56 via the command line interface or by any other appropriate manner known to those skilled in the art, for example, as specified in one of the IETF standards, e.g. GMPLS.

The control plane 54 performs the call control and connection control functions, and uses signalling to set up and release connections and to restore connections in the event of failure. The data forwarding plane 56 provides the filtering and forwarding functionality used to transport network data traffic.

In FIG. 15, a communications network 50 comprises a first network 60a of local hosts, for example a customer LAN, which is capable of being connected to a second network 60d of local hosts, for example another customer LAN, via a plurality of interconnected IP routers 62. An exemplary number (for clarity, only four) of IP Routers 20 are shown in FIG. 15 (labelled A,B, C, and D).

In FIG. 15, local area network 60a provides a source 64 of traffic (for example IP traffic) which is transmitted via a suitable edge device 66 (for example, a router providing some multiplexing functionality) to Router A. Alternatively, edge device 66 may encapsulate a different protocol type of traffic into IP traffic suitable for routing over the core network via data plane 56.

Network 60d as shown in FIG. 2 functions as the IP traffic sink 68, and receives IP traffic from IP Router D via an appropriate device 70 (for example, a router providing a de-multiplexing function). Again, edge device 708 may de-encapsulate the traffic if required. Moreover, a local network may, however, in practice function as both a source and a sink of IP traffic, as is well known to those skilled in the art.

In order for IP routers 62 to function correctly as a connection-oriented IP router, the pre-configured routing protocols must be turned off or configured such that all forwarding table entries populated by the routing protocols are of lower priority to those for connection-oriented service. Instead, the forwarding table entries associated with all a connection-oriented service are populated using information provided by the control plane via a CLI or by any other way known to those skilled in the art. In order to provide an end to end connection, each router (or equivalently switching apparatus) A,B,C, D is populated with forwarding table entries appropriate to the end-to-end connection by the control plane. This is possible as the IP routing header information is the same in each IP router 62.

In FIG. 15, the IP data forwarding functionality for connection oriented traffic on each of the IP switching apparatus 62 provided in the data plane 56 is controlled from the control plane 54 using the command line interface 74a,b,c,d associated with each IP router 62.

In the embodiment of the invention shown in FIG. 15, routing information for the forwarding tables of IP switching apparatus A is generated in the management plane 52 and is communicated with the router 62 via control plane 54. As an example, routing information may be generated by a network manager 72 and signalled to the switching apparatus using an appropriate command line interface (CLI) 74a. Routing information is similarly provided via CLIs 74 b,c,d to populate the forwarding tables of each of the IP routers 62 B, C, and D. Other functionality may be implemented on the IP routers, for example, such as a packet sniffer 34 on IP switching apparatus D.

The end-to-end control plane communications network de-activates and configures the routing table functionalities of each IP router 20 in the network which is to offer a connection-oriented service (by either turning the functionalities off or by lowering their priority to an appropriate level (e.g. to ensure they are not in practice implemented). In the preferred embodiment of the invention, IP router 62 offers only a connection-oriented service and connectionless routing is fully turned off, but alternatively, a hybrid-switching apparatus may be provided (see later hereinbelow).

Once the routing protocols have been de-activated as described above, for example, by the control plane, the control plane creates and provides routing information necessary to populate the IP forwarding tables based on IP address and port and any other header field table entries. The IP router then uses this information to establish appropriate IP link connections (shown by the heavy black arrows in FIG. 15) between the IP routers 62a,b,c,d themselves. It is possible for the IP routers to support both unidirectional and/or bi-directional link connections (and thus provide a full duplex service, as is well known to those skilled in the art).

Each IP router 62 implements data forwarding based on the outermost IP header in each packet of IP traffic received by performing a looking up operation on the IP address in its forwarding table. As the forwarding table is now populated by information derived from the control plane of the switching apparatus, the data will be forwarded in such a way as to provide a connection-oriented service.

When the addressing scheme used for the connection oriented service is the same as that used by the IP network, then the control plane can use this address directly, using the control planes route tables in order to work out the outgoing port on each IP router. This is then configured in the IP router as a static entry in the forwarding table of the IP router as is understood by those skilled in the art. When the addressing scheme used for the connection-oriented service is different to that used by the IP network, then the control must first carry out a directory translation look up in order to find the correct IP address for the end point of the connection. The control plane can then use this IP address along with this route tables to make the static entries in the forwarding tables of the IP routers.

In the preferred embodiment of the invention where connection-oriented traffic is the only traffic supported by the IP router, then the static entries in the forwarding tables of the IP routers are the only entries which are valid for end user's traffic. This gives a high degree of security as the only end user traffic on the traffic is traffic that has been explicitly admitted to the network.

In an alternative embodiment of the invention where connection-oriented traffic is mixed with connectionless traffic on the same IP router. In this embodiment the connection-oriented traffic can be distinguished from the connectionless traffic by making the static entries in the forwarding table a higher priority than the entries for connectionless traffic. Further distinctions between the traffic can be made in order to support the quality of service properties of connection-oriented service, for example, by making the connection-oriented packets a higher priority in queue buffers. Beyond simple prioritisation, many of the techniques developed for IP traffic management and know to those skilled in the art are available to distinguish the connection oriented traffic from the connectionless traffic and to offer normal connection oriented QoS for the connection oriented traffic.

The switching apparatus control provided by the control plane 54 implements the control functions (or an appropriate subset) identified and described in the International Telecommunication Union ITU-T Recommendation G.8080, entitled Architecture of the automatically switched optical network (ASON), the contents of which are hereby incorporated by reference. Preferred embodiments of the invention implements a control plane in a manner consistent with G.8080 which allows for the concept of a connection and a call, separation of control and user plane, and the separation of call control and connection control. Alternatively, GMPLS, MPLS, or a legacy PSTN control plane, or a network management system could be used.

The control plane has visibility over the IP network, it is aware what resources are free. Once a path from A to D has been signalled, the control plane needs to know at D what resources are available to establish the connection, i.e., to determine what resources are free, e.g., if in IP version 6 a flow identifier is free, the control plane informs all switching apparatus via the CPPs to use the free flow identifier. When a request is received by a CPP, the CPP processes the request to determine how to talk to the CPP at the far end of the control plane (i.e., the CPP for the IP switching apparatus at which traffic leaves the IP core network), and all intermediate CPPs. The request may provide a specific route or identify end-points, and can ask the CPP to find a route.

Those skilled in the art will be aware that a request for connection may be received by a control plane processor via an IP router for which the CPP controls the data forwarding functionality, however, the IP router will function dumbly when forwarding the request for connection to the CPP (i.e., the CPP does not control how the IP router forwards received connection requests to the control plane).

Referring now briefly to FIG. 21, the control plane may comprise a plurality of interconnected adjunct control plane processors (CPP) 78 or be implemented in a centralised manner (in which case the mapping between control plane processors and switching apparatus may differ from 1:1 and where a plurality of control plane processors are provided, complex hierarchical control process relationships are possible). Similarly, redundancy can be provided by having one or more spare CPP whose resources are only utilised in the event another CPP fails. For simplicity, unless there is a need to distinguish between the differing components, features will be referred to as router 62, local area network 60, instead of router 62a,b,c,d etc and network 60a,b etc.

Each IP router 62 in communications network 50 is connected to two or more local networks 60 comprising interconnected local hosts (for example, a customer LAN), although only LANs 60a and 60b are shown in FIG. 15. The control plane 54 retains routing information, which is used to populate the data forwarding tables provided in the data forwarding plane with data forwarding information. The routing information is provided for each IP router 62 via its respective command line interface (CLI) 74 (shown as a bar on the dashed line connecting the control plane and the associated IP switching apparatus 62 in FIG. 15). Not shown in FIG. 15 is the configuration of the control plane, which can be either distributed or centralised depending on the ratio of control plane processors 78 with IP routers 62.

In a fully distributed control plane (such as is shown for example in FIGS. 20 and 21), each CPP 78 is arranged in one-to-one correspondence with the IP router 62 it controls. Information is exchanged between the CPPs 78 by means of an appropriate signalling network (see FIGS. 20, 21 for example). These adjunct processors 78 generate information which controls how the data forwarding table of the IP routers 62 are updated, and they also prevent rogue frames with IP addresses, or in the case of IP version 6 Flow Identifiers which are not recognised by the signalling information provided from passing through the switching apparatus via the ports offering the connection-oriented service.

Apart from now being capable of offering a connection-oriented service, the remaining functionality of the IP routers 62 is unchanged, as the change in switching apparatus behaviour necessary to provide the connection-oriented service is simply a result of changing the forwarding table entries to provide such a service.

Multi-paths for embodiments of the invention in which a connection-oriented IP transport mode is provided can be established in a manner analogous to that shown schematically in FIG. 4 for Ethernet. Thus in FIG. 15, two paths can be established between IP routers A and D, one via routers switching apparatus B and C, and the other just via IP router B (the path ABD is shown as a dashed arrow between B and D in FIG. 15).

Multiple connections can now be provided using the IP routers 62 offering a connection-oriented service. The traffic can be switched to a new path dynamically if its current path suffers an unacceptable level of degradation as the control plane can be used to dynamically reconfigure the traffic flow from A to D at any point along the path. This enables a high bandwidth source of IP traffic to maintain its quality of service to its sink even when other traffic is subsequently generated which impacts the original path (1 over the network.

Traffic can also be sent simultaneously along two or more paths simultaneously if the bandwidth is required, and providing appropriate sequencing etc operations can be performed at the destination IP router 62D. In one further embodiment of the invention, the data forwarding table entries of all IP routers 62 associated with both routes pre-populated, so that if the first fails, the only forwarding table the control plane needs to repopulate is the forwarding table of the source IP router 62A to effect the change over from the 1st route to the 2nd route.

In some embodiments, the control plane processors CPP 78 provide call connection control functionality in addition to providing routing information. For example, if the CPP 78a controlling IP router A receives a connection request it then determines an appropriate route for the traffic originating from the source LAN 60a to the sink LAN 60d. CPP 78a also ensures appropriate signalling is sent to the other Ethernet switching apparatus 62 on the route CPP 78a has determined (e.g., for the first path shown in FIG. 15, this will be IP routers A, B, C and D) so that their forwarding tables are appropriately updated. When flow labels are present, as is the case with IP version 6 in the IP packet headers, in one embodiment of the invention, the traffic flows are separated using flow labels. This enables appropriate traffic management to be implemented (for example, to enable network load balancing). The flow labels do not need to be swapped, and if they are not swapped they can be used as part of a global identifier if they are combined with an IP address. In this way a fully scalable solution for managing a scalable network can be provided by, for example, forwarding traffic based on a combination of destination address and flow label. If flow labels are swapped by the IP switching apparatus, a flow label will remain only of local significance.

An end-to-end connection between the source IP router A and the sink IP router D is thus provided by populating each of the forwarding table entries for each IP router 20 along a path (e.g. the first and/or second path) with appropriate forwarding table entries. Forwarding is implemented by the forwarding table matching the relevant header information of the IP to an out-going port of the IP router.

IPv4 Flow Control

In the earlier description using Ethernet switching apparatus, VLAN tags were used in an identical way to the way the IPv6 flow labels are used here in order to achieve multiple paths. There are also a number of ways of implementing this multi-path flow label in IPv4. One option would be to use a sub-network address as the destination address and addresses with the sub-network to identify each path. The control plane can then appropriately set the sub-network mask in the forwarding table of each IP router in order control the routing of each path. A second option would be to use IP source routing, either loose source routing or strict source routing. A third option would be to use an IP in UDP in IP mapping and use TCP/UDP port forwarding in the IP router to distinguish end path. Other options might use other of the optional fields in the IPv4 header.

FIGS. 16 and 17 show schematically the relevant standard versions of IP currently known to those skilled in the art, respectively FIG. 16 shows the IP version 4 format, FIG. 7 shows the IP version 6 basic header format. FIGS. 16 and 17 are included to be illustrative of these protocol headers which are well known to those skilled in the art and which will not be further described in more detail herein. Those skilled in the art will find it apparent that the term IP packet should not limited to the specific embodiments described herein but refers to any type of functionally equivalent packet format whose features are capable of implementing the invention.

The limitations imposed by the length of the IP address fields can be mitigated by stacking the address fields so as to encapsulate IP header information. This is shown schematically in FIG. 18. For more detail on encapsulations schemes for IP, the reader is referred to Request for Comments standards document RFC 1853 available from Internet Engineering Task Force (IETF), or the equivalent standards documentation available from the European Telecommunications Standards Institute (ETSI) or the International Telecommunications Union (ITU), which are known to those skilled in the art. A number of other encapsulation schemes exist (apart from IP-in-IP) which also allow one IP packet to be carried in another IP packet and are in use for a variety of applications (and more may be defined in the future). For example, encapsulations of IP-in-UDP-in-IP exist which can be used to support the multi-path feature described herein above. In this description, IP-in-IP includes any of these encapsulation as is appropriate, and not just the IP-in-IP encapsulation described in RFC1853.

In embodiments of the invention in which customer visible IP header information is encapsulated within IP header information provided by a carrier for example, and in which a hierarchical addressing scheme is implemented, the control plane is securely isolated from the customer. This outer header encapsulating the customers can be provided by the control plane operating its own addressing scheme by providing an outer header to the conventional header information at the source IP router 62a.

In this embodiment of the invention, the IP-in-IP encapsulation scheme is controlled by the control plane 12. The customer source and destination IP addresses are encapsulated within IP address fields at the network edge IP routers 62. When IP in IP encapsulation is implemented, the customer packet is encapsulated and does not interact with the control plane, instead the control plane acts on the encapsulating IP headers provided by the IP switching apparatus, enabling the customer IP addresses to remain effectively invisible over the IP core network.

In FIG. 19, an IP-in-IP service for the core IP network is shown, but the principles of wrapping a customer IP packet inside a carrier's IP packet can be applied for other technologies. As the customer's packet is untouched, transparency is provided. The carrier is then free to use their own addressing scheme (providing scaling, security, isolation and fault detection).

FIG. 19 shows how a provider (P) IP packet can include other fields which are completely independent of the customer header. In this manner, enhanced security can be provided as within the network core the IP addresses used are those provided by the carrier whose IP addressing scheme is being used, with the customer IP addresses only being de-encapsulated at the network edge switching apparatus if required. The numbering scheme used in earlier drawings is retained for elements of FIG. 19 having the same or equivalent functionality.

In FIG. 19 the customer IP packet (indicated as the c-IP packet in the drawing) is shown preserved within the carrier IP packet as the traffic flows across the network. In one embodiment, only the edge IP routers 62 understand the customer address space. This is not necessary however, if a point-to-point service is provided. The core IP routers 62 need only understand the provider address space.

The IP network provided by the invention uses the IP source address (SA) and destination address (DA) to provide an end-user connection-oriented packet-switched (CO-PS) service (using the outer IP header). This enables a service provider/network operator to offer a “leased line” type of service where the customer IP packet is transported transparently (see, for example, FIG. 19 of the accompanying drawings). The inner IP header is processed using conventional IP routers and IP routing protocols and operates as conventional connectionless IP. In one embodiment of the invention, the service provider/network operator is able to add another server layer to implement proprietary services such as traffic engineering etc.

In another embodiment of the invention the inner and outer headers may be different versions of IP.

The inner and outer headers are logically separate and many embodiments of the invention are possible. Earlier, the embodiment where the outer header is Ethernet (MAC) has been described and in this case, there are many further constituent embodiments each with different inner headers. Examples include IPv4 in MAC, IPv6 in MAC, IPX in MAC, and MAC in MAC. In the embodiment described here the outer header is IP (for example IPv4 or IPv6) and there are also many constituent embodiments. Similarly, examples include IPv4 in IP, IPv6 in IP, IPX in IP, and MAC in IP.

Those skilled in the art will be aware that G.8080 describes an architecture for the control plane of a connection-oriented network, and it is by implementing the connection-oriented functionality of the G.8080 control plane that a connection-oriented service can be provided in the connectionless IP network environment. The G.8080 connection-oriented control plane is used to control the connectionless IP technology and in doing so converts the behaviour of the IP routers.

In one embodiment of the invention, an appropriate interface is provided conforming to G.8080 to separate the call/connection control plane processors (CPP) 36 and the IP routers 62, for example, each IP router 62 may be controlled via its existing proprietary command line interface (CLI) 32 (see FIG. 20). Not shown in this drawings is the stub or mediator that this embodiment requires which translates commands across the CLI (i.e., which handles changes to the command line interface or the control plane and translates between the “language” used on either side of the interface). The G.8080 architecture also allows for the control plane to be integrated into the switching apparatus platform. Whilst this may require modifications to the switching apparatus platform to add control plane functionality there is no need to change the hardware providing the data forwarding functionality. In another embodiment of the invention, a standardised interface between the switching apparatus and the control plane such as the Generalised Switching apparatus Management Protocol (GSMP) is used to implement the control plane functionality. For example, GMPLS and network management protocols or similar control or management plane protocols can be used to implement the necessary functionality, for example, the eXtensible Mark-up Language (XML) or International Telecommunication Union (ITU) Telecommunications (ITU-T) Recommendation M.3100.

Connection orientation means that “addressing and labelling” can be decoupled from each other, with the signalling system used to associate them. The invention treats the IP address as a “Label” which is only visible in the control plane. In principle, any addressing scheme could be used as addressing is only visible to the adjunct processor of the IP switching apparatus, i.e., only visible in the control plane. However, in order to give compatibility with connectionless networks, Internet Protocol version 4 (IPv4) addressing could be used or alternatively, Internet Protocol version 6(IPv6). Given the widespread use of private addressing, a globally unique address has been implicitly created in one of two forms. The first form is the implicit global address VPNid/IPv4 address used in Internet protocol (IP) virtual private networks (VPNs). The second form of a globally unique address is a Network Address Transport (NAT) address. This globally unique address is implicitly formed as the concatenation of the gateway's public IPv4 address followed by the private IPv4 address. Alternatives such as the Network Service Access Point NSAP address, the E.164 address or any applicable globally unique address format could also be used in alternative embodiments of the invention.

It is possible to use human forms of addressing such as those based on the geographic and/or physical location of the switching apparatus interface, as is well known to those skilled in the art of implementing network operations.

The signalling sent by the control plane 54 to the data plane 56 conforms to one of the current standard signalling protocols according to one embodiment of the invention as described in more detail hereinabove in the context of Ethernet traffic but here having the necessary functionality to have simple extensions that allow parameters specific to IP transport.

The routing functionality may be implemented in a manner similar to that described in the context of embodiments directed towards Ethernet switching apparatus.

A particular embodiment of dynamic routing can use the routing protocols within the router. In this embodiment, the router can run its normal routing protocols to calculate a route table, however forwarding of end user traffic is not based directly on this route table as it would be in normal connectionless routing. Instead, the control plane uses this routing table on the router as its routing table in order to calculate the forwarding entries in the forwarding table. In this embodiment, the router is configured so that the normal copying of the route table into the forwarding table is disabled, except for the addresses of the routers themselves as they are required for the successful operation of the routing protocol. The way in which the router disables this copying may vary depending of the exact implementation and CLI capability of the router. One particular technique that could be employed to assist this would be allocate the routers IP addresses from a different IP address space from the IP addresses of the end points of the connection oriented service. If supported by the IP router, a filter could to then be set up to allow connectionless forwarding of only the IP address of the routers themselves. Such an embodiment automatically implements auto-discovery and link and node failure detection.

Thus, in the embodiment of the invention shown in FIG. 15, routing information is provided by a control plane implemented as a plurality of processors, each control plane processor 78 providing input to a single IP router 62, which may be via a command line 74. This information can be provided using either an appropriate router or switching apparatus control protocol or explicitly via the command line interface provided for each IP router 62 in the communications network.

If the control plane architecture is arranged so that a distributed control plane functionality provides an end-to-end control plane communications network, each component of the control plane provides control plane functionality for more than one switching apparatus, and in this manner the control plane for IP routers 62 can be implemented in a manner equivalent to those described herein above for Ethernet switching apparatus for IP switching apparatus. As has been discussed above in the context of other embodiments, any suitable protocol capable of conveying the control information to the IP router may be used, for example, a management or control plane protocol networks could be used. The control plane protocol can be proprietary, based on management protocols or alternatively be based on standard control protocols such as GMPLS, ASON- RSVP-TE, CR-LDP, PNNI, SS7, etc, etc as described herein above, providing these are adapted as would be apparent to anyone skilled in the art for the IP specific parameters required by the invention.

Those skilled in the art will be aware that if the a change is made to the command line interface (CLI) of an IP switching apparatus, the switching apparatus software stubs between the control plane and the CLI will need to be updated. This requires the software to be updated and a separate communications network is required for the control plane to talk to the switching apparatus.

In FIG. 20, three IP routers 62 A, B, and C are shown, each having an associated CPP 78. Each CPP 78 is connected to the IP router 62 via an appropriate interface, either by command line interface (CLI) denoted by x and/or by interface y, which comprises a GSMP interface. Alternatively, any other known protocol capable of remotely controlling the IP routers 62 from the control plane could be used. However, if a switching apparatus management protocol interface is used to remotely control the switching apparatus, then the switching apparatus software will need to be modified in order to communicate with the CPP, for example, a stub or other mediator may be required.

FIG. 21 shows an alternative embodiment of the invention, in which the CPPs 78 are connected in a different topology which enables different CPPs 78 to communicate using a different communication networks. For example, CPPs 78 could use the flow identifier in Ipv6 packets to identify virtual private networks which can be used to convey the control messages between the CPPs 78 and the IP routers 62. The virtual private networks are set up by the network operator so that it is possible to distinguish each of the control VPNs. In this way it is possible to have different control plane functions implemented in different VPNs for example. In this manner it is possible to provide logically out-of-band control for a connection-oriented IP transport mode. Moreover, as those skilled in the art will appreciate, a VPN can also be used for other purposes, e.g., to convey operations and maintenance (OAM) packets.

Dual Mode/Hybrid Ip Switching Apparatus

In another embodiment of the invention, an IP router is arranged to provide both a connectionless service and a connection-oriented service. The IP router provides some connectionless functionality directly. In this embodiment, the data forwarding plane will retain its connectionless functionality the connectionless service. The data forwarding tables entries are updated with information derived from the control plane only for the connection oriented service.

Those skilled in the art will find apparent numerous equivalents and modifications to the features described hereinabove in the detailed description of the embodiments of the invention. The scope of the invention should therefore be interpreted by the accompanying claims, rather than the specific embodiments described hereinabove.

Unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

The previous description clearly indicates that the encapsulated IP traffic can be forwarded using all of the existing tools, techniques and protocols available to conventional IP networks, whilst the encapsulating IP traffic can use its own control plane and address space. However, the encapsulating traffic and some or all of its control traffic need not be forwarded in the same manner.

For control plane solutions that transport their traffic in conjunction with user traffic (i.e. it uses the same links as the traffic between routers) one could simply manually pre-provision connections dedicated to control and management traffic (in the layer providing the encapsulation) so that control traffic can be sent around the network. This is a prerequisite in order to create connections for user traffic. However, other schemes can be envisaged. Just as different forwarding behaviours can be applied to encapsulated and encapsulating IP traffic in the sense that it is being applied in different layers (IP on IP can be considered as full client/server encapsulation in the sense of ITU Recommendation G.809 where the encapsulated traffic is associated with the client layer and the encapsulating traffic is associated with the server layer) it can also be applied horizontally. Rather than pre-provision connections for management and control traffic the control traffic can sent in a connectionless manner whilst user traffic is sent along connections (in the encapsulating layer).

As such the layer that is providing the encapsulation can be divided such that control traffic is forwarded according to conventional IP forwarding techniques whilst connection-like traffic is forwarded using the new control plane. The advantage of partitioning the forwarding behaviour is that control plane traffic can use all of the tools and protocols available in conventional IP networks. As such protocols such as Internet Control Message Protocol (ICMP) and its attributes (such as traceroute and Ping) can be deployed for control plane traffic and the control plane can also utilise IP routing protocols for populating routing tables to assist with forwarding control traffic. Routing protocols for control traffic can be used to populate routing tables for control plane traffic only, by simply filtering out IP addresses that are not associated with control traffic.

It should also be observed that tools such as ICMP can also be used within the connections. In this case they are limited to the context of the connection, however conventional IP diagnostic tools and techniques can now be run “in connection” to provide OAM facilities for monitoring the connection. Furthermore these tools can be used in unidirectional connections. Here the return path need not follow the connection and return messages can be sent in the control plane. Alternatively for two unidirectional connections that are associated to form a bidirectional connection the return path can follow the connection in the other direction.

If the control traffic between control processors is run on a separate network from that of the user traffic (i.e. separate and distinct links), the forwarding of control plane traffic is in any case completely separate from that of the user traffic. The addressing space of this traffic is also separate and indeed need not even be of the same type (i.e. IPv4 in one space IPv6, in the other).

The above embodiments of the invention clearly indicate that it is possible to provide a connection-oriented service using switching apparatus originally designed for connectionless transport modes. Any layer-two communications equipment originally designed to support OSI layer-2 or layer-3 connectionless transport modes which relies on routing tables which are capable of being populated remotely from the control plane can now be used to provide a connection-oriented service. The original connectionless addressing schemes can be retained but one or more fields containing address information in each frame header will be used by the control plane to update the routing tables through an appropriate interface to the switching apparatus. By encapsulating address information at switching apparatus at the edge of the core (e.g. carrier) network, customer address information can be encapsulated within carrier provided address information and thus transported more securely across the network.

FIGS. 22A and 22B show how an IP router's forwarding table 80 can be populated by the control plane 54. In IP a forwarding table is commonly referred to as a routing table and contains a prioritised list of routes (effective an aggregation of addresses) associated with a particular outgoing port of the IP router. According to the invention, the control plane 54 populates the IP forwarding table 80 with routes prioritised in such a way as to ensure that the default router will be connectionless, if a default route is provided. The forwarding engine of the IP router simply looks at the route entries in the forwarding table 80 shown In FIG. 22A, as selects a route associated with a particular outgoing port of the router for a received IP packet. In the example shown in FIG. 22A, route 82a is the highest priority route, whereas route 82b has a lower priority. The route 84 is the default route, which in this embodiment of the invention is connectionless.

To implement multi-path routing in the embodiment shown in FIG. 22A, it is possible to assign a subnet of the IP address space to the destination address, and then each individual addresses in the IP subnet's address space can be used to distinguish being different paths. In this way, multiple paths can be set up in a connection-oriented manner for traffic conforming to the standard IP protocols. For example, in the IP addressing scheme which is well known to those skilled in the art, the Class C subnet can be used as the destination address, and up to 256 paths can be designated using individual Class-C addresses.

FIG. 22B shows an alternative embodiment of a forwarding/routing table for an IP router according to the invention, in which control plane 54 populates the forwarding table with route information comprising a standard IP route series of address and masked address space in the manner shown in FIG. 22A, and in addition provides the TCP/UDP port identifier to enable multiple paths to be set up between a source and a particular IP destination address

The above embodiments all demonstrate that the invention provides a means to enable an OSI layer-2 or 3 switching apparatus arranged to support connectionless traffic modes to support connection-oriented traffic modes as the default transmission mode, with connection-less traffic modes being either dropped or permissible only if identified as such by some means, e.g., using a particular VLAN-tag or default routing table entry.

Thus this invention allows the reuse of existing connectionless equipment for connection oriented service, including all the multi path features and path restoration features normally associated with connection oriented service, without any change to the existing equipment or to any of the standards associated with the equipment. In order to implement the multi path features and path restoration, a multi path identifier is needed which cannot be arrived at by either a simple destination address or a source and destination address pair. A further field is needed for this, such as the VLAN id, IPv6 flow id, or a number of possibilities for IPv6 described hereinbelow, which is missing from prior art. The control of the connection oriented traffic is fully decoupled for any of the existing connectionless control protocols, for example Ethernet bridge learning and spanning tree protocol or IP routing protocols, thus giving the security normally associated with connection oriented service.

Thus, by disabling conventional control plane protocols, the invention makes it possible to reconfigure the hardware to operate in a connection oriented mode. Regardless of whether the form of connection-orientation is circuit switched (e.g. TDM, or wavelengths) or packet switched (e.g. ATM) there are a set of properties which many consider as defining connection-orientation. These include requesting and allocating resources prior to the transfer of information. In the data plane it is assumed that forwarding is based upon a connection identifier that has link local significance. Examples include the timeslot in TDM networks, wavelengths in optical networks, the VCI and VPI fields in ATM, the DLCI field in frame relay and the label in RSVP-TE based MPLS networks. This connection identifier is also known by those skilled in the art as a “label” and is associated with each traffic unit that is transported through the network. It is known in the art to forward traffic units using labels, for example, in connection-oriented packet-switched (CO-PS) networks label swapping can achieve scalability. The label may be explicit or implicit (such as a timeslot).

The IEEE is currently developing MAC-in-MAC encapsulation which enables: the address space of the provider to be decoupled from that of the customer, customer frames to be untagged or tagged, customers to use their own control protocols such as spanning tree protocol, and the use of hierarchy to provide security by encapsulating customer frames at the edge of the network. The use of hierarchy also allows for the separation of control in management, for example, so that management control in one layer of hierarchy is independent of the control implemented in other layers.

It is possible in some embodiments of the invention for the client layer to be connectionless and for forwarding and bridging functionality to be as defined by the IEEE in the client layer. This applies to both untagged and tagged frames. There is no need to resort to connection-oriented constructs to describe VLANs (as a VLAN is not a connection) and from the customer perspective the network at this layer looks like any other Ethernet network. However, in such embodiments, in the server layer the normal format of Ethernet frames is maintained but bridging functionality is switched off, e.g. MAC learning and Broadcast on Unknown. Spanning tree is also disabled. Thus the concept proposed herein can be applied to some or all of the VLAN range.

Whilst IEEE specifications allow for forwarding tables to be populated by means of configuration statically with a view to implementing connection-less routing, the invention utilises this mechanism to populate the forwarding tables to implement connection-oriented routing between a source and a sink of Ethernet or IP traffic. This allows connection oriented forwarding using existing hardware. If a Protocol Data Unit (e.g. a frame or packet) is presented that has no entry in a forwarding table, the PDU is simply dropped. In this way, traffic is not allowed into the network unless it is associated with a connection.

Referring now to FIG. 23 of the accompanying drawings, an embodiment of the invention is shown which implements multi-path routing between switching apparatus in the core network for traffic at OSI-level 2 (e.g. traffic having Ethernet address information). Equivalent embodiments may be provided for OSI-level 3 traffic, e.g., traffic having IP address information.

In FIG. 23, a first path is shown between switching apparatus A, B, C, and E, and a second path is shown between switching apparatus A, D, and E. In FIG. 23, an embodiment of the invention is shown in which customer traffic comprises Ethernet traffic. Customer Ethernet traffic frames are encapsulated using an appropriate encapsulation scheme into a Ethernet frames which carry provider address information between Ethernet switching apparatus 20 of the core network. Similar encapsulation schemes can be implemented for IP traffic.

Thus in the embodiment shown in FIG. 23, at node A, the management plane 10 (and/or control plane 12) has configured the outgoing ports to forward traffic which is associated with VLAN ID 100 along the first path, and traffic having VLAN ID 120 is forwarded along the second path. In FIG. 23, network elements A and E correspond to the network edge devices, for example 802.1 ah compliant devices, that offer customer facing ports where customer traffic is encapsulated onto configured Ethernet switched paths at A and extracted at E.

The first path has been computed in the provisioning and management plane for traffic assigned the VLAN-ID 120. Thus the forwarding tables configured in the intervening P switches to map VID=120/MAC=E to the appropriate egress ports of each device to define a contiguous path. For the second path, the same process resulted in a path configured in the switches using VID=100/MAC=E. A similar process is also used to configure symmetrical return paths from E to A.

In the example the paths deliberately merge/demerge at node D to illustrate that it is the combination of both VID and MAC that provide the forwarding entry. It is the concatenation of the two that determines the forwarding path. Collisions in either space such as VID 100 or 120 used in conjunction with another MAC address or as in the example above where paths 120/E and 100/E cross are still uniquely resolved to a single egress port.

The VLAN ID is now being used to identify one of a number of parallel paths to a destination address. The VLAN ID field is no longer globally significant when used in this way and each VLAN ID value can be reused for a different destination address. However, there is no impact on the forwarding at each switching apparatus.

According to the invention, any index header field identifier values or combination of values which can be incorporated by the control plane into the forwarding table can be used, although in the above example it is the combination of a MAC address and a VLAN ID on which forwarding has been based. This allows “merging” at the VLAN tag level whilst using the combination of fields to ensure global uniqueness. This provides attractive scaling behaviour, whilst avoiding the loss of source visibility that occurs in connection oriented technologies that only use a label when merging. It does not require the introduction of any new form of forwarding mechanism, in contrast to VLAN swapping.

By exploiting existing MAC address plus another header identifier such as the VLAN tag and utilising the same values for the MAC address and VLAN ID on each hop between switching apparatus across the network, the OAM for the connection across the communications network is considerably simplified. For example, self identification of forwarding errors such as mis-configuration is immediate. In particular, the additional header plus MAC Destination Address allows traffic engineering capabilities to be added to Ethernet. This represents a considerable benefit over existing Ethernet solutions. Connection orientation capabilities such as bandwidth management and connection admission control provide resource management.

In contrast to existing connection oriented technologies forwarding is done not by means of a single implicit or explicit label, but rather by a combination of both a destination address and a header identifier label which now acts as a route distinguisher, for example, higher priority traffic may be assigned a connection-oriented mode of transport, whereas traffic having a lower priority may continue to be routed across the network in a connection-less mode. Clearly whilst a label is sufficient for connection oriented forwarding, additional functionality can be obtained if an address is also used. For most connection oriented technologies this is not possible, but with Ethernet (or IP) this is possible as a result of the frame/packet format. The combination of an address and a label also means that swapping is not required. Thus forwarding alone does not determine connection oriented or connectionless behaviour and either form of behaviour can be obtained using the same frame format and the same hardware.

OSI layer 2 and 3 switching apparatus configured to implement connection-less routing on an ad-hoc basis and having means to interface with a control plane can be adapted according to the invention to implement connection-oriented routing providing the connection-less routing/address learning functionality is disabled on all or a subset of the ports of the switching apparatus on which the connection-oriented service is to be implemented. This allows connection-oriented routing to be implemented on all or just a range of ports (or VLAN-IDs or other field identifiers capable of being examined by the switching apparatus) where the control or management plane is used to directly populate the forwarding tables of the switching apparatus. The operation of the switching apparatus is in some embodiments selective under the control of the control plane, rather than being statically determined.

By providing a plurality of Ethernet switching apparatus whose forwarding tables have been directly populated in this way in a communications network, the switching apparatus effectively operated in the CO-PS mode for all traffic whose header field identifier values match the values the control plane has configured the switch to provide a connection-oriented service for. Whilst this may be done for some entries on the basis of VLAN-ID, other entries may comprise other header identifiers, e.g., Ethertype, or priority, or a combination thereof, in fact, any information which can be provided by the control plane and which can be formatted in an appropriate manner so that it can occupy the forwarding tables used by the switching apparatus, and which can be matched to information extracted by the switching apparatus from the traffic header fields. It is thus possible to configure the switching apparatus to have tables which have some entries in which an egress port is associated with a VLAN-ID and DA, and other entries in the same table associating an egress port with Ethertype and DA or with priority and DA etc. The diversity of the entries may result in a plurality of paths for the traffic (for example, if the egress port associated with a particular VLAN-ID and DA is congested, it is possible for the traffic to be routed along an alternative path based on the DA and the Ethertype or priority, if these are associated with a different egress port).

The control plane will configure the forwarding tables of all relevant switching apparatus to establish a connection across the communications network (i.e., each contiguous series of switching apparatus will effectively populate its forwarding tables such that each entry sets up either a uni-directional (or a bi-directional connection if mapped to the reverse direction as well. I.e., SA to DA is uni-directional but SA-DA and DA-SA entries provide a bi-directional connection). The identifier in a forwarding table may be part of a series or range of identifiers, e.g., a series or range of VLAN-IDs which are unique to specific MAC DAs. If so, they can identify the number of potential connection terminations at any given DA.

As the forwarding table normally responds to unknown addresses by flooding, this functionality must be disabled to ensure flooding is avoided, and the forwarding table directly populated with information from the management plane (or equivalently, the control plane). This applies in particular to any broadcast or multi-cast traffic which needs to be filtered (or dropped) prior to being relayed by the switching apparatus.

Explicit routing of connections across the network when combined with call admission control and queuing, e.g., 802.1Q based class-based queuing, enables per connection QoS. Moreover, some topology information which is obtainable from the network (e.g., using the ITU-802.1ab standard technology) is needed to provide a CO-PS service. It is also necessary to provide for signalling of the required connections, for example, connections can be signalled from the management plane using OAM traffic (e.g., using ITU-802.1ag).

The invention thus relates to using a control plane to configure the switching apparatus such that the decision over whether traffic received is to be routed in a connection-oriented or connection-less manner across a core network, independently of the mode of transport utilised in access networks. Equivalently, the management plane may be used to configure the control plane appropriately, and is capable of determining when a connection-oriented service is to be implemented. The local area network service provider or customer does not need to allocate specific header field range values (although they may do so) for the traffic to be routed in a connection-oriented manner across the core network.

Some embodiments of the invention enable a service provider to control the operation of the switching apparatus via the control plane to selectively provide a connection-oriented or connectionless service for traffic across the core network. In this way, for example, it is possible to selectively offer a connection-oriented mode of transport according to the time of day and traffic load on the core network (or the amount of traffic to a specific destination address), rather than on specific information in the header field of received packets/frames.

The mode of forwarding traffic is determined simply by whether the connectionless protocols (e.g., the spanning tree and address learning protocols or any protocols having equivalent functionality for non-Ethernet traffic) are operating on specific interfaces of the switching apparatus or whether they have been disabled/removed such that the control plane is able to providing equivalent routing information to establish a connection for certain received traffic across the core network.

This enables the switching apparatus to operate to forward traffic to the same destination address in a connection-less and/or connection-oriented manner, either at the same time (i.e., in a hybrid mode) or selectively different times as determined by the control plane. The traffic does not need to be assigned specific identifiers in its header fields at its source, as the mode of operation of switching apparatus is controlled only by whether a connection is established by the control plane or not. The control plane can configure the switching apparatus to discard all unknown traffic or the switching apparatus may transfer unknown traffic to a egress port on which a suitable address protocol has been retained, for example, by swapping the VLAN-ID of a received packet/frame to a VLAN-ID associated with an egress port for which the broadcast on unknown functionality has not been disabled/removed.

Where the spanning tree and address learning functionality is remotely configurable, the control plane can be used to remotely activate/deactivate this functionality. In this way, it is possible for the switching apparatus to dynamically modify its behaviour according to the information it receives from the control plane to provide end-to-end connection-oriented routing or connection-less for received traffic by activating or deactivating the functionality of one or more interfaces of the switching apparatus which enables each said one or more interfaces from operating in a connection-less manner.

Those skilled in the art will be aware that there are many aspects of conventional switching apparatus not described in detail hereinabove, such as for example, the data storage means of the switching apparatus which may, for example, be a database arranged to provide the address “look-up” functionality. It is assumed that such database means are associated with the switching apparatus and/or integrated with the switching apparatus such that the control plane is capable of providing appropriate information to populate the database (the control plane information is assumed to be appropriately formatted/configured/translated by an appropriate stub in any manner apparent to those skilled in the art into a form suitable for inclusion in the database). In this way, the database records which associate the outgoing interfaces (or egress ports) of the switching apparatus with information associated with one or more pre-determined header fields of the received traffic can be populated by the control plane. Conventionally, switching apparatus is provided with forwarding tables which contain at least the destination address associated with an egress port. For example, Ethernet switching apparatus usually contains forwarding information comprising the VLAN-ID and the Destination Address information and the associated egress port of the switching apparatus.

However, as the control plane is now populating the database, it is possible to replace or supplement the VLAN-ID information with information from another field of the header information, for example, the Ethertype or priority header fields, either completely or in part in the database. This is because whatever information is provided simply needs to be matched with appropriate header information in the database for a received packet to be associated with an egress port of the switching apparatus.

For example, if the control plane has populated that entry in the bridging table on the switching apparatus so that that egress port of the Ethernet switching apparatus has its MAC learning functionality disabled and the spanning tree protocol deactivated (and so no BPDUs are provided), then the packet proceeds on a connection-oriented basis. If however, the control plane has not selectively provided connection-oriented information for that egress port, then the spanning tree protocol etc will remain functional for that port, and the packet proceeds on a connection-less manner.

In some embodiments where the control plane is used to remotely activate and/or deactivate the spanning tree protocol, it is possible for the same egress ports of switching apparatus in the communications network to dynamically change their function in either a connection-less or connection-oriented manner. In this way, a communications network can comprise a plurality of access networks (e.g. local area networks) which support connection-less communications protocols and a core network whose functionality can be either connection-less or connection-oriented according to the requirements of the service provider(s) controlling the switching apparatus in the core network. For example, traffic from one source may be routed by the service provider to a destination address in a connection-less mode and traffic from the same source but sent at a different time may be sent in a connection-oriented mode. As another example, traffic from the one source may be sent in a connection-less manner to a destination address but traffic sent at the same time from another source to the same destination address may be sent in a connection-oriented manner. There is no need to set aside a range of header field values or configure the traffic headers with pre-determined header information to received a connection-oriented service, instead, the decision to route traffic in a connection-oriented manner is determined by control plane according to criteria such as one or more conditions determined in the core network.

Thus in some embodiments it is possible for traffic to change its mode of transport dynamically from switching apparatus to another switching apparatus prior to reaching its destination address. As an example, from switch A to switch C in FIG. 23, it is possible for traffic of a certain type to be routed in a connection-less manner, but from switch C to switch E in a connection-oriented manner. At the same time, traffic of a different type might be routed in a connection-oriented manner from switch A to C and in a connection-less manner from switch C to switch E. However, in the best mode of invention, the mode of transport is determined in an end-to-end manner by the control plane directly populating the data forwarding tables of the switching apparatus via which the connection has been established with appropriate routing information.

In order for a service provider to implement an end-to-end connection-oriented service for connection-less protocol traffic, the control plane configures the core network switching apparatus to establish an appropriate connection between the source edge node and the destination edge node. This is achieved by associating certain header information fields with predetermined egress ports of the switching apparatus such that received traffic containing the same information in its header fields is routed in a connection-oriented manner. Thus on the basis of one or a combination of header fields, for example, one or more destination address fields and/or one or more source address fields and/or one or more source route address fields and/or one or more Ethertype field and/or one or more priority fields and/or one or more type of service fields and/or one or more flow identifier fields and/or one or more fields capable of identifying a virtual private network and/or one or more protocol fields and/or one or more TCP/UDP destination port identifier fields and/or one or more TCP/UDP source port identifier fields, it is possible to determine if the received traffic should be forwarded in a connectionless or connection-oriented mode, and if the later, along one or more paths to the destination address.

Thus, for example, by configuring the control plane, a core network service provider can selectively provide a connection-oriented service for certain traffic or not, according to a number of potential criteria and can arrange for the control plane to configure the switching apparatus of the core network accordingly. This means that access service providers can simply request connection-oriented service for certain traffic without the need to ensure specific predetermined identifiers are included in the header information to ensure a connection-oriented service is received. This enables connection-oriented service to be implemented by the control in virtually a hitless manner between a source and a destination address. As an example, if network congestion for connection-less traffic exceeds certain levels, it can be advantageous for connectionless traffic to change to a connection-oriented mode of transport in a relatively hitless manner, e.g. by dynamically reconfiguring the switching apparatus such that it routes received traffic in a connection-oriented mode.

The description of preferred embodiments is not intended to limit the scope of the claims appended hereto. Modifications to the above features of the invention and features having equivalent effect to the features apparent to those of ordinary skill in the art are implicitly included in the description. The scope of the invention should therefore be interpreted by the accompanying claims, rather than the specific embodiments described hereinabove. Features described in the context of one embodiment which are readily incorporated into other embodiments or for which it is apparent to one of ordinary skill in the art are functionally equivalent or capable of replacing features in other embodiments are implicitly intended to be incorporated into the description of the other embodiments.

Although the main embodiments of the invention have discussed providing connectionless protocols such as Ethernet and IP, those skilled in the art will appreciate that the invention is not limited to either of these two transport protocols or versions of these protocols, but instead is that set out by the accompanying claims. Those skilled in the art will appreciate that there are many possible modifications and variations to the features of the embodiments of the invention described herein and that the features described in the context of one embodiment which may be suitably adapted can be incorporated into other embodiments. Unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

The text of the abstract is hereby incorporated into the description:

A communications scheme for configuring a network comprising a plurality of connected switching apparatus, each switching apparatus having functionality for implementing connectionless forwarding of received communications traffic to selectively provide a connection-oriented service for said received communications traffic, the scheme comprising: determining in a control plane index header field values to identify connectionless traffic received at switching apparatus for which a connection is to be established between a source node and a destination node; providing each switching apparatus necessary to implement the connection with information from the control plane, the information enabling the data forwarding tables of the switching to be populated with said index header field values in association with egress ports of the switching apparatus; and disabling all other functionality on said switching apparatus capable of populating the data forwarding tables with index information associated with said egress ports of the switching apparatus necessary to establish said connection.

1-111. (canceled)

112. A switching apparatus in a communications network, the switching apparatus comprising:
a plurality of ingress ports arranged to receive traffic in the form of protocol data units which conform to a connection-less communications protocol;
a plurality of egress ports for forwarding received traffic on;
interface means arranged to receive information from a control plane processor; and
data storage means, whereby information provided by the control plane is stored and arranged to associate an egress port of the switching apparatus with an index field,
wherein the information received by the switching apparatus from the control plane enables the switching apparatus to operate to provide a connection-oriented mode of transport for the received traffic to establish a connection between a source node and an end node in said communications network via a plurality of other switching apparatus configured by the control plane, wherein said switching apparatus has no other functionality capable of controlling the data forwarding function for the interfaces of said switching apparatus configured by said control plane to provide a connection-oriented mode of transport for said received traffic, wherein the mode of transport for received traffic between said source and said destination is determinable by the control plane for the plurality of switching apparatus in the communications network.

113. A switching apparatus as claimed in claim 112, wherein the mode of transport is determined by the control plane populating the data storage means with a plurality of index field identifiers, at least one index field identifier comprising a destination address of the connection to be established for said received traffic.

114. A switching apparatus as claimed in claim 112, wherein the mode of transport is determined by the control plane populating the data storage means with a plurality of different index field identifiers, at least one index field identifier comprising a destination address of the connection to be established for said received traffic.

115. A switching apparatus as claimed in claim 113, wherein the plurality of index field identifiers are arranged in a hierarchical order, and index field identifiers at different levels of the hierarchy are associated with different egress ports of the switch arrangement.

116. A switching apparatus as claimed in claim 112, wherein the information received from the control plane processor further controls the data filtering function the switching apparatus performs on received traffic, and wherein said switching apparatus has no other functionality capable of controlling the data filtering function for the interfaces of said switching apparatus for which the control plane has provided information to control the data filtering function.

117. A switching apparatus as claimed in claim 112, wherein the forwarding and/or filtering functions performed by the switching apparatus are controlled by the control plane populating the forwarding tables used by the switching apparatus to cause said received traffic to follow one or more predetermined paths through said communications network.

118. A switching apparatus as claimed in claim 112, wherein the forwarding and/or filtering functions performed by the switching apparatus are controlled by the control plane populating the forwarding tables used by the switching apparatus to cause said received traffic to follow one or more predetermined paths through said communications network, and wherein said forwarding table has entries causing said received traffic to be forwarded using a connection-oriented mode which take precedence over entries for connectionless traffic.

119. A switching apparatus as claimed in claim 112, wherein the received traffic comprises Ethernet frames or IP packets.

120. A switching apparatus as claimed in claim 112, wherein the mode of transport is determined by the control plane populating the data storage means with a plurality of different index field identifiers, at least one index field identifier comprising a destination address of the connection to be established for said received traffic, and, wherein for one or more egress ports of the switching apparatus, the information provided by the control plane populates the data forwarding table with aggregate address information comprising a combination of header field values associated with an egress port of the switching apparatus.

121. A switching apparatus as claimed in claim 112, wherein the mode of transport is determined by the control plane populating the data storage means with a plurality of different index field identifiers, at least one index field identifier comprising a destination address of the connection to be established for said received traffic, and, wherein for one or more egress ports of the switching apparatus, the information provided by the control plane populates the data forwarding table with aggregate address information comprising a combination of header field values associated with an egress port of the switching apparatus, and wherein said aggregate address information comprises at least one locally unique address and at least one globally unique address, and wherein said control plane provides information to route said received traffic to a globally unique address along a path dependent on one or more locally unique addresses.

122. A switching apparatus as claimed in claim 112, wherein the mode of transport is determined by the control plane populating the data storage means with a plurality of different index field identifiers, at least one index field identifier comprising a destination address of the connection to be established for said received traffic, and, wherein for one or more egress ports of the switching apparatus, the information provided by the control plane populates the data forwarding table with aggregate address information comprising a combination of header field values associated with an egress port of the switching apparatus, and wherein said aggregate address information comprises information extracted from one or more fields in a header of a packet received by said switching apparatus which is associated with an egress port of the switching apparatus by said control plane, whereby the switching apparatus is arranged to forward said received frame to an egress port of the switching apparatus based on one or more of the following fields of the received packet conforming to a connectionless communications protocol:
one or more destination address fields;
one or more source address fields;
one or more source route address fields;
one or more Ethertype field;
one or more priority fields;
one or more type of service fields;
one or more flow identifier fields; and
one or more fields capable of identifying a virtual private network;
one or more protocol fields;
one or more TCP/UDP destination port identifier fields;
one or more TCP/UDP source port identifier fields.

123. A switching apparatus as claimed in claim 112, wherein the mode of transport is determined by the control plane populating the data storage means with a plurality of different index field identifiers, at least one index field identifier comprising a destination address of the connection to be established for said received traffic, and, wherein for one or more egress ports of the switching apparatus, the information provided by the control plane populates the data forwarding table with aggregate address information comprising a combination of header field values associated with an egress port of the switching apparatus, and wherein said traffic comprises IP packets and said aggregate address comprises a set of IP addresses and appropriate address mask information associated with an egress port of the switching apparatus, and wherein for each aggregate address, an IP subnet provides a destination address and the address within each subnet uniquely identifies a path through said communications network.

124. A switching apparatus as claimed in claim 112, wherein the mode of transport is determined by the control plane populating the data storage means with a plurality of different index field identifiers, at least one index field identifier comprising a destination address of the connection to be established for said received traffic, and, wherein for one or more egress ports of the switching apparatus, the information provided by the control plane populates the data forwarding table with aggregate address information comprising a combination of header field values associated with an egress port of the switching apparatus, and wherein said globally significant address is provided by a combination of data stored in the header fields of said received traffic, and wherein said locally significant aggregate address information comprises a hardware address.

125. A switching apparatus as claimed in claim 112, wherein the mode of transport is determined by the control plane populating the data storage means with a plurality of different index field identifiers, at least one index field identifier comprising a destination address of the connection to be established for said received traffic, and, wherein for one or more egress ports of the switching apparatus, the information provided by the control plane populates the data forwarding table with aggregate address information comprising a combination of header field values associated with an egress port of the switching apparatus, wherein said control plane provides in addition to said address aggregate a unique path identifier comprising a TCP/UDP port identifier associated with an IP address, said TCP/UDP port identifier being associated by the control plane with an egress port of said switching apparatus.

126. A switching apparatus as claimed in claim 112, wherein the mode of transport is determined by the control plane populating the data storage means with a plurality of different index field identifiers, at least one index field identifier comprising a destination address of the connection to be established for said received traffic, and, wherein for one or more egress ports of the switching apparatus, the information provided by the control plane populates the data forwarding table with aggregate address information comprising a combination of header field values associated with an egress port of the switching apparatus, wherein said control plane provides said forwarding table with an IPv6 route associated with an egress port of said switching apparatus, and said unique path identifier comprises said flow identifier of an IPv6 address.

127. A switching apparatus as claimed in claim 112, wherein the connectionless protocol comprises Ethernet.

128. A switching apparatus as claimed in claim 112, wherein the connectionless protocol comprises Ethernet and wherein said locally unique address information comprises one or more MAC header fields.

129. A switching apparatus as claimed in claim 112, wherein the switching apparatus is arranged to be capable of re-activating the connection-less mode of operation of egress ports by activating functionality which is capable of configuring the data forwarding tables of the switching apparatus to operate in a connectionless mode upon receipt of appropriate signalling from the control plane.

130. A switching apparatus as claimed in claim 112, further comprising:
means to extract header information from the header of each received packet;
means to perform a lookup operation to determine if said extracted header information matches stored forwarding information, said forwarding information being arranged to provide a data forwarding function for each said received packet dependent said extracted header information;
wherein said information received from said control plane source is processed by said switching apparatus to populate said data storage means to store forwarding information to enable the control plane source to control the connection-oriented data forwarding functionality which the switching apparatus performs on each said received packet.

131. A switching apparatus as claimed in claim 112, wherein said switching apparatus is deployed in a communications network, and previously provided only a connectionless service over said communications network.

132. A switching apparatus as claimed in claim 112, wherein said switching apparatus provides a transparent point-to-point service over said communications network.

133. A switching apparatus as claimed in claim 112, wherein said switching apparatus provides a transparent point-to-multipoint service over said communications network.

134. A switching apparatus as claimed in claim 131, wherein a field in a header of a packet received by said switching apparatus is associated with an egress port of the switching apparatus, and the switching apparatus forwards said received frame to an egress port of the switching apparatus based on one or more of the following fields of the received packet conforming to a connectionless communications protocol:
one or more destination address fields;
one or more source address fields;
one or more source route address fields;
one or more Ethertype field;
one or more priority fields;
one or more type of service fields;
one or more flow identifier fields; and
one or more fields capable of identifying a virtual private network;
one or more protocol fields;
one or more TCP/UDP destination port identifier fields;
one or more TCP/UDP source port identifier fields.

135. A switching apparatus as claimed in claim 131, wherein a field in a header of a packet received by said switching apparatus is associated with an egress port of the switching apparatus, and the switching apparatus forwards said received frame to an egress port of the switching apparatus based on one or more of the following fields of the received packet conforming to a connectionless communications protocol:
one or more destination address fields;
one or more source address fields;
one or more source route address fields;
one or more Ethertype field;
one or more priority fields;
one or more type of service fields;
one or more flow identifier fields; and
one or more fields capable of identifying a virtual private network;
one or more protocol fields;
one or more TCP/UDP destination port identifier fields;
one or more TCP/UDP source port identifier fields, and
wherein said switching apparatus encapsulates received the header of a received packet within one or more other headers.

136. A switching apparatus as claimed in claim 131, wherein a field in a header of a packet received by said switching apparatus is associated with an egress port of the switching apparatus, and the switching apparatus forwards said received frame to an egress port of the switching apparatus based on one or more of the following fields of the received packet conforming to a connectionless communications protocol:
one or more destination address fields;
one or more source address fields;
one or more source route address fields;
one or more Ethertype field;
one or more priority fields;
one or more type of service fields;
one or more flow identifier fields; and
one or more fields capable of identifying a virtual private network;
one or more protocol fields;
one or more TCP/UDP destination port identifier fields;
one or more TCP/UDP source port identifier fields. and
wherein said switching apparatus encapsulates received the header of a received packet within one or more other headers, wherein said received packet comprises an IP packet having an IP packet header including first IP address information encapsulated in a second IP packet header comprising second IP address information.

137. A switching apparatus as claimed in claim 112, wherein information relating to a connection provided by said switching apparatus in said communications network is provided only within the control plane of said communications network.

138. A method of modifying switching apparatus deployed in a communications network to provide a connectionless service over said communications network, wherein said method comprises the step of disabling the data forwarding functionality of the switching apparatus from using information calculated from connectionless routing protocols to implement connectionless routing, and wherein said information populating said forwarding table is provided by the control plane of the switching apparatus, wherein said provided information enables the switching apparatus to implement its data forwarding functionality for received packets.

139. A method of modifying switching apparatus as claimed in claim 138, wherein in said step of disabling the data forwarding functionality, the IP addresses of the switching apparatus themselves are retained in each forwarding table in a normal connectionless mode, and wherein the control plane transport and routing protocol including auto-discovery is implemented in a connectionless mode.

140. A method of modifying switching apparatus deployed in a communications network to provide a connectionless service over said communications network, wherein said method comprises the step of preventing data forwarding in connectionless mode by populating the forwarding table with connection-oriented entries which take precedence over connectionless forwarding entries, and wherein said information populating said forwarding table is provided by the control plane of the switching apparatus, wherein said provided information enables the switching apparatus to implement its data forwarding functionality for received packets.

141. A method of switching packets over a communications network comprising a plurality of interconnected switching apparatus, the method comprising:
receiving packets at a switching apparatus connected to said communications network,
forwarding said packets at a switching apparatus by populating a data store arranged to associate information provided in at least one field of the header of a received packet with an egress port of the switching apparatus using information provided by one or more control plane processors associated with the switching apparatus, said one or more control plane processors comprising the control plane of said communications network, whereby the data forwarding and/or route filtering functionality of the switching apparatus are controlled by the control plane of the communications network.

142. A communications network comprising a plurality of switching apparatus interconnected to provide switchable data transport between data sources and data sinks, wherein the data forwarding and data filtering functions each switch apparatus performs on received packets is controlled by a control plane comprising one or more control plane processors, said control plane providing each switch apparatus with control data enabling the switching apparatus to implement its data forwarding and data filtering functionality on received packets, said received packets including header information having address information conforming to a connectionless protocol, said control data enabling said switching apparatus to provide a connection-oriented service for said received packets.

143. A control plane processor arranged to provide switching apparatus as claimed in claim 112 with control data, the control data enabling the switching apparatus to implement its data forwarding and data filtering functionality on received packets.

144. A communications network comprising a plurality of interconnected switching apparatus as claimed in claim 112.

145. A communications network comprising a plurality of interconnected switching apparatus as claimed in claim 112, wherein the control data generated by said control plane is transmitted out of band to each switching apparatus.

146. A communications network comprising a plurality of interconnected switching apparatus as claimed in claim 112, wherein the control plane of said communications network establishes a plurality of paths for a traffic flow from at least one data source to at least one data sink through said network.

147. A method of generating an end-to-end connection over a communications network comprising a plurality of switching apparatus preconfigured to support a connectionless communications protocols the method comprising the steps of:
reconfiguring the switching apparatus by:
disabling any functionality supporting forwarding a received communications traffic flow using said connectionless communications protocol;
enabling functionality supporting forwarding a received communications traffic flow using a connection-oriented communications protocol;
determining a path for said end-to-end connection from a source to a sink for said traffic flow;
communicating said path via a control interface to provide routing information for said received traffic flow, whereby said enabling functionality forwards said received traffic flow towards said sink across said communications network.

148. In a communications network comprising a plurality of local area networks interconnected by a wide area network, a method of providing differentiated forwarding modes for packetised data received from a first one of said plurality of LANs to a second one of said plurality of LANs, the method comprising:
at a first apparatus arranged to provide data from said first LAN with access to said WAN, performing a look-up operation on a plurality of header fields for said data;
determining if each of said plurality of header fields are associated with routing information stored in a data store populated by the control plane of said first apparatus;
routing said data across said wide area network to a second apparatus arranged to provide access to data from said WAN to said second LAN in accordance with the routing information provided by said control plane.

149. A method as claimed in claim 148, wherein the packetised data comprises a plurality of Ethernet frames, and said plurality of header fields comprise at least a VLAN-ID/DA MAC tuple, and wherein said first and second switching apparatus comprise first and second independent VLAN learning Ethernet switches respectively.

150. A method as claimed in claim 149, wherein the packetised data comprises a plurality of Ethernet frames, and said plurality of header fields comprise at least a VLAN-ID/DA MAC tuple, and wherein said first and second switching apparatus comprise first and second independent VLAN learning Ethernet switches respectively, and wherein the first and second independent VLAN learning Ethernet switching apparatus are interconnected by a contiguous sequence of independent VLAN learning Ethernet switching apparatus arranged to forward received Ethernet frames on locally significant VLAN-IDs to form a unidirectional connection.

151. A method as claimed in claim 148, wherein the packetised data comprises a plurality of Ethernet frames, and said plurality of header fields comprise at least a VLAN-ID/DA MAC tuple, and wherein said first and second switching apparatus comprise first and second independent VLAN learning Ethernet switches respectively, and wherein the first and second independent VLAN learning Ethernet switching apparatus are interconnected by a contiguous sequence of independent VLAN learning Ethernet switching apparatus arranged to forward received Ethernet frames on locally significant VLAN-IDs to form a unidirectional connection, wherein said routing information provided by said control plane further provides a reverse path between said second Ethernet switch and said first Ethernet switch to provide bi-directional connectivity between said first and second Ethernet switching apparatus.

152. A method of configuring switching apparatus to receive management and/or signalling information comprising the steps of:
retaining a broadcast functionality on one or more specific ports of said switching apparatus,
disabling all pre-existing functionality supporting pre-configured connectionless protocols from other ports of said switching apparatus, said other ports being re-configured by information derived from said management and signalling information received on said one or more specific ports to provide one or more connection-oriented modes of transport for traffic received at said other ports, said traffic received at said other ports conforming to a connectionless communications protocol,
whereby, said one or more specific ports of said switching apparatus are configured to logically isolate said received management and/or signalling information from other traffic received by the switching apparatus.

153. A method of configuring switching apparatus as claimed in claim 152, wherein said retained broadcast functionality enables said switching apparatus to forward said received management and signalling traffic in a connection-less manner;

154. A method of configuring switching apparatus as claimed in claim 152, wherein said switching apparatus logically isolates received management and/or signalling information by associating an identifier extracted from the header of a packet or frame carrying said information with said one or more specific ports of said switching apparatus.

155. A communications scheme for configuring a network comprising a plurality of connected switching apparatus, each switching apparatus having functionality for implementing connectionless forwarding of received communications traffic to selectively provide a connection-oriented service for said received communications traffic, the scheme comprising:
determining index header field values to identify traffic received at switching apparatus for which a connection is to be established between a source node and a destination node;
providing each switching apparatus necessary to implement the connection with information which enables their data forwarding tables to be populated with said index header field values in association with egress ports of the switching apparatus; and
disabling all other functionality on said switching apparatus capable of populating the data forwarding tables with index information associated with said egress ports of the switching apparatus necessary to establish said connection.

156. A communications scheme as claimed in claim 155, wherein a plurality of differing types of index header field values are provided by the control plane.

157. A communications scheme as claimed in claim 156, wherein the differing types of index header field values are arranged hierarchically, and different levels of the hierarchy are associated with different egress ports of the switching apparatus.
